(19) United States
(12) Patent Application Publication
(10) Pub. No.: US 2026/0300389 A1
(43) Pub. Date: Oct. 1, 2026

(54) GRAPH-BASED MODELS WITH VIDEO NODES

(71) Applicant: Infosys Limited, Bangalore (IN)

(72) Inventor: Steven SCHILDERS, Columbus, IN (US)

(73) Assignees: Infosys Limited, Bangalore, KA (IN); InvertIT Inc., Columbus, IN (US)

(21) Appl. No.: 19/093,178

(22) Filed: Mar. 27, 2025

(51) Int. Cl. G06F 16/71; G06F 16/78

(52) U.S. Cl. CPC G06F 16/71; G06F 16/78

(57) ABSTRACT

An overlay system is provided that includes a storage element and processing circuitry coupled thereto. The storage element stores an executable graph-based model having a plurality of video action overlay nodes. The processing circuitry receives a stimulus associated with a node creation operation in the executable graph-based model to represent a first video of an external system. The processing circuitry identifies, based on the stimulus, a first video action overlay node of the plurality of video action overlay nodes. The processing circuitry retrieves, using the first video action overlay node, a first plurality of image configurations of a first plurality of image frames of the first video from the external system. The processing circuitry generates, in response to the stimulus, a first video node, in the executable graph-based model, representing the video based on the first plurality of image configurations of the first plurality of image frames.

### FIELD OF THE DISCLOSURE

Various embodiments of the present disclosure relate generally to graph-based models. More specifically, various embodiments of the present disclosure relate to implementation of video nodes in executable graph-based models.

### BACKGROUND

Graph-based models are gaining widespread adoption across various fields due to their ability to represent intricate relationships between different entities. These models consist of nodes such as vertices and edges, where vertices correspond to real-world entities, and edges define the relationships or interactions between them. This structural framework makes graph-based models highly adaptable and suitable for applications spanning multiple industries, including marketing, research, and hospitality.

A key advantage of graph-based models is their inherent flexibility, allowing nodes to encapsulate diverse real-world concepts without being restricted to a specific domain. Additionally, some graph-based models integrate specialized nodes that incorporate processing logic. These specialized nodes facilitate operations such as data analysis, automated decision-making, and other computational tasks within the graph structure.

Despite their versatility, the generic nature of graph-based models introduces certain drawbacks. While their adaptability makes them applicable to a wide range of scenarios, it can also result in inefficient utilization of their capabilities. The absence of domain-specific customization in node structure and processing logic may lead to suboptimal performance, limiting the models' effectiveness in specialized applications.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present application and with reference to the drawings.

### SUMMARY

Methods and systems for facilitating implementation of video nodes in executable graph-based models are provided substantially as shown in, and described in connection with, at least one of the figures.

The methods and systems described herein provide an overlay system. The overlay system includes processing circuitry and a storage element coupled to the processing circuitry. The storage element is configured to store an executable graph-based model that includes a plurality of video action overlay nodes. The processing circuitry is configured to receive a first stimulus associated with a node creation operation in the executable graph-based model to represent a first video of an external system. The processing circuitry is further configured to identify, based on the first stimulus, a first video action overlay node of the plurality of video action overlay nodes. The processing circuitry is further configured to retrieve, using the first video action overlay node, a first plurality of image configurations of a first plurality of image frames of the first video from the external system. The processing circuitry is further configured to generate, in response to the first stimulus, a first video node, in the executable graph-based model, representing the first video based on the first plurality of image configurations of the first plurality of image frames.

In some embodiments, the first video action overlay node is a video creation overlay node.

In some embodiments, the first video node includes a first video reference of the first video.

In some embodiments, the first video action overlay node includes a first module reference of a video creation module of the external system.

In some embodiments, the processing circuitry identifies the first video action overlay node based on a functionality thereof being in conformity with the node creation operation.

In some embodiments, the first video node is one of a group consisting of a stateful node or a stateless node.

In some embodiments, based on the first video node being the stateful node, the first plurality of image configurations remain stored with the storage element upon unloading of the first video node.

In some embodiments, based on the first video node being the stateless node, the first plurality of image configurations cease to exist in the storage element upon unloading of the first video node.

In some embodiments, the processing circuitry is further configured to receive a second stimulus associated with a first video action to be executed based on the first video. The processing circuitry is further configured to identify, based on the second stimulus, the first video node in the executable graph-based model. The processing circuitry is further configured to associate a second video action overlay node, of the plurality of video action overlay nodes, with the first video node. The second video action overlay node has a functionality that conforms with the first video action. The processing circuitry is further configured to execute the first video action using the first video node and the second video action overlay node to generate a second video in the external system. The processing circuitry is further configured to generate, in response to the second stimulus, a second video node, representing the second video based on a second plurality of image configurations of a second plurality of image frames of the second video, in the executable graph-based model.

In some embodiments, the second video action overlay node includes a second module reference of a first video action module associated with the external system. The first video action is executed further based on the first video action module.

In some embodiments, the second video action overlay node is at least one of a group consisting of: a video creation overlay node, a video modification overlay node, or a video analyzer overlay node.

In some embodiments, the executable graph-based model further includes a plurality of standard operations overlay nodes. The processing circuitry is further configured to associate a first standard operations overlay node, of the plurality of standard operations overlay nodes, with the first video node. A functionality of the first standard operations overlay node conforms with the first video action. The first video action is executed further based on the first standard operations overlay node.

In some embodiments, the first video node includes a first video reference of the first video. The second video action overlay node includes a second module reference of a first video action module associated with the external system. For the execution of the first video action, the processing circuitry is further configured to retrieve, using the second video action overlay node, the first video reference from the first video node. The processing circuitry is further configured to communicate, using the second module reference, the first video reference to the first video action module. The first video reference is utilized by the first video action module to execute a video operation of the first video action on at least one of the first plurality of image frames of the first video to generate the second plurality of image frames of the second video. The processing circuitry is further configured to receive, using the second video action overlay node, the second plurality of image configurations of the second plurality of image frames, from the first video action module.

In some embodiments, the first video action corresponds to a set of video mutation operations. The execution of the first video action generates at least one intermediate video associated with the first video. Prior to the reception of the second plurality of image configurations, the processing circuitry is further configured to receive, from the first video action module, using the second video action overlay node, a third plurality of image configurations of a third plurality of image frames of the at least one intermediate video.

In some embodiments, the processing circuitry is further configured to associate a third video action overlay node, of the plurality of video action overlay nodes, with the first video node. The third video action overlay node includes a fourth module reference of a second video action module associated with the external system. The first video action is executed further based on the third video action overlay node.

In some embodiments, the first video node further includes a first overlay manager configured to manage the association of the first video node with the second video action overlay node.

In some embodiments, the processing circuitry is further configured to associate a fourth video action overlay node, of the plurality of video action overlay nodes, with the second video action overlay node. A functionality of the fourth video action overlay node conforms with the first video action. The first video action is executed further based on the fourth video action overlay node.

In some embodiments, based on the execution of the first video action, the processing circuitry is further configured to store the first plurality of image configurations in association with the second video action overlay node.

In some embodiments, the first video action is a set of video mutation operations. Upon the execution of the first video action, the processing circuitry is further configured to associate the first plurality of image configurations with the second video action overlay node. The processing circuitry is further configured to discard the first video node from the overlay system.

In some embodiments, the first video action is a set of video mutation operations. The execution of the first video action generates at least one intermediate video associated with the first video. The at least one intermediate video is generated prior to the generation of the second video. The processing circuitry is further configured to receive, using the second video action overlay node, a third plurality of image configurations of a third plurality of image frames of the at least one intermediate video, from the external system.

In some embodiments, the second video action overlay node represents the third plurality of image configurations of the third plurality of image frames of the at least one intermediate video.

In some embodiments, the processing circuitry is further configured to generate, using the second video action overlay node, at least one intermediate video node representing the at least one intermediate video based on the third plurality of image configurations of the third plurality of image frames.

In some embodiments, the processing circuitry is further configured to correlate, using the second video action overlay node, the first video node with at least one of a group consisting of the at least one intermediate video node or the second video node.

In some embodiments, the processing circuitry is further configured to generate a first group node including at least one of a group consisting of: the first video node, the at least one intermediate video node, or the second video node.

In some embodiments, the processing circuitry is further configured to generate, based on the first group node, a video trail associated with the first video. The video trail includes a time-synchronized order of video mutations of the first video.

In some embodiments, the processing circuitry is further configured to associate the first group node with a second group node having at least a third video node correlated with at least one of the group consisting of: the first video node, the at least one intermediate video node, or the second video node.

In some embodiments, the processing circuitry is further configured to associate the first group node with a fifth video action overlay node, of the plurality of video action overlay nodes. The first video action is executed further based on the fifth video action overlay node.

In some embodiments, the executable graph-based model further includes a plurality of standard operations overlay nodes. The processing circuitry is further configured to associate the first group node with a second standard operations overlay node of the plurality of standard operations overlay nodes. The first video action is executed further based on the second standard operations overlay node.

In some embodiments, the first group node is one of a group consisting of a persistable node or a non-persistable node.

In some embodiments, based on the first group node being the persistable node, a video trail of the first video node is stored in the storage element. The video trail of the first video node includes a time-synchronized order of at least one of the group consisting of: the first video node, the at least one intermediate video node, or the second video node.

In some embodiments, based on the first group node being the non-persistable node, a video trail of the first video node ceases to exist from the storage element upon expiration of a threshold time-interval. The video trail of the first video node includes a time-synchronized order of at least one of the group consisting of: the first video node, the at least one intermediate video node, or the second video node.

In some embodiments, the processing circuitry is further configured to associate the first group node with a contract overlay node of the executable graph-based model. The processing circuitry is further configured to execute, using the contract overlay node, a set of constraints that implements access control associated with the first group node.

In some embodiments, the access control associated with the first group node includes one of a group consisting of: a private access, a public access, or a protected access.

In some embodiments, the first video node is a run-time node that includes (i) a node template that defines a node structure and (ii) a node instance that is an implementation of the node template. Based on the first video node being the run-time node, the second video action overlay node is a run-time overlay node that includes (i) an overlay node template that defines an overlay node structure and (ii) an overlay node instance that is an implementation of the overlay node template.

In some embodiments, each video action overlay node of the plurality of video action overlay nodes is the run-time overlay node. The processing circuitry is further configured to associate one or more video action overlay nodes, of the plurality of video action overlay nodes, with the second video action overlay node. The first video action is executed further based on the one or more video action overlay nodes. An overlay node template of the second video action overlay node defines a sequence of operations associated with the one or more video action overlay nodes.

In some embodiments, the processing circuitry is further configured to associate a sixth video action overlay node with the first video node. The processing circuitry is further configured to analyze, using the sixth video action overlay node, the first plurality of image frames. The processing circuitry is further configured to generate, based on the analysis of the first plurality of image frames, a set of analyzed image frames.

In some embodiments, the analysis of the first plurality of image frames is performed based on the first plurality of image configurations.

In some embodiments, the processing circuitry is further configured to receive, using the sixth video action overlay node, a fourth set of image configurations, associated with the set of analyzed image frames.

In some embodiments, the sixth video action overlay node represents the fourth set of image configurations associated with the set of analyzed image frames.

In some embodiments, the first video node is an edge node.

In some embodiments, a method is provided. The method comprising receiving, by processing circuitry of an overlay system, a stimulus associated with a node creation operation in an executable graph-based model to represent a first video of an external system. The executable graph-based model is stored in a storage element of the overlay system and includes a plurality of video action overlay nodes. The method further comprising identifying, by the processing circuitry, based on the stimulus, a first video action overlay node of the plurality of video action overlay nodes. The method further comprising retrieving, by the processing circuitry, using the first video action overlay node, a first plurality of image configurations of a first plurality of image frames of the first video from the external system. The method further comprising generating, by the processing circuitry, in response to the stimulus, a first video node, in the executable graph-based model, representing the first video based on the first plurality of image configurations of the first plurality of image frames.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a graph that illustrates a composition of an executable graph-based model, consistent with disclosed embodiments of the present disclosure;

FIG. 2 is a block diagram that illustrates a system environment of an overlay system for execution, management, and configuration of the executable graph-based model, consistent with disclosed embodiments of the present disclosure;

FIG. 3A is a block diagram that illustrates a standard structure of a generic node within the executable graph-based model, consistent with disclosed embodiments of the present disclosure;

FIG. 3B is a block diagram that illustrates a standard structure of a run-time node within the executable graph-based model, consistent with disclosed embodiments of the present disclosure;

FIG. 4A is a block diagram that illustrates a standard structure of a generic video node within the executable graph-based model, consistent with disclosed embodiments of the present disclosure;

FIG. 4B is a block diagram that illustrates a standard structure of a run-time video node within the executable graph-based model, consistent with disclosed embodiments of the present disclosure;

FIG. 5A is a block diagram that illustrates an executable generic video node within the executable graph-based model, consistent with disclosed embodiments of the present disclosure;

FIG. 5B is a block diagram that illustrates an executable run-time video node within the executable graph-based model, consistent with disclosed embodiments of the present disclosure;

FIG. 6 is a block diagram that illustrates a composition of the executable generic video node that enables persistent storage of data and processing logic associated therewith, consistent with disclosed embodiments of the present disclosure;

FIGS. 7A-7C, collectively, illustrate a graph that depicts an implementation of generic video nodes in the executable graph-based model, consistent with disclosed embodiments of the present disclosure;

FIGS. 8A and 8B, collectively, illustrate a graph that depicts an implementation of a plurality of run-time video nodes in the executable graph-based model, consistent with disclosed embodiments of the present disclosure;

FIG. 9 illustrates a graph that depicts an exemplary implementation of the executable graph-based model, consistent with disclosed embodiments of the present disclosure;

FIG. 10 illustrates a graph that depicts another exemplary implementation of the executable graph-based model, consistent with disclosed embodiments of the present disclosure;

FIG. 11 is a graph that illustrates another exemplary implementation of the executable graph-based model, consistent with disclosed embodiments of the present disclosure;

FIG. 12 shows an example computing system for carrying out methods of the present disclosure, consistent with disclosed embodiments of the present disclosure;

FIG. 13 illustrates a flowchart of a method for creation of a video node in the executable graph-based model, consistent with disclosed embodiments of the present disclosure; and

FIG. 14 illustrates a flowchart of a method for execution of a video action, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

Graph-based models are widely utilized across various industries due to their ability to capture complex relationships between different entities. These models consist of interconnected nodes, including vertices and edges, where the vertices represent real-world elements and the edges define the connections or associations between them. This structural approach enables graph-based models to be highly adaptable, making them applicable to domains such as marketing, research, and hospitality.

One of the fundamental strengths of graph-based models is their general-purpose nature, allowing nodes to represent a diverse range of concepts without being confined to a particular industry. Furthermore, some graph-based models incorporate specialized nodes, such as overlay nodes with built-in processing capabilities. These nodes can execute various tasks within the graph-based models, including data analysis, automated decision-making, and computational processing.

However, the broad adaptability of graph-based models also presents certain challenges. While their flexibility allows them to function across multiple domains, it can lead to inefficiencies in utilizing their full potential. The lack of domain-specific refinements in node configurations and processing mechanisms may hinder their overall performance, preventing them from operating at peak efficiency in specialized applications.

The present disclosure is directed to facilitation of video nodes in an executable graph-based model of an overlay system. The executable graph-based model is a customized hypergraph with hyper-edges that are realized by way of executable nodes. Each executable node is associated with a particular node-type. For example, an edge node corresponds to a base node with an edge node-type. Nodes (for example, base nodes and executable nodes) are connected with other nodes by way of roles included in an edge node therebetween. In some embodiments, roles are represented by way of nodes of role node-type. A role node between two nodes may be indicative of a context regarding an association therebetween. The executable graph-based model also includes a plurality of overlay nodes that incorporate in-situ features in the overlay system. Each overlay node is associated with one or more nodes (for example, a vertex node, an edge node, or the like) of the executable graph-based model and includes a corresponding processing logic that when executed implements a functionality thereof on the associated nodes. Hence, the processing logic is implemented within the executable graph-based model and is not required to be retrieved from any external system.

The overlay system disclosed herein facilitates implementation of the video nodes in the executable graph-based model. Each video node may represent a video of an external system associated with the overlay system. The executable graph-based model may include a plurality of video action overlay nodes (for example, a plurality of generic video action nodes and a plurality of run-time video action nodes). A video action overlay node may include processing logic that when executed, may implement one or more algorithms, techniques, or the like to perform one or more video operations (for example, video creation operations, video modification operations, video analysis operations, video deletion operations, or the like). Each video action overlay node may include a module reference of a corresponding video action module of the external system. Based on a first video action overlay node of the plurality of video action overlay nodes that includes a first module reference of a first video action module (e.g., a video creation module) of the external system, image configurations of image frames of a video of an external system may be retrieved. Subsequently, a video node, that represents the retrieved image configurations and a video reference of the video, may be generated in the executable graph-based model. Based on the video node including the retrieved image configurations and the video reference of the video, the video of the external system may be represented in the overlay system by way of the video node.

A second video action overlay node may be associated with the video node. The second video action overlay node associated with the video node may have a second module reference associated with a second video action module in the external system. The second video action overlay node may retrieve the video reference from the video node associated therewith. Subsequently, the second video action overlay node may communicate, using the second module reference, the video reference to the second video action module. Based on the received video reference, the second video action module may execute a corresponding video operation on the video. Subsequently, the second video action module may communicate an output of the video operation to the second video action overlay node which may update the executable graph-based model to reflect the output of the video operation. The output may be image configurations of image frames of another video generated based on the execution of the video operation on the video.

Thus, the disclosed overlay system facilitates implementation of a plurality of video nodes in the executable graph-based model. A video node may be a node of the executable graph-based model that may be dedicated, specialized, and customized to represent a video of the external system associated with the overlay system. The disclosed overlay system further includes the plurality of video action overlay nodes having processing logic that when executed may cause execution of various video operations (for example, video creation, video modification, video analysis, video deletion, or the like) on one or more videos of the external system being represented by one or more video nodes associated therewith. Such implementation of video nodes and video action overlay nodes significantly eliminates the disadvantage of a limited use of capabilities of graph-based models by optimizing the use of the executable graph-based model for dedicated purposes. Hence, the disclosed overlay system offers numerous advantages, including enhanced efficiency and performance through optimized and customized node structures and tailored processing logic. Therefore, the disclosed overlay system enables faster data processing and reduced computational overhead. It ensures increased scalability by improving resource management, allowing the overlay system to handle large and complex datasets effectively across diverse domains. Furthermore, it enables domain-specific customization by adapting node and node structures to meet the unique requirements of specific industries, such as marketing, healthcare, or hospitality. This results in more accurate insights, streamlined operations, and maximized utilization of the executable graph-based model, unlocking its full potential for specialized applications while retaining their inherent versatility.

### Figure Description

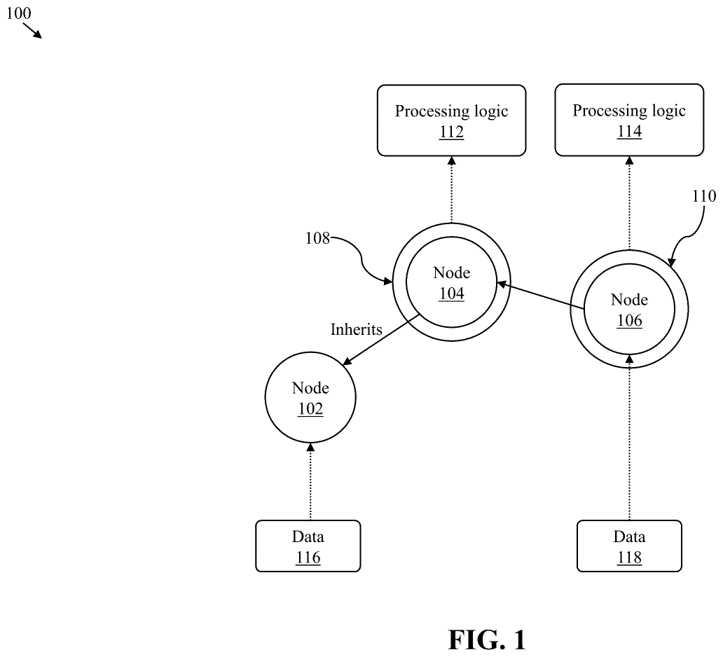

FIG. 1 is a graph that illustrates a composition of an executable graph-based model 100, consistent with disclosed embodiments of the present disclosure. Referring to FIG. 1, the executable graph-based model 100 is generally formed of a data structure (e.g., a graph-based model or a graphical model) comprising a plurality of nodes 102-106 which can be functionally extended with processing logic via the use of overlays. For example, as shown in FIG. 1, the nodes 104 and 106 are functionally extended with processing logic via the use of overlay nodes 108 and 110, respectively. Although not shown, the node 102 can be similarly extended with processing logic via the use of one or more overlays. Each overlay includes processing logic, such as processing logic 112 and 114 which are associated with the overlay nodes 108 and 110, respectively. At run-time, data, such as data 116 and 118, is associated with the nodes 102 and 106, respectively. Further, the overlay nodes 108 and 110 of the nodes 104 and 106, respectively, provide the functionality to respond to stimuli and interact with, manipulate, or otherwise process the data based on the stimuli. Further, the node 104 inherits the node 102, and hence, also inherits the data 116 which is associated with the node 102. In some embodiments, the node 102 may be extended to have one or more overlays. In such embodiments, the node 104 may further inherit the overlays of the node 102.

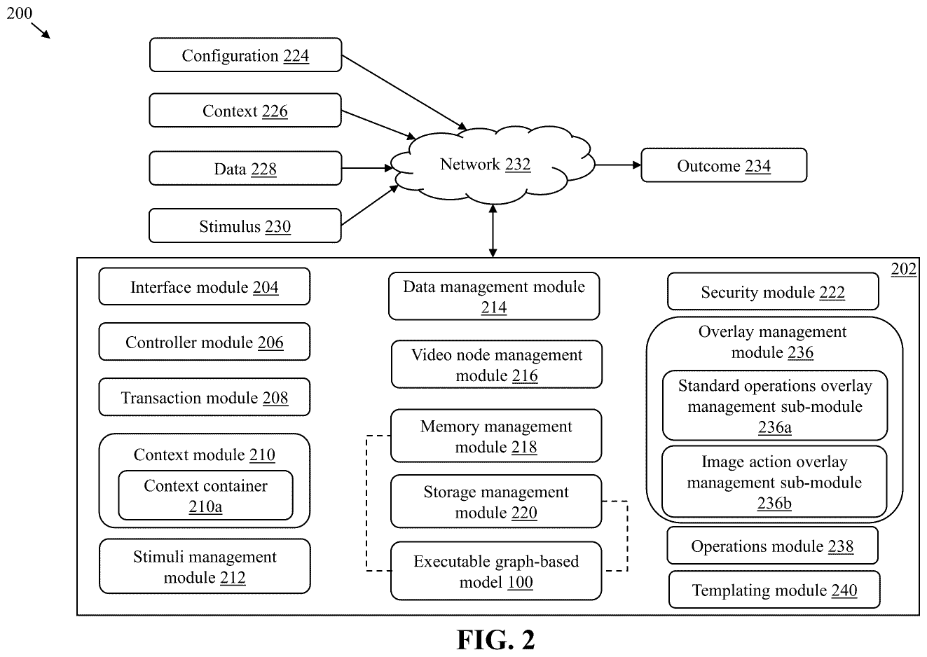

Each element within the executable graph-based model 100 (both the data and the processing functionality) is implemented by way of a node. A node forms the fundamental building block of all executable graph-based models. A node may be an executable node. A node that is extended by way of an overlay node forms an executable node. One or more nodes are extended to include overlays in order to form the executable graph-based model 100. As such, the executable graph-based model 100 includes one or more nodes that can be dynamically generated, extended, or processed by one or more other modules within an overlay system (shown in FIG. 2). Throughout the description, the terms “overlay node” and “overlay” are used interchangeably.

Notably, the structure and functionality of the data processing are separate from the data itself when offline (or at rest) and are combined dynamically at run-time. The executable graph-based model 100 thus maintains the separability of the data and the processing logic when offline. Moreover, by integrating the data and the processing logic within a single model, processing delays or latencies are reduced because the data and the processing logic exist within the same logical system. Therefore, the executable graph-based model 100 applies to a range of time-critical systems where efficient processing of the stimuli is required.

FIG. 2 is a block diagram that illustrates a system environment 200 of an overlay system 202 for execution, management, and configuration of the executable graph-based model 100, consistent with disclosed embodiments of the present disclosure. Referring to FIG. 2, the overlay system 202 includes the executable graph-based model 100. The overlay system 202 further includes an interface module 204, a controller module 206, a transaction module 208, a context module 210, a stimuli management module 212, a data management module 214, a video node management module 216, a memory management module 218, a storage management module 220, and a security module 222. FIG. 2 further shows a configuration 224, a context 226, data 228, a stimulus 230, a network 232, and an outcome 234. Additionally, the overlay system 202 of the present disclosure includes an overlay management module 236, an operations module 238, and a templating module 240. In some embodiments, all the modules of the overlay system 202 except for the executable graph-based model 100 may collectively form processing circuitry that facilitates operations associated with a plurality of video nodes of the executable graph-based model 100. The plurality of video nodes may be created/generated based on generic nodes and run-time nodes of the executable graph-based model 100.

A generic node may refer to a node, in the executable graph-based model 100, with an edge node-type, a role node-type, an overlay node-type, or a vertex node-type. A first generic node with the vertex node-type is coupled to a second generic node with the vertex node-type by way of a third generic node with the edge node-type indicative of roles of the first and second generic nodes. A run-time node may include a node template and a node instance. The node template may be a predefined node structure and the node instance may be an implementation of the predefined node structure. The run-time node may have an edge node-type, a role node-type, an overlay node-type, or a vertex node-type. A first run-time node with the vertex node-type is coupled to a second run-time node with the vertex node-type by way of a third run-time node with the edge node-type and indicative of roles of the first and second run-time nodes.

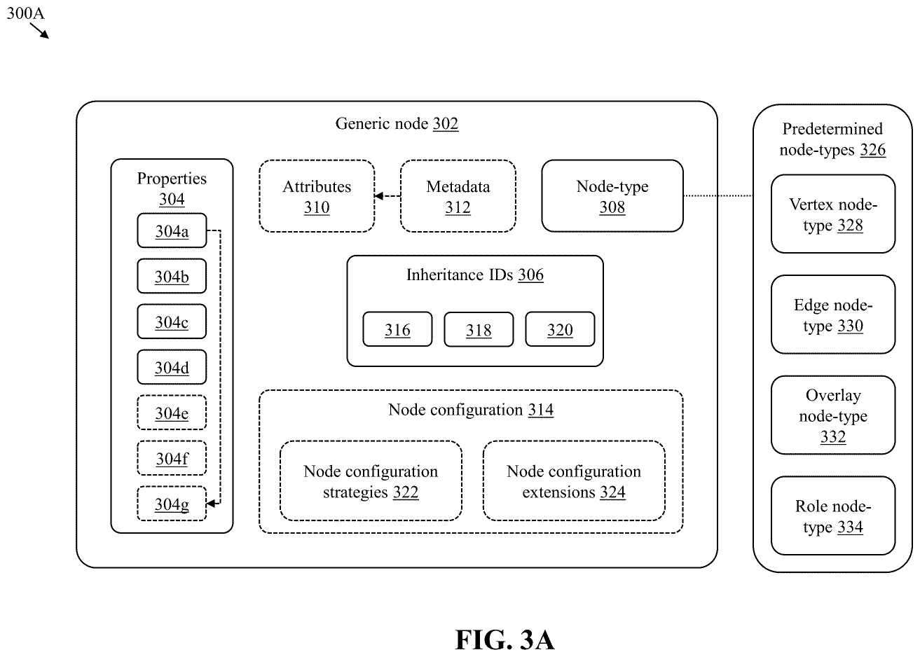

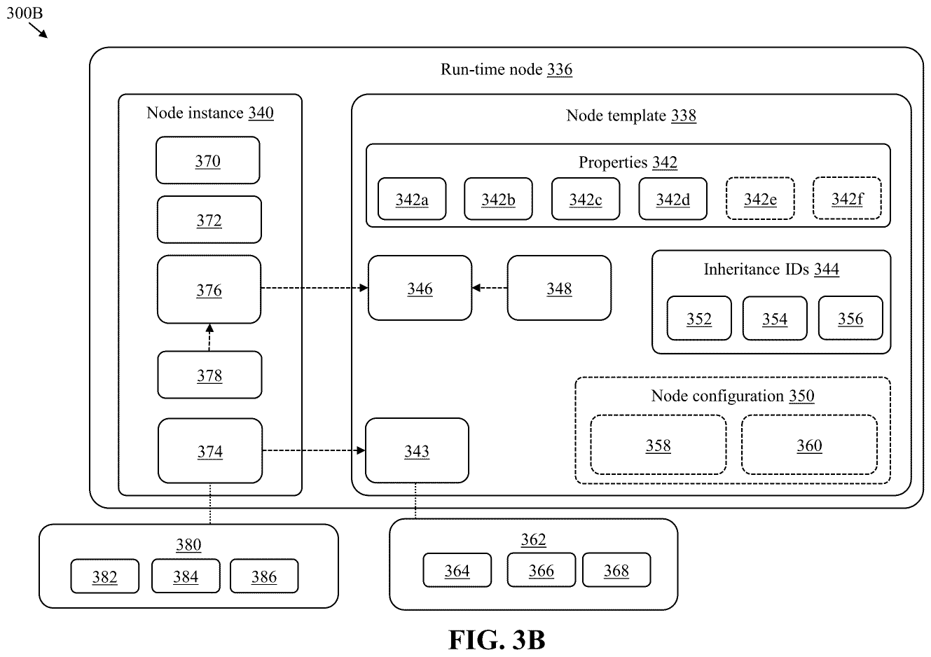

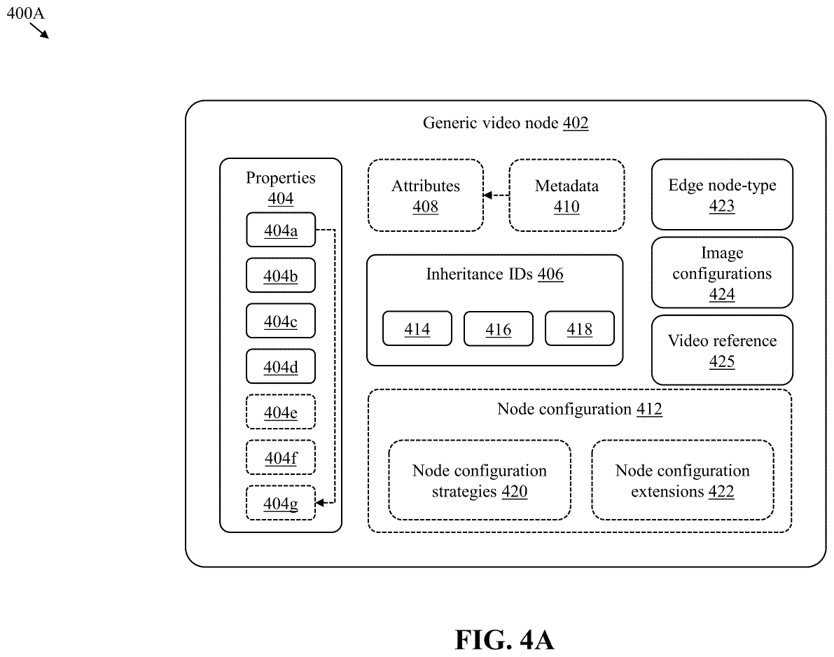

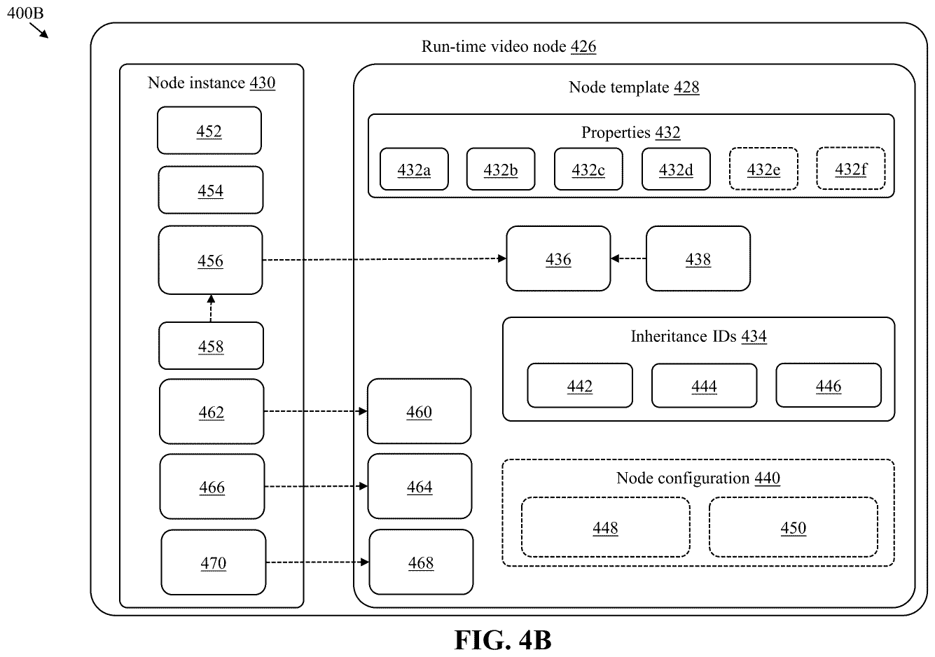

A standard node structure of the generic node and the run-time node (as described later in conjunction with FIGS. 3A and 3B, respectively) may be modified to form a generic video node (depicted in FIG. 4A) and a run-time video node (depicted in FIG. 4B), respectively, in the executable graph-based model 100. The generic video node and the run-time video node are collectively referred to as a video node. A video node may represent a video of an external system associated with the overlay system 202. Such a representation may be based on a plurality of image configurations of a plurality of image frames of the video being stored in association with the video node. The external system may include a plurality of videos that may be represented by the plurality video nodes of the executable graph-based model 100.

The overlay system 202 may include suitable logic, circuitry, interfaces, and/or code, executable by the circuitry, that may be configured to facilitate one or more operations associated with the nodes in the executable graph-based model 100. One or more modules (for example, the controller module 206, the transaction module 208, or the like) of the overlay system 202 may be modified and customized to execute one or more operations associated with creation and management of the plurality of video nodes and execution of transactions associated with the video nodes.

The interface module 204 may include suitable logic, circuitry, interfaces, and/or code, executable by the circuitry, configured to provide a common interface between internal modules of the overlay system 202 and/or external sources. The interface module 204 provides an application programming interface (API), scripting interface, or any other suitable mechanism for interfacing externally or internally with any module of the overlay system 202. The configuration 224, the context 226, the data 228, and the stimulus 230 may be received by the interface module 204 via the network 232. Similarly, outputs (e.g., the outcome 234) produced by the overlay system 202 are passed by the interface module 204 to the network 232 for consumption or processing by external systems. In one embodiment, the interface module 204 supports one or more messaging patterns or protocols such as the simple object access protocol (SOAP), the representational state transfer (REST) protocol, or the like. The interface module 204 thus allows the overlay system 202 to be deployed in any number of application areas, operational environments, or architecture deployments. Although not illustrated in FIG. 2, the interface module 204 is communicatively coupled (e.g., connected either directly or indirectly) to one or more other modules or elements within the overlay system 202 (such as the controller module 206, the context module 210, the executable graph-based model 100, or the like). In one embodiment, the interface module 204 is communicatively coupled (e.g., connected either directly or indirectly) to one or more overlays within the executable graph-based model 100. The interface module 204 is further configured to receive one or more inputs via the API for creation/generation of the plurality of video nodes for representing the plurality of videos of the external system. The interface module 204 is further configured to receive one or more inputs via the API for executing one or more video operations (for example, video creation operations, video modification operations, video analysis operations, or video deletion operations) based on the plurality of video nodes. The video operations may be executed further based on a plurality of video action overlay nodes of the external system.

The controller module 206 may include suitable logic, circuitry, interfaces, and/or code, executable by the circuitry, configured to handle and process interactions and executions within the overlay system 202. As will be described in more detail below, stimuli (such as the stimulus 230) and their associated contexts (such as the context 226) provide the basis for all interactions within the executable graph-based model 100. Processing of such stimuli may lead to execution of processing logic associated with one or more overlays (for example, the plurality of video action overlay nodes) within the executable graph-based model 100. The processing of the stimuli within the overlay system 202 may be referred to as a system transaction (namely, transaction). The processing and execution of stimuli (and associated overlay execution) within the overlay system 202 is handled by the controller module 206. The controller module 206 manages all received input stimuli (e.g., the stimulus 230) and processes them based on a corresponding context (e.g., the context 226). The context 226 determines the priority that is to be assigned to the processing of the corresponding stimulus by the controller module 206 or the context module 210. This allows each stimulus to be configured with a level of importance and prioritization within the overlay system 202. The controller module 206 may be further configured to facilitate and manage interactions among various modules of the overlay system 202 for execution of the video operations associated with the overlay system 202.

The controller module 206 may maintain the integrity of the modules within the overlay system 202 before, during, and after a system transaction. The transaction module 208, which is associated with the controller module 206, is responsible for maintaining the integrity of the overlay system 202 through the lifecycle of a transaction. The transaction module 208 may be further configured to track and monitor various transaction associated with the video operations associated with the overlay system 202. Based on such tracking and monitoring, the transaction module 208 may be configured to maintain system integrity of the overlay system 202. Maintaining system integrity via the controller module 206 and the transaction module 208 allows a transaction to be rolled back in an event of an expected or unexpected software or hardware fault or failure. The controller module 206 is configured to handle the processing of the stimulus 230 and transactions (for example, video operations) through architectures such as parallel processing, grid computing, priority queue techniques, or the like. In one embodiment, the controller module 206 and the transaction module 208 are communicatively coupled (e.g., connected either directly or indirectly) to one or more overlays within the executable graph-based model 100.

As stated briefly above, the overlay system 202 utilizes a context-driven architecture, whereby the stimulus 230 within the overlay system 202 is associated with the context 226 which is used to adapt the handling or processing of the stimulus 230 by the overlay system 202. That is to say that the handling or processing of the stimulus 230 is done based on the context 226 associated therewith. Hence, the stimulus 230 is a contextualized stimulus. The context 226 may include details such as username, password, access token, device information, time stamp, one or more relevant identifiers (IDs), or the like, that are required for processing of the stimulus 230 within the executable graph-based model 100. Each context within the overlay system 202 may be extended to include additional information that is required for the processing of the stimulus (e.g., a query, a command, or an event).

The context module 210 may include suitable logic, circuitry, interfaces, and/or code, executable by the circuitry, configured to manage the handling of contexts within the overlay system 202. The context module 210 is responsible for processing any received contexts (e.g., the context 226) and translating the received context to an operation execution context.

In some examples, the operation execution context is larger than the received context because the context module 210 supplements the received context with further information necessary for the processing of the received context. The context module 210 passes the operation execution context to one or more other modules within the overlay system 202 to drive communication of data associated with the operation execution context. Contexts within the overlay system 202 can be external or internal. While some contexts apply to all application areas and problem spaces, some applications may require specific contexts to be generated and used to process the received stimulus 230. As will be described in more detail below, the executable graph-based model 100 is configurable (e.g., via the configuration 224) so as only to execute within a given execution context for a given stimulus.

As shown, the context module 210 includes a context container 210a that includes a set of defined contexts. The set of defined contexts may be generated by a module of the overlay system 202 or may be user defined and received by way of the interface module 204. Each defined context of the set of defined contexts pertains to a context that is associated with one or more operations for facilitating implementation and management of the plurality of video nodes in the overlay system 202. That is to say that, one or more contexts of the set of defined contexts are indicative of the one or more operations to be executed by way of one or more video nodes in the overlay system 202. The one or more operations are executed when a context of a corresponding stimuli matches one of the set of defined contexts. Each defined context of the set of defined contexts pertains to a context that is associated with one or more operations for facilitating the creation and maintenance of the video nodes in the overlay system 202. That is say to that, one or more contexts of the set of defined contexts are indicative of the one or more video operations to be executed for performing the creation and maintenance of the video nodes in the overlay system 202. The set of defined contexts may include a video node creation context, a video node modification context, a video node analysis context, a video node deletion context, and a rollback context. The video node creation context is indicative of a first set of video operations that may be executed for the creation of one or more video nodes. The video node modification context is indicative of a second set of video operations that may be executed for modification of one or more video nodes. The video node analysis context is indicative of a third set of video operations that may be executed for analysis of one or more video nodes. The analysis of the video node may be performed for edge detection, object identification, object classification, or other operations associated with videos. The video node deletion context is indicative of a fourth set of video operations that may be executed for deletion of one or more video nodes. The rollback context is indicative of a rollback operation that may be executed for the first or second set of video operations executed for creation or modification of the one or more video nodes such that a previous state of the video node or the overlay system 202 may be achieved. Notably, a set of operations associated with the creation and maintenance of the one or more video nodes is executed when a context of a corresponding stimuli matches one of the set of defined contexts.

The stimuli management module 212 may include suitable logic, circuitry, interfaces, and/or code, executable by the circuitry, configured to process externally received stimuli (e.g., the stimulus 230) and any stimuli generated internally from any module within the overlay system 202. The stimuli management module 212 is communicatively coupled (e.g., connected either directly or indirectly) to one or more overlays within the executable graph-based model 100 to facilitate the processing of stimuli within the executable graph-based model 100. The overlay system 202 utilizes different types of stimuli such as a command (e.g., a transactional request), a query, or an event received from an external system such as an Internet-of-Things (IoT) device. As previously stated, a stimulus (such as the stimulus 230) can be either externally or internally generated. In an example, the stimulus 230 may be a message that is internally triggered (e.g., generated) from any of the modules within the overlay system 202. Such internal generation of the stimulus 230 indicates that something has happened within the overlay system 202 and subsequent handling by one or more other modules within the overlay system 202 may be required. Internal stimulus 230 can also be triggered (e.g., generated) from the execution of processing logic associated with overlays within the executable graph-based model 100. In another example, the stimulus 230 may be externally triggered and may be generated based on an input received via a user interface associated with the controller module 206. The externally triggered stimulus 230 may be received in the form of a signal, a textual, audio, or visual input. The externally triggered stimulus 230 may be associated with the intent of a user to execute an operation indicated by the stimulus 230. The operation is executed in accordance with information included in the context 226 associated with the stimulus 230. The stimulus 230 may be indicative of one or more video operations (for example, video creation operations, video modification operations, video analysis operations, video deletion operations, rollback operations, or the like) associated with one or more video nodes of the plurality of video nodes of the executable graph-based model 100.

The stimuli management module 212 may receive the stimuli (such as the stimulus 230) in real-time or near-real-time and communicate the received stimuli to one or more other modules or nodes of the executable graph-based model 100. In some examples, the stimuli are scheduled in a batch process. The stimuli management module 212 utilizes any suitable synchronous or asynchronous communication architectures or approaches in communicating the stimuli (along with associated information). The stimuli within the overlay system 202 are received and processed (along with a corresponding context) by the stimuli management module 212, which then determines the processing steps to be performed for the communication of data associated with each stimulus.

In one embodiment, the stimuli management module 212 processes the received stimuli in accordance with a predetermined configuration (e.g., the configuration 224) or dynamically determines what processing needs to be performed based on the contexts associated with the stimuli and/or based on a state of the executable graph-based model 100. The state of the executable graph-based model 100 refers to the current state of each node of the executable graph-based model 100 at a given point in time. The state of the executable graph-based model 100 is dynamic, and hence, may change based on processing of data by any of its nodes. In some examples, the processing of a stimulus (such as the stimulus 230) results in the generation, communication, or processing of data that further results in one or more outcomes (e.g., the outcome 234) being generated. Such outcomes are either handled internally by one or more modules in the overlay system 202 or communicated via the interface module 204 as an external outcome. In one embodiment, all stimuli and corresponding outcomes are recorded for auditing and post-processing purposes by, for example, the operations module 238 of the overlay system 202.

The data management module 214 may include suitable logic, circuitry, interfaces, and/or code, executable by the circuitry, configured to manage all data or information within the overlay system 202 (e.g., the data 228) for a given application. Operations performed by the data management module 214 include data loading, data unloading, data modeling, and data processing. The data management module 214 is communicatively coupled (e.g., connected either directly or indirectly) to one or more other modules within the overlay system 202 to complete some or all of these operations. For example, data storage is handled by the data management module 214 in conjunction with the storage management module 220. The data management module 214 may be further configured to manage data and information associated with each video node of the plurality of video nodes. In other words, the data management module 214 is further configured to manage a plurality of image configurations associated with a plurality of image frames of each video node of the plurality of video nodes within the overlay system 202.

The video node management module 216 may include suitable logic, circuitry, interfaces, and/or code, executable by the circuitry, configured to manage, design, storage, and implement the plurality of video nodes in the overlay system 202. The video node management module 216 may be further configured to manage association between videos of the external system and the video nodes. In other words, the video node management module 216 may cause each video node to include a video reference of a video of the external system being represented thereby. The video node management module 216 may be further configured to manage association of each video node of the plurality of video nodes with a plurality of image configurations of a plurality of image frames of a video of the external system that is being represented thereby. Additionally, the video node management module 216 may be further configured to manage association between video action modules of the external system and video action overlay nodes of the executable graph-based model 100. The video nodes may include the generic video nodes and the run-time video nodes. Further, each video node may have an edge node-type. The video node management module 216 is further configured to facilitate operations associated with execution of one or more transactions using the video nodes.

The memory management module 218 may include suitable logic, circuitry, interfaces, and/or code, executable by the circuitry, configured to manage and optimize the memory usage of the overlay system 202. The memory management module 218 thus helps to improve the responsiveness and efficiency of the processing performed by one or more modules within the overlay system 202 by optimizing the memory handling performed by these modules. The memory management module 218 uses direct memory or some form of distributed memory management architecture (e.g., a local or remote caching solution). Additionally, or alternatively, the memory management module 218 deploys multiple different types of memory management architectures and solutions (e.g., reactive caching approaches such as lazy loading or a proactive approach such as write-through cache may be employed). These architectures and solutions are deployed in the form of a flat (single-tiered) or multi-tiered caching architecture where each layer of the caching architecture can be implemented using a different caching technology or architecture solution approach. In such implementations, each cache or caching tier can be configured (e.g., by the configuration 224) independent of the requirements for one or more modules of the overlay system 202. For example, data priority and an eviction strategy, such as least-frequently-used (LFU) or least-recently-used (LRU), can be configured for all or parts of the executable graph-based model 100. In one embodiment, the memory management module 218 is communicatively coupled (e.g., connected either directly or indirectly) to one or more overlays within the executable graph-based model 100.

The storage management module 220 may include suitable logic, circuitry, interfaces, and/or code, executable by the circuitry, configured to manage the temporary or permanent storage of data associated with the overlay system 202. The storage management module 220 is any suitable low-level storage device solution (such as a file system) or any suitable high-level storage technology such as another database technology (e.g., relational database management system (RDBMS) or NoSQL database). The storage management module 220 is directly connected to the storage device upon which the relevant data is persistently stored. For example, the storage management module 220 can directly address the computer-readable medium (e.g., hard disk drive, external disk drive, or the like) upon which the data is being read or written. Alternatively, the storage management module 220 is connected to the storage device via a network such as the network 232. As will be described in more detail later in the present disclosure, the storage management module 220 uses manifests to manage the interactions between the storage device and the modules within the overlay system 202. In one embodiment, the storage management module 220 is communicatively coupled (e.g., connected either directly or indirectly) to one or more overlays within the executable graph-based model 100. Throughout the description, the term ‘storage device’ is used interchangeably with the term ‘storage element’.

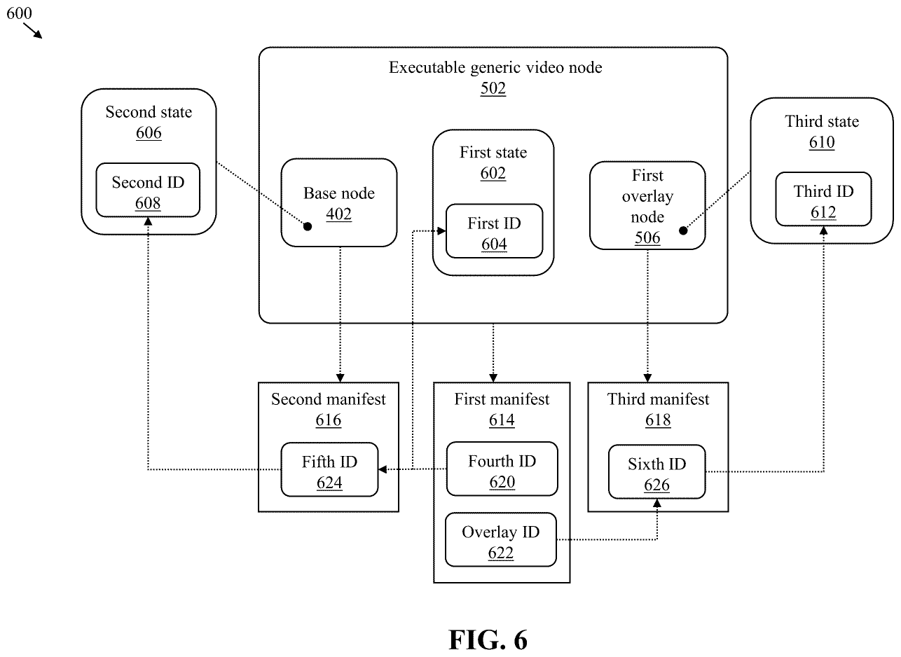

As described, storage, loading, and unloading of the executable graph-based model 100 or one or more components thereof (for example, the video nodes) is facilitated by the memory management module 218 and the storage management module 220. The memory management module 218 and the storage management module 220 may facilitate such operations by interacting with the storage device that stores the executable graph-based model 100. The overlay system 202 further includes a plurality of manifest storages. The manifest storages are used by the memory management module 218 and the storage management module 220 to facilitate storage of manifest states (including manifest template states and manifest instance states) of nodes. The storage element may include a primary storage and a secondary storage. The primary storage may store the executable graph-based model 100 and may also store nodes (for example, the video nodes) that are loaded in the executable graph-based model 100. The secondary storage may store node states, manifests, and manifest states associated with nodes (for example, the video nodes) that are unloaded from the executable graph-based model 100. Storage and retrieval of nodes (for example, the video nodes) are described in detail in conjunction with FIG. 6.

The security module 222 may include suitable logic, circuitry, interfaces, and/or code, executable by the circuitry, configured to manage the security of the overlay system 202. This includes security at a system level and a module level. Security is hardware-related, network-related, or software-related, depending on the operational environment, the architecture of the deployment, or the data and information contained within the overlay system 202. For example, if the system is deployed with a web-accessible API (as described above in relation to the interface module 204), the security module 222 can enforce a hypertext transfer protocol secure (HTTPS) protocol with the necessary certification. As a further example, if the data or information associated with the nodes (for example, the video nodes) of the overlay system 202 contains Personally Identifiable Information (PII) or Protected Health Information (PHI), the security module 222 can implement one or more layers of data protection to ensure that sensitive image configurations (for example, image configuration that corresponds to the PII or PHI) associated with videos of the external system are correctly processed and stored. In an additional example, in implementations whereby the overlay system 202 operates on United States of America citizen medical data, the security module 222 may enforce additional protections or policies as defined by the United States Health Insurance Portability and Accountability Act (HIPAA). Similarly, if the overlay system 202 is deployed in the European Union (EU), the security module 222 may enforce additional protections or policies to ensure that the data processed and maintained by the overlay system 202 complies with the General Data Protection Regulation (GDPR). In one embodiment, the security module 222 is communicatively coupled (e.g., connected either directly or indirectly) to one or more overlays within the executable graph-based model 100, thereby directly connecting security execution to the data/information in the executable graph-based model 100. The security module 222 thus acts as a centralized coordinator that works in conjunction with the overlay management module 236 for managing and executing security-based overlays.

The overlay management module 236 may include suitable logic, circuitry, interfaces, and/or code, executable by the circuitry, configured to manage all overlays (for example, standard operations overlay nodes, video action overlay nodes) within the overlay system 202. The overlays may be generic standard operations overlays, run-time standard operations overlays, generic video action overlays, or run-time video action overlays. Video action overlays are nodes that are associated with one or more video nodes by way of a direct connection or an indirect connection. Direct connection may refer to association between a video action overlay node and a video node without any intermediate node. Indirect connection may refer to association between a video action overlay node and an associated video node by way of one or more intermediate nodes. A video action overlay may be associated with a video node by extending functionality of the video node. Alternatively, the video action overlay node may be associated with the video node by way of one or more video nodes (for example, based on inheritance, based on group level association, or the like). A video action overlay may include a module reference (for example, a pointer, a storage location, or the like) to a video action module of the external system. The video action overlay may include processing logic that when executed may cause the video action module to perform a corresponding video operation on a video of the external system being represented by a video node associated with the video action overlay. The video action overlay node that may not be a run-time video action overlay node may be referred to as a generic video action overlay node. The run-time video action overlay node may have a description similar to the video action overlay node. In addition, the run-time video action overlay node may include a node template and a node instance. The term video action overlay node is used throughout the description to refer to the generic video action overlay node and the run-time video action overlay node, collectively.

Operations performed by the video node management module 216 may further include overlay storage management, overlay structure modeling, overlay logic creation and execution, and overlay loading and unloading (within the executable graph-based model 100). The video node management module 216 is communicatively coupled (e.g., connected either directly or indirectly) to one or more other modules (for example, the overlay management module 236, or the like) within the overlay system 202 to complete some or all of these operations. For example, overlays can be persisted in some form of physical storage using the storage management module 220 (as described in more detail below). As a further example, overlays can be compiled and preloaded into memory via the memory management module 218 for faster run-time execution.

The overlay management module 236 may include a standard operations overlay management sub-module 236a and a video action overlay management sub-module 236b. The standard operations overlay management sub-module 236a is configured to perform operations of the overlay management module 236 that are associated with the standard operations overlays and run-time standard operations overlays. The video action overlay management sub-module 236b is configured to perform operations of the overlay management module 236 that are associated with the video action overlays and run-time video action overlays.

The operations module 238 may include suitable logic, circuitry, interfaces, and/or code, executable by the circuitry, configured to track operational metrics and the behavior of all modules of the overlay system 202. Operational metrics of a module are indicative of statistics associated with the performance of the module while performing an operation (for example, communication, data processing, stimulus processing, or the like) associated with the nodes (for example, the video nodes) of the executable graph-based model 100.

The templating module 240 may include suitable logic, circuitry, interfaces, and/or code, executable by the circuitry, configured to enable the overlay system 202 to implement a templated version of one or more nodes (for example, the video nodes, the video action overlay nodes, or the like) of the executable graph-based model 100. The templating module 240 may be configured to create one or more predefined templates in the executable graph-based model 100. The templating module 240 may be further configured to generate one or more node instances of the predefined node templates for the implementation of the templated version of the executable graph-based model 100. Notably, the templating module 240 ensures ontology integrity by enforcing structure and rules of a template when generating instances of the template at run-time. Ontology integrity refers to consistency, accuracy, and correctness of an ontology. Thus, the templating module 240 ensures that the consistency, accuracy, and correctness of the ontology of the executable graph-based model 100 are maintained while generating the instances of the template at run-time. The templating module 240 may be communicatively coupled (i.e., connected either directly or indirectly) to one or more nodes and/or one or more overlays within the executable graph-based model 100.

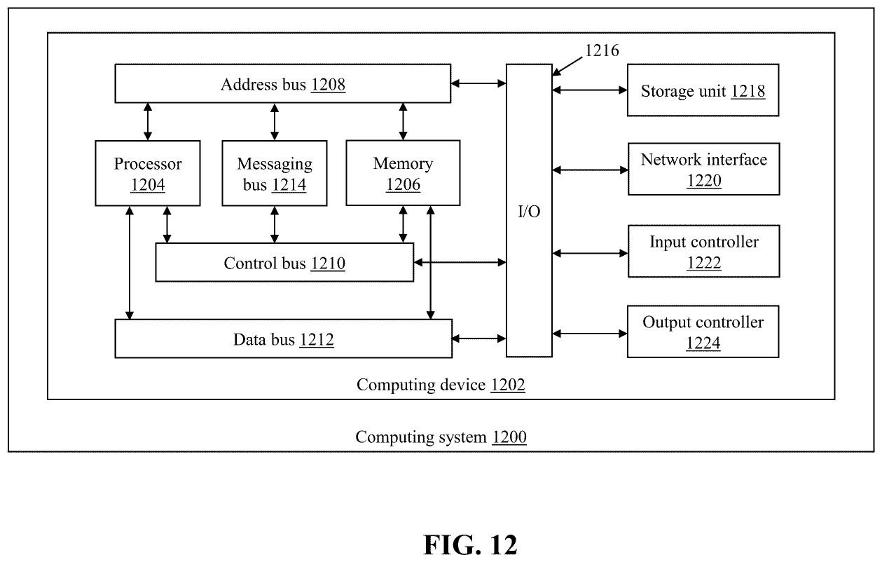

Beneficially, various features of the overlay system 202 support the processing circuitry and a computing system (shown in FIG. 12) implementing the overlay system 202 in significantly enhancing its performance. The significant enhancement in performance may include significantly increased throughput and efficiency, as well as significantly reduced cost complexity, processing complexity, time complexity, latency, waiting time, turnaround time, or the like.

The functionality of two or more of the modules included in the overlay system 202 may be combined within a single module. Conversely, the functionality of a single module can be split into two or more further modules which can be executed on two or more devices. The modules described above in relation to the overlay system 202 can operate in a parallel, distributed, or networked fashion. The overlay system 202 may be implemented in software, hardware, or a combination of both software and hardware. Examples of suitable hardware modules include, but are not limited to, a general-purpose processor, a field programmable gate array (FPGA), and/or an application-specific integrated circuit (ASIC). Software modules can be expressed in a variety of software languages such as C, C++, Java, Ruby, Visual Basic, Python, and/or other object-oriented, procedural, or functional programming languages.

Although it is described that the overlay system 202 includes a single executable graph-based model (e.g., the executable graph-based model 100), the scope of the present disclosure is not limited to it. In other embodiments, the overlay system 202 may include more than one executable graph-based model, without deviating from the scope of the present disclosure. In such a scenario, each executable graph-based model is implemented and managed in a manner that is similar to the executable graph-based model 100.

Having described the overlay system 202 for executing and managing executable graph-based models, the description will now turn to the elements of an executable graph-based model, specifically, the concept of a node. Unlike conventional graph-based systems, all elements (e.g., data, overlays, etc.) within the executable graph-based model 100 are implemented as nodes. As will become clear, this allows executable graph-based models to be flexible, extensible, and highly configurable.

FIG. 3A is a block diagram 300A that illustrates a standard structure of a generic node 302 within the executable graph-based model 100, consistent with disclosed embodiments of the present disclosure. Referring to FIG. 3A, the generic node 302 corresponds to a generic node of the executable graph-based model 100. The generic node 302 further corresponds to the core structure of the executable graph-based model 100 and forms the foundational building block for all data and processing logic within the executable graph-based model 100. The generic node 302 includes properties 304, inheritance IDs 306, and a node-type 308. The generic node 302 optionally includes one or more attributes 310, metadata 312 associated with the attributes 310, and a node configuration 314.

The properties 304 of the generic node 302 include a unique ID 304a, a version ID 304b, a namespace 304c, and a name 304d. The properties 304 optionally include one or more icons 304e, one or more labels 304f, and one or more alternative IDs 304g. The inheritance IDs 306 of the generic node 302 include an abstract flag 316, a leaf flag 318, and a root flag 320. The node configuration 314 optionally includes one or more node configuration strategies 322 and one or more node configuration extensions 324.

The unique ID 304a is unique for each node within the executable graph-based model 100. The unique ID 304a is used to register, manage, and reference the generic node 302 within the system (e.g., the overlay system 202). In some embodiments, the one or more alternative IDs 304g are associated with the unique ID 304a to help manage communications and connections with external systems (e.g., during configuration, sending stimuli, or receiving outcomes). The version ID 304b of the generic node 302 is incremented when the generic node 302 undergoes transactional change. This allows the historical changes between versions of the generic node 302 to be tracked by modules or overlays within the overlay system 202. The namespace 304c of the generic node 302, along with the name 304d of the generic node 302, is used to help organize nodes within the executable graph-based model 100. That is, the generic node 302 is assigned a unique name 304d within the namespace 304c such that the name 304d of the generic node 302 need not be unique within the entire executable graph-based model 100, only within the context of the namespace 304c to which the generic node 302 is assigned. The generic node 302 optionally includes one or more icons 304e which are used to provide a visual representation of the generic node 302 when visualized via a user interface. The one or more icons 304e can include icons at different resolutions and display contexts such that the visualization of the generic node 302 is adapted to different display settings and contexts. The generic node 302 also optionally includes one or more labels 304f which are used to override the name 304d when the generic node 302 is rendered or visualized.

The generic node 302 supports the concept of inheritance of data and processing logic associated with any other node of the executable graph-based model 100 that is inherited by the generic node 302. This allows the behavior and functionality of the generic node 302 to be extended or derived from the inherited node of the executable graph-based model 100. The inheritance IDs 306 of the generic node 302 indicate the inheritance-based information, which may apply to the generic node 302. The inheritance IDs 306 comprise a set of Boolean flags that identify the inheritance structure of the generic node 302. The abstract flag 316 allows the generic node 302 to support the construct of abstraction. When the abstract flag 316 takes a value ‘true’, the generic node 302 is flagged as abstract that is to say that it cannot be instantiated or created within an executable graph-based model (e.g., the executable graph-based model 100). Thus, in an instance when the generic node 302 has the abstract flag 316 set to ‘true’, the generic node 302 may only form the foundation of other nodes that inherit therefrom. By default, the abstract flag 316 of the generic node 302 is set to ‘false’. The leaf flag 318 is used to indicate whether any other node may inherit from the generic node 302. If the leaf flag 318 is set to ‘true’, no other node may inherit from the generic node 302 (but unlike an abstract node, a node with the leaf flag 318 set may be instantiated and created within the executable graph-based model 100). The root flag 320 is used to indicate whether the generic node 302 inherits from any other node. If the root flag 320 is set to ‘true’, the generic node 302 does not inherit from any other node. The generic node 302 is flagged as leaf (e.g., the leaf flag 318 is set to ‘true’) and/or root (e.g., the root flag 320 is set to ‘true’), or neither (e.g., both the leaf flag 318 and the root flag 320 are set to ‘false’). It will be apparent to a person skilled in the art that a node cannot be flagged as both abstract and leaf (e.g., the abstract flag 316 cannot be set to ‘true’ whilst the leaf flag 318 is set to ‘true’).

As stated above, all elements of the executable graph-based model 100 are defined as nodes. This functionality is in part realized due to the use of a node-type. The node-type 308 of the generic node 302 is used to extend the functionality of the generic node 302. All nodes within the executable graph-based model 100 comprise a node-type that defines additional data structures and implements additional executable functionality. A node-type thus includes data structures and functionality that are common across all nodes that share that node-type. Therefore, composition of a node with a node-type improves extensibility by allowing the generation of specialized node functionalities for specific application areas. Such extensibility is not present in prior art graph-based models. As illustrated in FIG. 3A, the generic node 302 and the node-type 308 are one logical unit that is not separated in the context of an overlay system at run-time (e.g., in the context of execution of an executable graph-based model).

FIG. 3A further shows the plurality of predetermined node-types 326 which provides a non-exhaustive list of node-types for the node-type 308 associated with the generic node 302. The plurality of predetermined node-types 326 includes a vertex node-type 328 and an edge node-type 330. The vertex node-type 328 (also referred to as a data node-type or a value node-type) includes common data structures and functionality related to the ‘things’ modeled in the graph (e.g., the data). The edge node-type 330 includes common data structures and functionality related to coupling/linking/associating two or more nodes. A node having the edge node-type 330 may connect two or more nodes and thus the edge node-type 330 constructs associations and connections between nodes (for example, objects or ‘things’) within the executable graph-based model 100. The edge node-type 330 is not restricted to the number of nodes that can be associated or connected by a node having the edge node-type 330. The data structures and functionality of the edge node-type 330 thus define a hyper-edge which allows two or more nodes to be connected through a defined set of roles. A role defines a connective relationship between the two or more nodes, and hence, allows an edge node to connect two or more nodes such that the two or more nodes may have more than one relationship therebetween.

The plurality of predetermined node-types 326 further includes an overlay node-type 332 and a role node-type 334. As will be described in more detail below, a node with the overlay node-type 332 is used to extend the functionality of a node, such as the generic node 302, to incorporate processing logic. Unlike non-overlay nodes, an overlay node (e.g., a node having the overlay node-type 332) includes processing logic which determines the functionality of the overlay node. The processing logic of an overlay node includes a block of executable code, or instructions, which carries out one or more operations associated with the communication of data within the executable graph-based model 100. The block of executable code is pre-compiled code, code that requires interpretation at run-time, or a combination of both. Different overlay nodes provide different processing logic to realize different functionality. For example, an encryption overlay node includes an encryption technique using which an associated node is to be protected/secured and processing logic for facilitating such security/protection of the associated node. A generic node 302 with the overlay node-type 332 may be a standard operations overlay node or a video action overlay node. The overlay node-type 332 may be a standard operations overlay node-type or a video action overlay node-type. In an instance, when the generic node 302 may have processing logic, that when executed, may cause a video operation to be performed based on an associated video node, the generic node may correspond to a video action overlay node. In another instance, when the generic node 302 may include processing logic, that when executed may perform one or more standard operations on an associated node (for example, a video node) that may be different from video operations, the generic node 302 may correspond to a standard operations overlay node. The standard operations may refer to one or more operations that may be internal to the overlay system 202. The generic node 302 with the overlay node-type 332 may be a generic overlay node (for example, a generic standard operations overlay node and a generic video action overlay node). The executable graph-based model 100 may include a plurality of generic standard operations overlay nodes and a plurality of generic video action overlay nodes.

The role node-type 334 defines a connective relationship between two nodes, for example, an edge node and a first vertex node. A node with the role node-type 334 defines a relationship without expressly defining the first vertex node to which the edge node connects. A number of roles (and thus a number of connections) that an edge node-type can have is not limited.

The one or more attributes 310 correspond to the data associated with the generic node 302 (e.g., the data represented by the generic node 302 within the executable graph-based model 100 as handled by the data management module 214). Notably, a node in the executable graph-based model 100 that is not associated with data may not have any attributes. The one or more attributes 310 represent a complex data type. Each attribute of the one or more attributes 310 is composed of an attribute behavior. Attribute behavior may be one of a standard attribute behavior, a reference attribute behavior, a derived attribute behavior, or a complex attribute behavior. The attribute behavior of each attribute defines the behavior of the corresponding attribute. The attribute behavior of each attribute may be configured by associated attribute configurations. The attribute configurations are examples of attribute configuration extensions which are node configuration extensions (e.g., they are part of the one or more node configuration extensions 324 of the generic node 302 shown in FIG. 3A). The standard attribute behavior may be configured by a standard attribute configuration, the reference attribute behavior may be configured by a reference attribute configuration, the derived attribute behavior is configured by a derived attribute configuration, and the complex attribute behavior is configured by a complex attribute configuration.

The attribute behavior defines the behavior of the corresponding attribute. The standard attribute behavior is a behavior that allows read-write access to the data of the corresponding attribute. The reference attribute behavior is a behavior that allows read-write access to the data of the corresponding attribute but restricts possible values of the data to values defined by a reference data set. The reference attribute configuration associated with the reference attribute behavior includes appropriate information to obtain a reference data set of possible values. The derived attribute behavior is a behavior that allows read-only access to data of the corresponding attribute. Also, data of the corresponding attribute is derived from other data or information, within the executable graph-based model 100 in which an executable node of the corresponding attribute is used. The data is derived from one or more other attributes associated with the node or is derived from more complex expressions depending on the application area. In one embodiment, the derived attribute configuration (which is used to configure the derived attribute behavior) includes mathematical and/or other forms of expressions (e.g., regular expressions, templates, or the like) that are used to derive the data (value) of the corresponding attribute. The complex attribute behavior is a behavior that allows the corresponding attribute to act as either a standard attribute behavior if the data of the corresponding attribute is directly set, or a derived attribute behavior if the data of the corresponding attribute is not directly set.

As shown, the generic node 302 further includes the metadata 312 (e.g., data stored as a name, a confidentiality indicator for indicating data as sensitive and/or confidential, an average processing time required for processing data, or the like) which is associated with either the generic node 302 or an attribute (for example, the one or more attributes 310) of the generic node 302. An attribute within the one or more attributes 310 may either have an independent state or a shared state. That is to say, an attribute may be a value-shared attribute or a non-value-shared attribute. An independent attribute has data that is not shared with any other node within the executable graph-based model 100. Conversely, a shared attribute has data that is shared with one or more other nodes within the executable graph-based model 100. For example, if two nodes within the executable graph-based model 100 comprise a shared-data attribute with a value state shared by both nodes, updating the data (e.g., the value) of this shared attribute will be reflected across both nodes.

The node configuration 314 provides a high degree of configurations for the different elements of the generic node 302. The node configuration 314 optionally includes the one or more node configuration strategies 322 and/or the one or more node configuration extensions 324 which are complex data types. An example of a concrete node configuration strategy is an ID strategy, associated with the configuration of the unique ID 304a of the generic node 302, which creates message source IDs. A further example of the concrete node configuration strategies 322 is a versioning strategy, associated with the configuration of the version ID 304b of the generic node 302, which supports major and minor versioning (depending on the type of transactional change incurred by the generic node 302). The versioning strategy may be adapted to a native filing system of a user device hosting the overlay system 202 or a third-party data storage (for example, Snowflake®, or the like) associated with the overlay system 202. All attribute configurations may be examples of node configuration extensions 324.

FIG. 3B is a block diagram 300B that illustrates a standard structure of a run-time node 336 within the executable graph-based model 100, consistent with disclosed embodiments of the present disclosure. Referring to FIG. 3B, the run-time node 336 corresponds to the core structure of the executable graph-based model 100 and forms the foundational building block for all data and processing logic within the executable graph-based model 100. The run-time node 336 is shown to include a node template 338 and a node instance 340. The node instance 340 is generated according to the node template 338. The node template 338 forms a data structure for the node instance 340. The run-time node 336 is shown in FIG. 3B is a compositional structure that is generated and executed, at run-time as part of the executable graph-based model 100. In other words, the node template 338 is defined as ‘offline’ and the node instance 340 and the run-time node 336 may be run-time structures that may be dynamically generated during execution of the executable graph-based model 100.

The node template 338 comprises a predetermined node structure. Further, the node template 338 defines one or more rules that govern the generation of the node instance 340. The node instance 340 is an implementation of the node template 338. In other words, the node instance 340 is generated based on the predetermined node structure and the one or more rules of the node template 338. The node template 338 cannot be modified during the execution but may be modified during offline mode or at rest. During execution, only the node instance 340 of the run-time node 336 may be modified.

The node template 338 may include properties 342, node type template 343, inheritance IDs 344, and a set of attribute templates 346. The node template 338 may optionally include metadata 348 and node configuration 350. The properties 342 of the node template 338 include a unique identifier (ID) 342a, a version ID 342b, a namespace 342c, a name 342d, and optionally include one or more icons 342e and a set of labels 342f. The inheritance IDs 344 comprise an abstract flag 352, a leaf flag 354, and a root flag 356. The node configuration 350 optionally comprises one or more node configuration strategies 358 and/or one or more node configuration extensions 360. FIG. 3B further shows a plurality of predetermined node type templates 362. The plurality of predetermined node type templates 362 may include a vertex node type template 364, an edge node type template 366, and an overlay node type template 368. Further, the node instance 340 may include a unique ID 370, a version ID 372, a node type instance 374, and a set of attribute instances 376. The node instance 340 may optionally include metadata 378. FIG. 3B further shows a plurality of predetermined node type instances 380. The plurality of predetermined node type instances 380 include a vertex node type instance 382, an edge node type instance 384, and an overlay node type instance 386.

The unique ID 342a is unique for each node template within the executable graph-based model 100. Similarly, the unique ID 370 is unique for each node instance within the executable graph-based model 100. The unique ID 342a and the unique ID 370 may be used to register, manage, and reference the node template 338 and the node instance 340, respectively, within the overlay system 202. The version ID 342b of the node template 338 represents a version of the node template 338. The version ID 342b gets incremented when the node template 338 undergoes a transactional change. Similarly, the version ID 372 of the node instance 340 represents a version of the node instance 340. The version ID 372 gets incremented when the node instance 340 undergoes a transactional change. The namespace 342c of the node template 338, along with the name 342d of the node template 338, is used to organize node templates within the executable graph-based model 100. That is, the node template 338 is assigned a unique name 342d within the namespace 342c such that the name 342d of the node template 338 need not be unique within the entire executable graph-based model 100, only within the context of the namespace 342c to which the node template 338 is assigned. The node template 338 optionally comprises one or more icons 342e which may be used to provide a visual representation of the node template 338. The one or more icons 342e can include icons at different resolutions and display contexts such that the visualization of the node is adapted to different display contexts and settings. The node template 338 also optionally comprises the set of labels 342f which may be used to override the name 342d when the node template 338 is rendered or visualized.

The node template 338 supports the software development feature of multiple inheritance by maintaining references (not shown) to zero or more other node templates, which then act as the base of the node template 338. This allows the behavior and functionality of a node template to be extended or derived from one or more other node templates within an executable graph-based model. The node instance 340 likewise supports multiple inheritance because it is an instance representation of the node template 338. The multiple inheritance structure of the node instance 340 is, however, limited to the corresponding instance realization of the multiple inheritance structure defined by the node template 338, i.e., one node instance 340 is created and managed for each node template 338 defined in the inheritance hierarchy for a node instance of a node template.

The inheritance IDs 344 of the node template 338 provide an indication of the inheritance-based information, which is applicable, or can be applicable, to the node template 338. The node template 338 supports the concept of inheritance of data and processing logic associated with any other node template of the executable graph-based model 100 that is inherited by the node template 338. This allows the behavior and functionality of the node template 338 to be extended or derived from the inherited node template of the executable graph-based model 100. The inheritance IDs 344 of the node template 338 indicate the inheritance-based information, which may apply to the node template 338. The inheritance IDs 344 comprise a set of Boolean flags that identify the inheritance structure of the run-time node 336. The abstract flag 352 allows the node template 338 to support the construct of abstraction. When the abstract flag 352 takes a value ‘true’, the node template 338 is flagged as abstract that is to say that it cannot be instantiated or created within an executable graph-based model (e.g., the executable graph-based model 100). Thus, in an instance when the node template 338 has the abstract flag 352 set to ‘true’, the node template 338 may only form the foundation of other node templates that inherit therefrom. By default, the abstract flag 352 of the node template 338 is set to ‘false’. The leaf flag 354 is used to indicate whether any other node template may inherit from the node template 338. If the leaf flag 354 is set to ‘true’, then no other node template may inherit from the node template 338 (but unlike an abstract node, a node with the leaf flag 354 set may be instantiated and created within the executable graph-based model 100). The root flag 356 is used to indicate whether the node template 338 inherits from any other node template. If the root flag 356 is set to ‘true’, the node template 338 does not inherit from any other node. The node template 338 is flagged as leaf (e.g., the leaf flag 354 is set to ‘true’) and/or root (e.g., the root flag 356 is set to ‘true’), or neither (e.g., both the leaf flag 354 and the root flag 356 may be set to ‘false’). It will be apparent to a person skilled in the art that a node cannot be flagged as both abstract and leaf (e.g., the abstract flag 352 cannot be set to ‘true’ whilst the leaf flag 354 is set to ‘true’).

In instances when nodes of the executable graph-based model 100 may be run-time nodes, all elements within the executable graph-based model 100 may be defined as node templates or node instances. The functionality of the node template 338 and the node instance 340 may be realized due to the use of the node type template 343 and the node type instance 374. The node type template 343 of the node template 338 is used to extend the functionality of the node template 338 by defining the standard set of capabilities, including data and associated behavior. The vertex node type template 364 (also referred to as a data node type) may include a template of common data structures and functionality related to the ‘things’ modeled in the graph (e.g., the data). The vertex node type instance 382 may include the common data structures and functionality related to the ‘things’ modeled in the graph based on the vertex node type template 364. The edge node type template 366 may include a template of common data structures and functionality related to joining two or more nodes. A node instance having the edge node type instance 384 may connect two or more nodes and thus the edge node type instance 384 constructs associations and connections between nodes (for example objects or ‘things’) within the executable graph-based model 100. The edge node type instance 384 is not restricted to the number of nodes that can be associated or connected by a node having the edge node type instance 384. The data structures and functionality of the edge node type instance 384 thus define a hyper-edge which allows two or more nodes to be connected through a defined set of roles. A role defines a connective relationship between the two or more nodes, and hence, allows an edge node to connect two or more nodes such that the two or more nodes may have more than one relationship therebetween. The plurality of predetermined node type templates 362 may further include the overlay node type template 368. The overlay node type template 368 is used to extend the functionality of a node template (e.g., the node template 338) to incorporate processing logic. Similarly, the overlay node type instance 386 is used to extend the functionality of a node instance (e.g., the node instance 340) to incorporate processing logic. The run-time node 336 having the node template 338 with the overlay node type template 368 and the overlay node type instance 386 may be a run-time overlay node (for example, a run-time standard operations overlay node and a run-time video action overlay node). The executable graph-based model 100 may include a plurality of run-time standard operations overlay nodes and a plurality of run-time video action overlay nodes.

The set of attribute templates 346 corresponds to the data defined by the node template 338. For example, the set of attribute templates 346 may define the names and value types (e.g., integer, string, float, etc.) of one or more attributes but not the values of these attributes. The values of the set of attribute templates 346 may be defined by the set of attribute instances 376 of the node instance 340 through one or more values or instance values. For example, the node template 338 may define a string attribute ‘surname’ and the corresponding node instance 340 may assign the instance value ‘Bell-Richards’ to this string attribute. Each attribute instance of the set of attribute instances 376 may be associated with an attribute template of the set of attribute templates 346. The node template 338 may define one or more default values for the set of attribute templates 346. The default values correspond to the values that the attributes take if no value is assigned. The metadata 348 (e.g., data stored as a name, a value type, and a value triplet) may be associated with either the node template 338 or one or more of the set of attribute templates 346 of the node template 338. Similarly, the node instance 340 also optionally comprises the metadata 378 (e.g., data stored as a name, a value type, and a value triplet) which may be associated with either the node instance 340 or one or more of the set of attribute instances 376.

The node configuration 350 provides a high degree of configurability for the different elements of a node template and/or a node instance. An example of a concrete node configuration strategy is an ID strategy, associated with the configuration of the unique ID 342a of the node template 338. A further example of a concrete node configuration strategy is a versioning strategy, associated with the configuration of the version ID 342b of the node template 338 which supports major and minor versioning (depending on the type of transactional change incurred). The versioning strategy may be adapted to a native filing system of a user device hosting the overlay system 202 or a third-party data storage (for example, Snowflake®, or the like) associated with the overlay system 202.

It will be apparent to a person skilled in the art that each run-time node of the executable graph-based model 100 has a standard structure that is similar to the run-time node 336 of FIG. 3B.

FIG. 4A is a block diagram 400A that illustrates a standard structure of a generic video node 402 within the executable graph-based model 100, consistent with disclosed embodiments of the present disclosure. Referring to FIG. 4A, the generic video node 402 corresponds to the core structure of the executable graph-based model 100 and forms the foundational building block for various data and processing logics within the executable graph-based model 100. The standard structure of the generic video node 402 is derived from the standard structure of the generic node 302. The generic video node 402 includes properties 404, inheritance IDs 406, attributes 408, metadata 410, and a node configuration 412.

The properties 404 include a unique ID 404a, a version ID 404b, a namespace 404c, a name 404d, one or more icons 404e, one or more labels 404f, and one or more alternative IDs 404g. The properties 404 of the generic video node 402 may have a description similar to the description of the properties 304 of the generic node 302. In other words, the unique ID 404a, the version ID 404b, the namespace 404c, the name 404d, the one or more icons 404e, the one or more labels 404f, and the one or more alternative IDs 404g may have a description similar to the description of the unique ID 304a, the version ID 304b, the namespace 304c, the name 304d, the one or more icons 304e, the one or more labels 304f, and the one or more alternative IDs 304g, respectively, of the generic node 302.

The inheritance IDs 406 of the generic video node 402 include an abstract flag 414, a leaf flag 416, and a root flag 418. The inheritance IDs 406 of the generic video node 402 may have a description similar to the description of the inheritance IDs 306 of the generic node 302. In other words, the abstract flag 414, the leaf flag 416, and the root flag 418 may have a description similar to the description of the abstract flag 316, the leaf flag 318, and the root flag 320, respectively, of the generic node 302.

The node configuration 412 of the generic video node 402 includes node configuration strategies 420 and node configuration extensions 422. The node configuration 412 is same as the node configuration 314 of the generic node 302. In other words, the node configuration strategies 420 and the node configuration extensions 422 of the generic video node 402 may have a description similar to the description of the node configuration strategies 322 and the node configuration extensions 324, respectively, of the generic node 302.

The generic video node 402 further has an edge node-type 423. The edge node-type 423 may have a description similar to the description of the edge node-type 330. The generic video node 402 with the edge node-type 423 may further include features of a role node-type that may have a description similar to the description of the role node-type 334.

Further, the generic video node 402 may include image configurations 424 indicative of various configurations, data, information, or the like associated with a plurality of image frames of a video of the external system represented by the generic video node 402. The image configurations 424 may include metadata, temporal data, dimensions (height and width), resolution, aspect ratio, color depth, file format, compression type, pixel composition (e.g., RGB or grayscale), or the like associated with each image frame of the video being represented by the generic video node 402. In addition, the generic video node 402 may include a video reference 425 that may be a storage location, a pointer, a uniform resource locator (URL), or the like associated with the video represented by the generic video node 402. The video reference 425 may be used to access the video represented by the generic video node 402.

FIG. 4B is a block diagram 400B that illustrates a standard structure of a run-time video node 426 within the executable graph-based model 100, consistent with disclosed embodiments of the present disclosure. Referring to FIG. 4B, the run-time video node 426 corresponds to the core structure of the executable graph-based model 100 and forms the foundational building block for all data and processing logic within the executable graph-based model 100. The standard structure of the run-time video node 426 may be derived from the standard structure of the run-time node 336. The run-time video node 426 is shown to include a node template 428 and a node instance 430. The node template 428 of the run-time video node 426 may correspond to a video node template whereas the node instance 430 of the run-time video node 426 may correspond to a video node instance. The node instance 430 is generated according to the node template 428. The node template 428 forms a data structure for the node instance 430. Notably, the node template 428 corresponds to a predefined video node structure. The node template 428 includes a reference (for example, a pointer, an identifier, or the like) to node template of each run-time node associated with the run-time video node 426. Similarly, the node instance 430 may include a reference (for example, a pointer, an identifier, or the like) to node template of each run-time node associated with the run-time video node 426. The run-time video node 426 shown in FIG. 4B is a compositional structure that is generated and executed, at run-time as part of the executable graph-based model 100. In other words, the node template 428 is defined as ‘offline’ and the node instance 430 and the run-time video node 426 may be run-time structures that may be dynamically generated during execution of the executable graph-based model 100.

The node template 428 may have a description similar to the node template 338 described in conjunction with FIG. 3B. Similarly, the node instance 430 may have a description similar to the node instance 340 described in conjunction with FIG. 3B.

The node template 428 may include properties 432, inheritance IDs 434, and a set of attribute templates 436. The node template 428 may optionally include metadata 438 and node configuration 440. The properties 432 of the node template 428 include a unique identifier (ID) 432a, a version ID 432b, a namespace 432c, a name 432d, and optionally include one or more icons 432e and a set of labels 432f. The inheritance IDs 434 comprise an abstract flag 442, a leaf flag 444, and a root flag 446. The node configuration 440 optionally comprises one or more node configuration strategies 448 and/or one or more node configuration extensions 450. Further, the node instance 430 may include a unique ID 452, a version ID 454, and a set of attribute instances 456. The node instance 430 may optionally include metadata 458.

The properties 432 of the node template 428 may have a description that is similar to the description of the properties 342 described in conjunction with FIG. 3B. In other words, the unique ID 432a, the version ID 432b, the namespace 432c, the name 432d, the icons 432e, and the set of labels 432f have descriptions that may be similar to descriptions of the unique ID 342a, the version ID 342b, the namespace 342c, the name 342d, the icons 342e, and the set of labels 342f, respectively, shown in FIG. 3B.

The inheritance IDs 434 of the node template 428 may have a description that is similar to the inheritance IDs 344 of the node template 338. In other words, the abstract flag 442, the leaf flag 444, and the root flag 446 may have descriptions that may be similar to the abstract flag 352, the leaf flag 354, and the root flag 356, respectively, shown in FIG. 3B.

The set of attribute templates 436 has a description that is similar to the description of the set of attribute templates 346 described in conjunction with FIG. 3B. The metadata 438 has a description that is similar to the metadata 348 depicted in FIG. 3B. Similarly, the set of attribute instances 456 has a description that is similar to the set of attribute instances 376 of FIG. 3B and the metadata 458 have a description that is similar to the metadata 378 of FIG. 3B.

The node configuration 440 has a description that may be similar to the node configuration 350 of FIG. 3B. In other words, descriptions of the node configuration strategies 448 and the node configuration extensions 450 may be similar to the descriptions of the node configuration strategies 358 and the node configuration extensions 360, respectively, of FIG. 3B.

The node template 428 and the node instance 430 may have edge node type template 460 and edge node type instance 462. The edge node type template 460 may have a description similar to the edge node type template 366 and the edge node type instance 462 may have a description similar to the edge node type instance 384. Therefore, the run-time video node 426 may have an edge node-type.

Moreover, the run-time video node 426 may further include a plurality of image configurations of a plurality of image frames of a video being represented thereby in the executable graph-based model 100. To enable such a representation, as shown, the node template 428 may further include an image configuration template 464 that may define a template for storing the image configurations of the image frames of the video. The node instance 430 may further include an image configuration instance 466 that may include values of the image configurations of the image frames to be stored based on the image configuration template 464.

The run-time video node 426 may further include a video reference of the video being represented thereby in the executable graph-based model 100. To enable such a representation, as shown, the node template 428 may further include a video reference template 468 that may define a template for storing the video reference of the video. The node instance 430 may further include a video reference instance 470 that may include a reference value of the video reference of the video to be stored based on the video reference template 468.

A video node (for example, a generic video node and a run-time video node) may represent a video in the overlay system 202 based on association thereof with a plurality of image configurations of a plurality of image frames of the video. In addition, the video node also includes a video reference (for example, a pointer, a storage location, a URL, or the like) associated with the video. The video reference may be used to directly or indirectly access the video in the external system.

Notably, a generic node (for example, the generic node 302), a run-time node (for example, the run-time node 336), a generic video node (for example, the generic video node 402), and a run-time video node (for example, the run-time video node 426) when associated with an overlay node may be referred to as an executable generic node, an executable run-time node, an executable generic video node, and an executable run-time video node, respectively. An overlay associated with a node (for example, a generic node, a run-time node, a generic video node, and a run-time video node) may extend functionality thereof. An overlay node (for example, a standard operations overlay node or a video action overlay node) that has a node structure as described in conjunction with FIG. 3B may be a run-time overlay node (for example, a run-time standard operations overlay node and a run-time video action overlay node). In other words, a standard operations overlay node having a node structure similar to the run-time node 336 may correspond to a run-time standard operations overlay node whereas, a video action overlay node having a node structure similar to the run-time node 336 may correspond to a run-time video action overlay node.

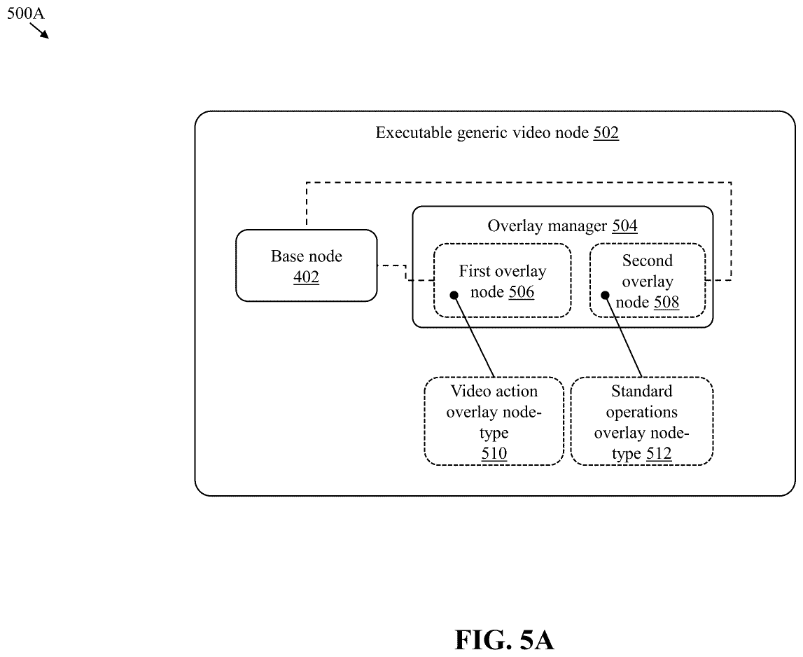

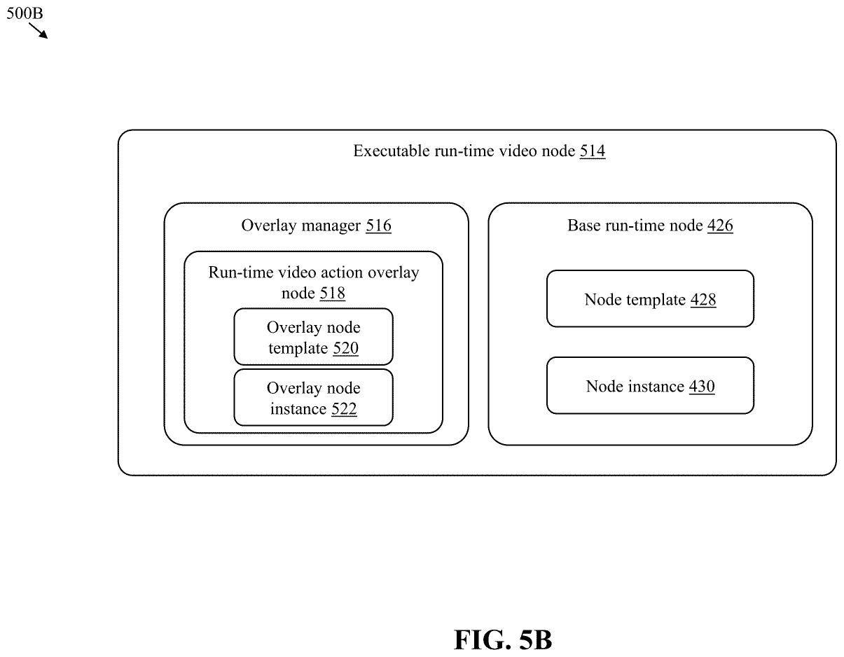

FIG. 5A is a block diagram 500A that illustrates an executable generic video node 502 within the executable graph-based model 100, consistent with disclosed embodiments of the present disclosure. Referring to FIG. 5A, the executable generic video node 502 is shown to include a base node (e.g., the generic video node 402) and an overlay manager 504. For the sake of ongoing discussion, the base node corresponds to the generic video node 402, and is hereinafter referred to as the “base node 402”. The base node 402, when extended by way of one or more overlay nodes (for example, standard operations overlay node and video action overlay nodes), becomes the executable generic video node 502.

The executable generic video node 502 provides processing functionality (e.g., processing logic) to the base node 402 via one or more associated overlay nodes (for example, first and second overlay nodes 506 and 508, respectively). Beneficially, the data and processing capability of the base node 402 may be dynamically and significantly extended using the concept of an executable node (for example, the executable generic video node 502). As shown, the first overlay node 506 has a video action overlay node-type 510, and the second overlay node 508 has a standard operations overlay node-type 512.

The video action overlay node-type 510 may be a video generation overlay node-type, a video modification overlay node-type, a video analyzer overlay node-type, a video deletion overlay node-type, or a rollback overlay node-type.

Based on the video action overlay node-type 510 being the video generation overlay node-type, the first overlay node 506 may be a video generation overlay node. The first overlay node 506 may include processing logic that when executed may cause creation of a video in the external system and/or an associated video node representing a video of the external system.

Based on the video action overlay node-type 510 being the video modification overlay node-type, the first overlay node 506 may be a video modification overlay node. The first overlay node 506 may include processing logic that when executed may cause modification of a video being represented by a video node associated therewith. In addition, the processing logic when executed may also cause modification of the associated video node.

Based on the video action overlay node-type 510 being the video analyzer overlay node-type, the first overlay node 506 may be a video analyzer overlay node. The first overlay node 506 may include processing logic that when executed may cause analysis of different parameters, a plurality of image configurations of a plurality of image frames of a video being represented by the video node associated therewith.

Based on the video action overlay node-type 510 being the video deletion overlay node-type, the first overlay node 506 may be a video deletion overlay node. The first overlay node 506 may include processing logic that when executed may cause deletion of a video of the external system represented by the video node associated therewith. In addition, the processing logic when executed may also cause deletion of the associated video node.

Based on the video action overlay node-type 510 being the rollback overlay node-type, the first overlay node 506 may be a rollback overlay node. The first overlay node 506 may include processing logic that when executed may cause a desired set of video operations executed on the video represented by the associated video node to be ineffective and consequently may cause a video of the external system to roll back to a previous state. In addition, the processing logic when executed may also cause the associated video node to roll back to a previous node state.

Examples of a video action overlay node (for example, the first overlay node 506) may include, but are not limited to, a video capture overlay, a video display overlay video compression overlay, a video decompression overlay, a video resizing overlay, a video cropping overlay, a video rotation overlay, a frame extraction overlay, a color adjustment overlay, a video filtering overlay, a noise reduction overlay, a video enhancement overlay, a video segmentation overlay, an object tracking overlay, a motion analysis overlay, a temporal filtering overlay, a video registration overlay, a geometric transformations overlay, a video editing overlay, a video analysis and measurement overlay (namely, video analyze overlay node or analyzer overlay node), an object recognition overlay.

A video capture overlay node may include processing logic that when executed may perform capturing or acquiring of a plurality of image frames of a video using a video action module i.e., a video creation module (for example, camera or other videography device) of the external system. The video capture overlay node may acquire a plurality of image configurations of a plurality of image frames of a video captured using the video action module. The video capture overlay node may instantiate a video node, in the executable graph-based model 100, representing the plurality of image configurations of the plurality of image frames of the captured video.

A video display overlay node may include processing logic that when executed may cause a display device of the overlay system 202 or the external system to display a video being represented by a video node associated with the video display overlay node.

A video compression overlay node may include processing logic that when executed may cause a reduction of a file size of a video being represented by a video node associated therewith.

A video decompression overlay node may include processing logic that when executed may cause expansion of a compressed video file of a video being represented by a video node associated therewith.

A video resizing overlay node may include processing logic that when executed may cause a change in dimensions of a plurality of image frames of a video being represented by a video node associated therewith.

A video cropping overlay node may include processing logic that when executed may cause removal of unwanted portions of a plurality of image frames of a video represented by an associated video node.

A video rotation overlay node may include processing logic that when executed may cause a change in an orientation of a plurality of image frames of a video represented by an associated video node. The change in orientation may be of any degree, for example, 90, 180, 270 degrees, or any other magnitude of degrees.

A frame extraction overlay node may include processing logic that when executed may cause extraction of one or more image frames of a plurality of image frames of a video being represented by an associated video node. The extraction of the one or more image frames may be performed for analysis of the video or for creation of still images or analyzed image frames.

A color adjustment overlay node may include processing logic that when executed may cause modification of color balance, brightness, contrast, saturation, or other color-related attributes of a video being represented by an associated video node.

A video filtering overlay node may include processing logic that when executed may apply filters (for example, blurring, sharpening, high-pass, low-pass, band-pass filtering, or the like) or convolution operations to enhance or modify specific features of a video represented by an associated video node.

A noise reduction overlay node may include processing logic that when executed may cause removal of unwanted noise or artifacts from a video represented by an associated video node.

A video enhancement overlay node may include processing logic that when executed may cause application of techniques to improve visual quality (for example, sharpening details or adjusting the overall appearance) of a video represented by an associated video node.

A video segmentation overlay node may include processing logic that when executed may cause division of a video, being represented by an associated video node, into distinct segments or scenes based on certain criteria, such as content or motion.

An object tracking overlay node may include processing logic that when executed may cause tracking or monitoring of movements of objects or patterns of a video being represented by an associated video node.

A motion analysis overlay node may include processing logic that when executed may cause analysis of motion patterns or flow of objects within a video represented by an associated video node. Such an analysis may be performed for execution of tasks such as action recognition or behavior analysis.

A temporal filtering overlay node may include processing logic that when executed may cause application of filters or operations across a temporal dimension of a video being represented by an associated video node. Such application of filters or operations may be performed to address changes in the video over time.

A video registration overlay node may include processing logic that when executed may cause aligning of image frames of multiple videos, represented by associated video nodes, to a common coordinate system for comparison or analysis.

A geometric transformation overlay node may include processing logic that when executed may cause application of geometric transformations (for example, scaling, translation, shearing, or the like) to modify spatial arrangement of video elements of a video represented by an associated video node.

A video editing overlay node may include processing logic that when executed may cause execution of editing tasks such as cutting, splicing, and rearranging video segments to create a final edited version of a video being represented by an associated video node.

A video analysis and measurement overlay node may include processing logic that when executed may cause one or more videos, represented by associated video nodes, to be analyzed to (i) extract quantitative information, (ii) measure features, or (iii) perform statistical analysis.

An object recognition overlay node may include processing logic that when executed may cause identification and classification of objects or patterns within a video represented by an associated video node. The object recognition overlay node may use machine learning or computer vision algorithms for such identification and classification. The video may be provided as an input to an artificial neural network (ANN) implemented by the object recognition overlay node optionally in combination with one or more other video action overlay nodes. The video may undergo a chain of video functions as stated above before being converted to a set of appropriate vectors defined in the ANN. An output of the ANN may be returned to the originating video node for further processing and storage.

A video action overlay node may include a module reference of a corresponding video action module of the external system. Based on the module reference, the video action module may communicate with the corresponding video action module and cause a corresponding operation to be performed on a video of the external system being represented by an associated video node. The video action overlay node may cause the corresponding operation to be executed by way of the corresponding video action module of the external system.

The second overlay node 508 with the standard operations overlay node-type 512 may perform various operations associated with the overlay system 202 that may have to be performed within the overlay system 202 and without interacting with the external system or any component of the external system. Examples of the standard operations overlay node-type 512 may include, but are not limited to, a subscriber overlay node-type, a publisher overlay node-type, and an encryption overlay node-type.

A node with the subscriber overlay node-type is a subscriber overlay node that is indicative of an operation of receiving an input from an associated node (for example, the video node). The subscriber overlay node also includes processing logic to receive the input. A node with the publisher overlay node-type is a publisher overlay node that is indicative of an operation of publishing an output of an associated node. The publisher overlay node also includes processing logic to publish the output. A node with the encryption overlay node-type is an encryption overlay node that is indicative of an encryption technique using which an associated node (for example, a video node) is to be secured. The encryption overlay node also includes processing logic to secure a corresponding node. Examples of the encryption technique include a symmetric encryption algorithm, an asymmetric encryption algorithm, a combination of these, or any other encryption technique.

Although, the executable generic video node 502 is assumed to include the first and second overlay nodes 506 and 508 and, in other embodiments, the executable generic video node 502 may include any number of overlay nodes, without deviating from the scope of the present disclosure.

The executable generic video node 502 extends the base node 402 (or is a subtype of the base node 402) such that all the functionality and properties of the base node 402 are accessible to the executable generic video node 502. The executable generic video node 502 also dynamically extends the functionality of the base node 402 by associating the first and second overlay nodes 506 and 508 maintained by the overlay manager 504 with the base node 402. The executable generic video node 502 may thus be considered a combination of the base node 402 and the first and second overlay nodes 506 and 508. The executable generic video node 502 may be alternatively referred to as a node with overlay(s). Therefore, the executable generic video node 502 acts as a decorator of the base node 402 adding the functionality of the overlay manager 504 to the base node 402.

It will be apparent to a person skilled in the art that the base node 402 may correspond to any suitable generic video node within the executable graph-based model 100. Alternatively, the base node 402 may be an executable generic video node such that the functionality of the (executable) base node 402 is dynamically extended. In this way, complex and powerful processing functionality can be dynamically generated by associating and extending overlay nodes.

Extending the functionality of a base node through one or more overlay nodes is at the heart of the overlay system 202. As illustrated in FIG. 2, the data (e.g., a vertex node as represented by the base node 402 in FIG. 5A) and the functionality that acts upon that data (e.g., an overlay node) can be separated and independently maintained offline, but at run-time, an association between the data node and the overlay node is determined and an executable video node is generated (e.g., the executable generic video node 502 shown in FIG. 5A).

It will be apparent to a person skilled in the art that functionalities of the first and second overlay nodes 506 and 508 may be performed by a single overlay node that includes processing logic associated with both the first and second overlay nodes.

It will be apparent to a person skilled in the art that the list of overlay types (for example, the video action overlay node-type 510 and the standard operations overlay node-type 512) is not exhaustive and the number of different overlay types that can be realized is not limited. Because an overlay node is itself a node, all functionality of a node described in relation to the base node 402 is thus applicable to an overlay node. For example, an overlay node (for example, the first and second overlay nodes 506 and 508) includes a unique ID, a name, etc., can have attributes (e.g., an overlay node can have its data defined), supports multiple inheritance, and can be configured via node configurations. Furthermore, because an overlay node (for example, the first and second overlay nodes 506 and 508) is a node, the overlay node can have one or more overlay nodes associated therewith (e.g., the overlay node may be an overlay node with an overlay). Moreover, the processing functionality of an overlay node (for example, the first and second overlay nodes 506 and 508) extends to the node-type of the node to which the overlay node is applied.

An overlay node, such as the first overlay node 506 or the second overlay node 508, is not bound to a single executable video node or a single executable graph-based model (unlike nodes that have non-overlay node-types). This allows overlay nodes (for example, the first and second overlay nodes 506 and 508) to be centrally managed and reused across multiple instances of executable graph-based models. Notably, a node (for example, a base node, an executable node, and an overlay node) may be extended by way of overlays. Further, each overlay node may be extended to have one or more overlays. Such overlays may be termed chaining overlays. Also, a single overlay node may be associated with multiple executable nodes. Thus, the overlay node and functionality thereof may be shared among the multiple executable nodes.

The overlay manager 504 of the executable generic video node 502 is responsible for executing all overlays registered therewith. The overlay manager 504 also coordinates the execution of all associated overlay nodes. As shown in FIG. 5A, the executable generic video node 502 associates the base node 402 with two overlay nodes that is the first overlay node 506 and the second overlay node 508. Thus, the overlay manager 504 employs a strategy to manage the potentially cascading execution flow. Example strategies to manage the cascading execution of overlays include the visitor pattern and the pipe and filter pattern. Further examples include strategies that apply either breadth-first or depth-first processing patterns, a prioritization strategy, or a combination thereof. All execution strategies are defined and registered with the overlay manager 504 and are associated with an overlay via a node configuration extension for the overlay. Additionally, the overlay manager 504 may be configured to provide a set of attributes associated with the executable generic video node 502 to the first overlay node 506 and/or the second overlay node 508. The first overlay node 506 and/or the second overlay node 508 may apply/execute corresponding processing logic based on the executable generic video node 502.

It will be apparent to a person skilled in the art that a generic video node may be associated with one or more overlay nodes as described in conjunction with FIG. 5A. Further, an overlay manager of the generic video node may have a description similar to the description of the overlay manager 504.

FIG. 5B is a block diagram 500B that illustrates an executable run-time video node 514 within the executable graph-based model 100, consistent with disclosed embodiments of the present disclosure. Referring to FIG. 5B, the executable run-time video node 514 is shown to include the run-time video node 426 (hereinafter referred to as ‘the base run-time node 426’) and an overlay manager 516. The overlay manager 516 may include a run-time video action overlay node 518. The executable run-time video node 514 provides processing functionality (e.g., processing logic) to the base run-time node 426 via one or more associated overlay nodes (for example, the run-time video action overlay node 518). Beneficially, the data and processing capability of the base run-time node 426 may be dynamically and significantly extended using the concept of an executable run-time node (for example, the executable run-time video node 514).

Although, the executable run-time video node 514 is shown to include a single run-time video action overlay node 518, in other embodiments, the executable run-time video node 514 may include any number of run-time overlay nodes (for example, run-time standard operations overlay nodes, run-time video action overlay nodes). The run-time video action overlay node 518 may include an overlay node template 520 and an overlay node instance 522. The overlay node template 520 and the overlay node instance 522 may, collectively, constitute the run-time video action overlay node 518.

The executable run-time video node 514 extends the base run-time node 426 (or is a subtype of the base run-time node 426) such that all the functionality and properties of the base run-time node 426 may be accessible to the executable run-time video node 514. The executable run-time video node 514 also dynamically extends the functionality of the base run-time node 426 by associating the run-time overlay nodes maintained by the overlay manager 516 with the base run-time node 426. The executable run-time video node 514 may thus be considered a composition of the base run-time node 426 and the run-time video action overlay node 518. The executable run-time video node 514 may be alternatively referred to as a run-time video node with overlay(s). Therefore, the executable run-time video node 514 acts as a decorator of the base run-time node 426 adding the functionality of the overlay manager 516 to the base run-time node 426.

It will be apparent to a person skilled in the art that the base run-time node 426 refers to any suitable run-time video node within the executable graph-based model 100. Alternatively, the base run-time node 426 may itself be an executable node such that the functionality of the (executable) base run-time node 426 is dynamically extended. In this way, complex and powerful processing functionality can be dynamically generated by associating and extending overlay nodes.

The overlay manager 516 registers and maintains one or more run-time overlay nodes (such as the run-time video action overlay node 518) associated with the base run-time node 426. The overlay manager 516 may register and maintain the one or more run-time overlay nodes using one or more overlay node templates and one or more overlay node instances. For example, the overlay manager 516 may register the run-time video action overlay node 518 using the overlay node template 520 and the overlay node instance. The assignment of the run-time video action overlay node 518 to the base run-time node 426 (via the overlay manager 516) endows the base run-time node 426 with processing logic and executable functionality defined within the run-time video action overlay node 518. In other words, the run-time video action overlay node 518 may interact at run-time, with the node template 428 and/or the node instance 430 of the base run-time node 426. In an example, the node template 428 and the node instance 430 may be not executable nodes. That is, neither the node template 428 nor the node instance 430 comprises an overlay manager with one or more run-time overlay nodes. In another example, the node template 428 and/or the node instance 430 may be executable nodes thereby extending the functionality, complexity, and configurability of executable run-time nodes.

Extending the functionality of a base run-time node through one or more run-time overlay nodes is at the heart of the overlay system 202. As illustrated in FIG. 2, the data (e.g., a vertex node as represented by the base run-time node 426 in FIG. 5B) and the functionality that acts upon that data (e.g., an overlay node) can be separated and independently maintained offline, but at run-time, an association between the data node and the run-time overlay node is determined and an executable run-time node is generated (e.g., the executable run-time video node 514).

Each run-time overlay node comprises an overlay node template and an overlay node instance. The overlay node template is a node template with the overlay node type template. Similarly, the overlay node instance is a node instance with the overlay node type instance. The overlay node instance is an implementation of the overlay node template. The overlay node template comprises one or more generic rules that may be implemented by the processing logic of the overlay node instance. Examples of the run-time video action overlay node 518 may be same as the first overlay node 506.

A run-time standard operations overlay node, is a node having a standard operations overlay node-type. Examples of run-time standard operations overlay node-type include an encryption overlay node type, an obfuscation overlay node type, an audit overlay node type, an analytics overlay node type, a handler overlay node type, a publisher overlay node type, or the like. It will be apparent to a person skilled in the art that the list of overlay node types is not exhaustive and the number of different overlay node types that can be realized is not limited. Examples of node-type of a run-time standard operations overlay node may be same as examples of the standard operations overlay node-type 512. Examples of node-types of a run-time video action overlay node (for example, the run-time video action overlay node 518) may be same as the examples of the video action overlay node-type 510.

Because an overlay node (for example, a run-time standard operations overlay node and a run-time video action overlay node) is itself a node, all functionality of a node described in relation to the base run-time node 426 is thus applicable to an overlay node. For example, an overlay node may include a unique ID, a name, etc., can have attributes (e.g., an overlay node can have its data defined), supports multiple inheritance, and can be configured via node configurations. Furthermore, because an overlay node is a node, the overlay node can have one or more overlay nodes associated therewith (e.g., the overlay node may be an overlay node with an overlay).

A run-time overlay node, such as the run-time video action overlay node 518, is not bound to a single executable node or a single executable graph-based model (unlike nodes that have non-overlay node types). This allows run-time overlay nodes to be centrally managed and reused across multiple instances of executable graph-based models. Notably, a node (for example, a base node, a video node, an executable node, and an overlay node) may be extended by way of overlays. Further, each overlay node may be extended to have one or more overlays. Such overlays may be termed chaining overlays.

A run-time overlay node (for example, a run-time video action overlay node and a run-time standard operations overlay node) may include processing logic (not shown in FIG. 5B) which determines the functionality of the run-time overlay node. The processing logic of a run-time overlay node may include a block of executable code, or instructions, which carries out one or more operations associated with the facilitation of indexing within the executable graph-based model 100. The block of executable code is pre-compiled code, code that requires interpretation at run-time, or a combination of both. Different run-time overlay nodes provide different processing logic to realize different functionality. The overlay manager 516 of the executable run-time video node 514 is responsible for executing all overlays registered therewith. The overlay manager 516 also coordinates the execution of all associated overlay nodes. As shown in FIG. 5B, the executable run-time video node 514 associates the base run-time node 426 with the run-time video action overlay node 518.

In some embodiments, the overlay manager 516 employs a strategy to manage potentially cascading execution flow of overlays such that one overlay may be associated with one or more other overlays. Example strategies to manage the cascading execution of overlays include the visitor pattern and the pipe and filter pattern. Further examples include strategies that apply either breadth-first or depth-first processing patterns, a prioritization strategy, or a combination thereof. All execution strategies may be defined and registered with the overlay manager 516 and may be associated with an overlay via a node configuration extension for the overlay.

It will be apparent to a person skilled in the art that a run-time node may be associated with one or more run-time overlay nodes as described in conjunction with FIG. 5B. Further, an overlay manager of the run-time node may have a description similar to the description of the overlay manager 516.

Throughout the description, an executable node (for example, an executable generic node, an executable run-time node, the executable generic video node 502, and the executable run-time video node 514) is represented by way of two concentric circles. In other words, the executable node is represented by way of an inner circle encircled by an outer circle, where the inner circle represents a base node and the outer circle represents an overlay node associated with the base node.

It will be apparent to a person skilled in the art that an operation being performed by a node corresponds to an operation being performed by the processing circuitry while using the node.

Notably, a video node (for example, the generic video node 402, the run-time video node 426, the executable generic video node 502, and the executable run-time video node 514) may be a stateful node or a stateless node. The video node, being the stateful node, may be referred to as a stateful video node. Based on the video node being stateful, a node state of the video node persists in the storage element of the overlay system 202 upon unloading thereof. The node state of the video node may be used to re-generate/load the video node in the executable graph-based model 100 based on a requirement thereof. Loading of the video node is described in detail later in the description. Further, based on the video node being the stateless node, the video node may cease to exist in the storage element upon unloading thereof from the executable graph-based model 100. That is to say that, the video node may be discarded from the overlay system 202 based on the unloading thereof. The video node, being the stateless node, may be referred to as a stateless video node.

Similarly, an overlay node (for example, the first and second overlay nodes 506 and 508, and the run-time video action overlay node 518) may also be the stateful node or the stateless node. Based on the overlay node being the stateful node, a node state of the overlay node persists in the storage element of the overlay system 202 upon unloading thereof. The node state of the overlay node may be used to re-generate/load the overlay node in the executable graph-based model 100 based on a requirement thereof. The overlay node, being the stateful node, may be referred to as a stateful overlay node. Loading of the overlay node is described in detail later in the description. Further, based on the overlay node being the stateless node, the overlay node may cease to exist in the storage element upon the unloading thereof. That is to say that, the overlay node may be discarded from the overlay system 202 based on the unloading thereof. The overlay node, being the stateless node, may be referred to as a stateless overlay node.

FIG. 6 is a block diagram 600 that illustrates a composition of the executable generic video node 502 that enables persistent storage of data and processing logic associated therewith, consistent with disclosed embodiments of the present disclosure.

As described in conjunction with FIG. 5A, the executable generic video node 502 includes the base node 402 and one or more overlay nodes (e.g., the first and second overlay nodes 506 and 508, respectively). For the sake of brevity of the ongoing description, the persistent storage is explained for the executable generic video node 502 including only the first overlay node 506. One or more operations performed for ensuring the persistence of the first overlay node 506 may be performed for the second overlay node 508 as well.

Referring to FIG. 6, the executable generic video node 502 includes the base node 402 and the first overlay node 506. The executable generic video node 502 has a corresponding first state 602 having a first ID 604. The base node 402 has a second state 606 having a second ID 608, and the first overlay node 506 has a third state 610 having a third ID 612. A manifest (for example, first through third manifests 614-818) is generated for each of the base node 402, the executable generic video node 502, and the first overlay node 506. In an embodiment, the manifests may be generated by the storage management module 220. The first manifest 614 is associated with the executable generic video node 502 and has a fourth ID 620 and an overlay ID 622. The second manifest 616 is associated with the base node 402 and has a fifth ID 624. The third manifest 618 is associated with the first overlay node 506 and has a sixth ID 626. Further, the manifests are stored at respective storage locations that may be centralized or distributed storage locations associated with the overlay system 202. The manifests may be stored by the storage management module 220.

The first state 602 of the executable generic video node 502 includes data required to reconstruct the executable generic video node 502 (e.g., attributes, properties, etc.). The first state 602 of the executable generic video node 502 is persistently stored along with the first ID 604. The first manifest 614 is generated for the executable generic video node 502 and has (i) the fourth ID 620 (which is the same as the first ID 604), (ii) the storage location of the first state 602 of the executable generic video node 502, and (iii) the overlay ID 622 (which is the same as the sixth ID 626). Notably, the fourth ID 620 is the same as the first ID 604 and the fifth ID 624, hence, the first manifest 614 includes the ID of the state of the base node 402 and the executable generic video node 502. Further, the overlay ID 622 is the same as the sixth ID 626 of the state of the first overlay node 506. Therefore, the first manifest 614 may be used to identify and retrieve the states of the base node 402, the executable generic video node 502, and the first overlay node 506. Subsequently, the retrieved states may be used to reconstruct the executable generic video node 502 and the first overlay node 506. In an instance, the executable generic video node 502 may be further extended to include additional overlay nodes. In such an instance, the first manifest 614 may include state IDs of the additional overlay nodes as well. A first manifest state (not shown) is then generated for the first manifest 614 and persistently stored along with the fourth ID 620.

The second state 606 of the base node 402 includes data required to reconstruct the base node 402 (e.g., attributes, properties, etc.) and is persistently stored along with the second ID 608. The second manifest 616 is generated for the base node 402 and has the fifth ID 624 and the storage location of the second state 606 of the base node 402. The second ID 608 of the second state 606 and the fifth ID 624 of the second manifest 616 are the same as the first ID 604 of the first state 602 of the executable generic video node 502 (which is also the same as the fourth ID 620 of the first manifest 614 of the executable generic video node 502). As mentioned above, along with the first state 602, the first manifest 614 may also be used to identify and retrieve the second manifest 616 which in turn may be used to identify the second state 606 of the base node 402. A second manifest state (not shown) is then generated for the second manifest 616 and persistently stored along with the fifth ID 624. Thus, the states, manifests, and manifest states for the executable generic video node 502 and the base node 402 include the same, shared, ID. A shared ID can be used in this instance because the states, manifests, and manifest states are stored separately. The separate storage of the states, manifests, and manifest states exhibit a distributed architecture of the overlay system 202.

The third state 610 of the first overlay node 506 includes data required to reconstruct the first overlay node 506 (e.g., attributes, properties, processing logic, etc.) and is persistently stored along with the third ID 612. The third manifest 618 is generated for the first overlay node 506 and includes the sixth ID 626, which is the same as the third ID 612. Therefore, the first manifest 614 may be further used to identify and retrieve the third manifest 618 which in turn may be used to identify and retrieve the third state 610 of the first overlay node 506. A third manifest state (not shown) is then generated for the third manifest 618 and is persistently stored along with the sixth ID 626.

In operation, when the executable generic video node 502 is to be loaded, the transaction module 208, in conjunction with the storage management module 220, may execute one or more operations to retrieve the first manifest state stored at a known storage location. Based on the first manifest state, the storage management module 220 may re-construct the first manifest 614 which includes the fourth ID 620 which is the same as the fifth ID 624 of the second manifest 616. Based on the fifth ID 624, the storage management module 220 may identify the second manifest state and may generate the second manifest 616 based on which the second state 606 is identified. Subsequently, the base node 402 is loaded and the storage management module 220 may determine that the base node is a node with overlay. Based on the fourth ID 620 (that is the same as the first ID 604 of the first state 602 of the executable generic video node 502) of the first manifest 614, the first state 602 is identified and retrieved. Subsequently, the executable generic video node 502 is loaded. Moreover, based on the overlay ID 622 (that is the same as the sixth ID 626 of the third manifest 618) of the first manifest 614, the third manifest state is identified and the third manifest 618 is generated. Subsequently, based on the sixth ID 626 (that is the same as the third ID of the third state) of the third manifest 618, the third state 610 is identified and retrieved. Based on the third state 610, the first overlay node 506 is reconstructed and loaded in the executable graph-based model 100.

Based on a context of a stimulus (for example, the stimulus 230) associated with the overlay system 202, the processing logic (such as the context module 210) may determine an ID that is the same as the fifth ID 624. Based on the determined ID, the processing logic (such as the memory management module 218 and the storage management module 220) may identify the second manifest 616. Subsequently, the processing logic (such as the memory management module 218 and the storage management module 220) may identify the second state 606 that has the second ID 608 that matches the fifth ID 624. Further, the processing logic (such as the memory management module 218 and the storage management module 220) may retrieve the second state 606 associated with the second manifest 616 from a corresponding storage element. Subsequently, the processing logic (such as the memory management module 218 and the storage management module 220) may determine, by checking the manifest storage(s) associated with the overlay system 202, whether there is another manifest (such as the first manifest of the executable generic video node 502) with an ID that matches the second ID 608 and the fifth ID 624. Notably, the first manifest 614 includes storage locations of each overlay node (for example, the first overlay node 506) of the executable generic video node 502. Based on the overlay ID 622 included in the first manifest 614 that matches the sixth ID 626 included in the third manifest 618, the processing logic (such as the memory management module 218 and the storage management module 220) may identify and retrieve the third manifest 618 from a manifest storage of a plurality of manifest storages of the overlay system 202.

Subsequently, the processing logic (such as the memory management module 218 and the storage management module 220) may identify the third state 610 which has the third ID 612 that matches the sixth ID 626. Further, the processing logic (such as the memory management module 218 and the storage management module 220) may retrieve the third state 610 associated with the third manifest 618 from a corresponding storage element. To determine whether the first overlay node 506 has an overlay node associated therewith, the processing logic (such as the memory management module 218 and the storage management module 220) may also perform a check to determine whether any of the plurality of manifest storages of the overlay system 202 includes any other manifest with an ID that matches the sixth ID 626. Since the first overlay node 506 does not have an overlay associated therewith, no other manifest has the ID that matches the sixth ID.

Notably, the manifest (the third manifest 618) of the first overlay node 506 includes a reference (such as an identifier that is common to the second manifest 616 and the third manifest 618, a link, a path, a storage location, or the like) to the second manifest 616 of the base node 402. Therefore, the re-formation of the executable generic video node 502 includes a re-creation of the first overlay node 506 prior to a re-creation of the base node 402. Subsequently, the first overlay node 506 and the base node 402 are organized by associating the base node 402 with the first overlay node 506 to re-form the executable generic video node 502.

In some embodiments, the first overlay node 506 may not be loaded in case it is not required for executing the operation associated with the stimulus 230. The loaded executable generic video node 502 and the first overlay node 506 may be unloaded in case they remain unused for a predefined time period, whereas one or more executable nodes that are used at least once during the predefined time period may remain loaded in the executable graph-based model 100. In some embodiments, the data and processing logic associated with a loaded executable node and/or overlay node may be transferred to a local memory of the overlay system 202 if the data and the processing logic remain unused for a first predefined period of time. Further, the data and the processing logic associated with the executable node/overlay node are transferred to an external storage from the local memory in case the executable node/overlay node remains unused for a second predefined period of time. The second predefined period of time is greater than the first predefined period of time. The term unloading refers to storing a state of a node with a current version of data and processing logic associated therewith at a storage location in the secondary storage of the storage element that is pointed by the corresponding manifest.

An executable graph-based model (for example, the executable graph-based model 100) may be stored (and loaded) using the above-described composition. Beneficially, each component is stored separately thereby allowing a user to maintain and store their data independently of the storage of the structure and functionality of the executable graph-based model 100.

Notably, the management and storage of manifests is managed by the controller module 206, the memory management module 218, the storage management module 220, a combination of these, or any other module of the overlay system 202. Also, all manifest states are stored together at a storage location (such as a manifest storage) that is known to the storage management module 220. Such centralized storage of the manifest states ensures that node states associated therewith are easily accessible.

It will be apparent to a person skilled in the art that although FIG. 6 illustrates only a single overlay node associated with a generic video node, in other embodiments, the executable generic video node 502 may include additional or different overlay nodes (for example, the second overlay node 508). It will also be apparent to a person skilled in the art that only those overlay nodes that are required for responding to the stimulus 230 may be loaded.

In some embodiments, the run-time video node 426 may be loaded by loading the node template 428 and the node instance 430. Each of the node template 428 and the node instance 430 may be loaded in a manner similar to the loading of the base node 402 as described in conjunction with FIG. 6. Additionally, the node instance 430 may include a reference to the node template 428. Therefore, the node template 428 may be identified based on the node instance 430 and may be loaded prior to the node instance 430. In some embodiments, the node template 428 and the node instance 430 may be associated with node templates and node instances, respectively, of one or more overlay nodes associated with the executable run-time video node 514. In such embodiments, each of the node template 428 and the node instance 430 may be loaded in a manner that is similar to the loading of the executable generic video node 502.

It will be apparent to a person skilled in the art that the generic node 302 may be loaded in a manner that is similar to the loading of the base node 402. Additionally, the generic node 302 when extended by way of an overlay node may be loaded in a manner similar to the loading of the executable generic video node 502.

In some embodiments, the run-time node 336 may be loaded by loading the node template 338 and the node instance 340. Each of the node template 338 and the node instance 340 of the run-time node 336 may be loaded in a manner similar to the loading of the base node 402. Additionally, in an instance when the run-time node 336 may be extended by way of a run-time overlay node, the node template 338 and the node instance 340 may be associated with overlay node template and overlay node instance, respectively, of the run-time overlay node. In such a scenario, each of the node template 338 and the node instance 340 may be loaded in a manner similar to the loading of the executable generic video node 502.

Having described various features associated with the video nodes and overlay nodes (for example, the standard operations overlay nodes and video action overlay nodes), the description now moves towards implementation of the video nodes in the overlay system 202 based on such features.

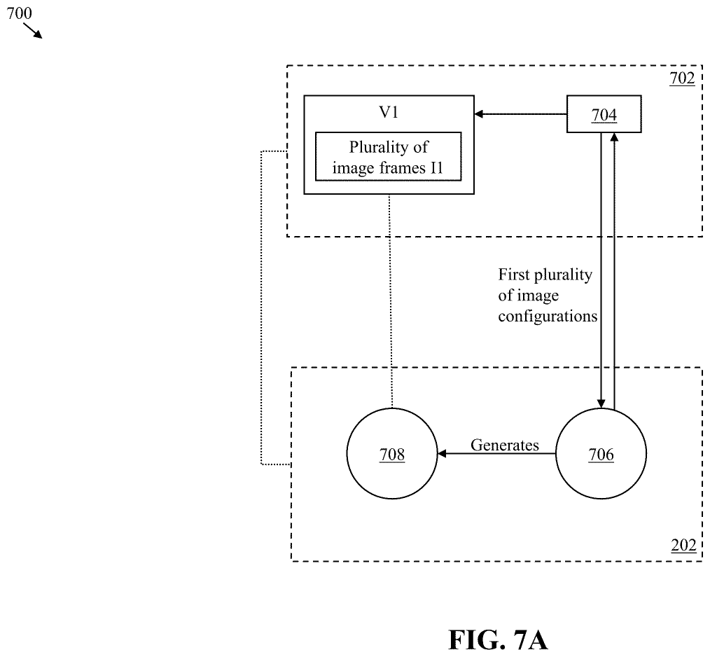

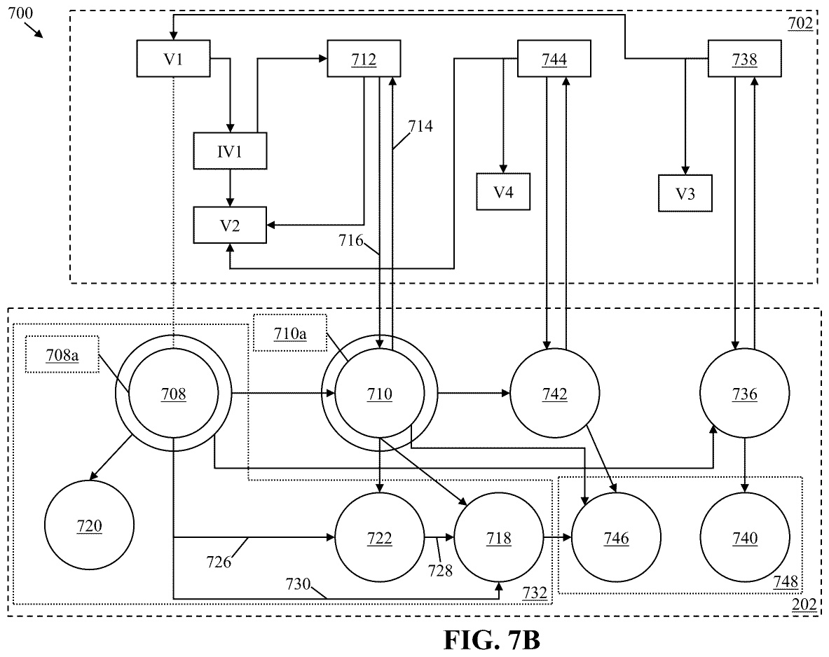

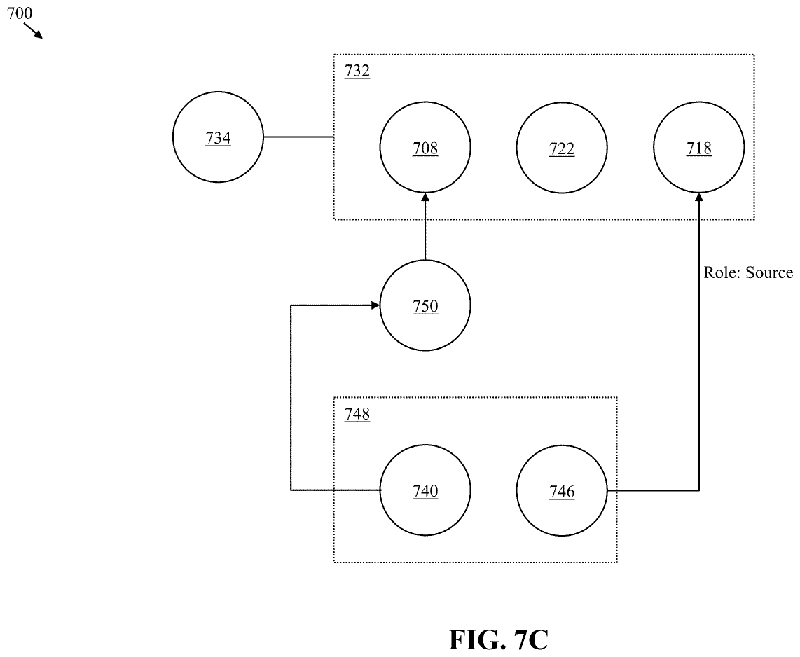

FIGS. 7A-7C, collectively, illustrate a graph 700 that depicts an implementation of generic video nodes in the executable graph-based model 100, consistent with disclosed embodiments of the present disclosure. Referring to FIG. 7A, shown is the overlay system 202 and an external system 702 associated therewith. The external system 702 may include one or more videos including a video V1. The video V1 may include a first plurality of image frames I1. Each frame of the plurality of image frames may be associated with a corresponding image configuration. An image configuration of an image frame may include parameters such as resolution, aspect ratio, file format, bit depth, compression type, color mode, metadata (for example, exchangeable image file format data), sharpness, noise level, contrast, brightness, dynamic range, saturation, exposure, dimensions, dots per inch (DPI)/pixels per inch (PPI), cropping/framing, rotation/orientation, scaling/resizing, pixel intensity, histogram distribution, white balance, gamma correction, edge detection, blur level, gradient information, texture features, object count, segmentation data, face detection, and saliency map, associated with the image frame.

The external system 702 may further include a plurality of video action modules including a video creation module 704. The video creation module 704 may include processing circuitry, instructions, or the like that in operation may execute a video creation operation for creating a new video within the external system 702. Notably, each video action module of the plurality of video action modules (shown in FIG. 7B) may be associated with a processor (for example, CPU, GPU, or the like) and may have processing logic that when implemented may execute a video operation on a video of the external system 702. The video operation may correspond to a video generation/creation operation, a video modification operation, a video analysis operation, a video deletion operation, or a rollback operation. For the sake of brevity, the plurality of video action modules are shown in FIG. 7B to be a part of the external system 702. In some embodiments, the plurality of video action modules may be parts of same or distinct external systems that may be different from the external system 702.

In some embodiments, the external system 702 may have a centralized architecture. Hence, the one or more videos (including the video V1) and the plurality of video action modules may be organized and stored in a centralized manner. Alternatively, in some embodiments, the external system 702 may have a distributed architecture. Hence, the one or more videos and the plurality of video action modules may be organized and stored in a distributed manner.

The overlay system 202 may include a plurality of video action overlay nodes including a video action overlay node 706. Other video action overlay nodes of the plurality of video action overlay nodes are shown in FIG. 7B. Each video action overlay node of the plurality of video action overlay nodes may be a video creation overlay node (alternatively, a video generation overlay node), a video modification overlay node (alternatively, a video manipulation overlay node), a video analyzer overlay node, a video deletion overlay node, a rollback overlay node, or any other overlay node with a video action overlay node-type (for example, the video action overlay node-type 510). The video action overlay node 706 may be the video creation overlay node. Each video action overlay node of the plurality of video action overlay nodes may include a module reference of a corresponding video action module of the plurality of video action modules of the external system 702. The module reference of each video action overlay node may be a pointer, a storage location, a URL, or the like to the corresponding video action module. The module reference may be used to access the corresponding video action module in the external system 702. Each video action overlay node of the plurality of video action overlay nodes may further include processing logic that when executed may use the corresponding module reference to communicate with the corresponding video action module. Based on such communication, the video action module may execute a video operation on a video of the plurality of videos. The video action overlay node 706 may include a first module reference of the video creation module 704. Therefore, the video action overlay node 706 may be communicatively coupled to the video creation module 704.

Based on a requirement to implement the external system 702 entirely or partially by way of the overlay system 202, the video V1 may have to be represented in the overlay system 202. Therefore, a first stimulus (for example, the stimulus 230) may be received by the processing circuity (for example, the interface module 204, the controller module 206, the transaction module 208, the stimuli management module 212, or the like). The first stimulus may be associated with a node creation operation to be executed in the executable graph-based model 100 to represent the video V1 in the overlay system 202. The first stimulus may be indicative of a first video reference to the video V1. The first video reference may be a pointer, a storage location, a uniform resource locator (URL), or the like.

The processing circuitry (for example, the controller module 206, the transaction module 208, the stimuli management module 212, or the like) may be configured to identify, based on the first stimulus, the video action overlay node 706. The processing circuitry (for example, the controller module 206, the transaction module 208, the stimuli management module 212, or the like) may identify the video action overlay node 706 based on a functionality thereof being in conformity with the node creation operation. In other words, such identification of the video action overlay node 706 may be performed based on processing logic associated therewith, when executed, being able to cause creation of a video node in the executable graph-based model 100 to represent a video in the external system 702. The video node may represent an existing video (for example, the video V1) of the external system 702 or a new video generated based on execution of the processing logic of the video action overlay node 706. For the sake of brevity, it is assumed that the video node may be created for an existing video of the external system 702.

Based on the identification of the video action overlay node 706, the processing circuitry (for example, the controller module 206, the transaction module 208, the stimuli management module 212, or the like) may be configured to use the first module reference, of the video creation module 704, included in the video action overlay node 706 to communicate a set of node creation instructions (for example, record and pull instructions) to the video creation module 704. Based on a reception of the set of node creation instructions, the video creation module 704 may extract a first plurality of image configurations of the first plurality of image frames I1 of the video V1. In some embodiments, the video creation module 704 may record the video V1 by way of a video recording device of the external system 702 before extracting the first plurality of image configurations of the first plurality of image frames I1 of the video V1.

Subsequently, the processing circuitry (for example, the controller module 206, the transaction module 208, or the like) may be configured to use the video action overlay node 706 to retrieve the first plurality of image configurations from the video creation module 704. Additionally, the processing circuitry (for example, the controller module 206, the transaction module 208, or the like) may be configured to retrieve the first video reference of the video V1. Alternatively, the processing circuitry (for example, the controller module 206, the transaction module 208, or the like) may determine the first video reference based on the first stimulus. A video reference may be a pointer, a storage location, a URL, or the like associated with a video of the external system 702. The video reference may be used to access the video in the external system 702. Similarly, the first video reference may be a pointer, a storage location, a URL, or the like associated with the video V1 and may be used to access the video V1 in the external system 702.

The processing circuitry (for example, the controller module 206, the transaction module 208, the stimuli management module 212, the video node management module 216, or the like) may be further configured to use the video action overlay node 706 to generate, in response to the first stimulus, a video node 708 in the executable graph-based model 100. The video node 708 may have an edge node-type (for example, the edge node-type 423). The video node 708 may include the first video reference of the video V1 and the first plurality of image configurations of the first plurality of image frames I1. The video node 708 may represent the video V1 in the executable graph-based model by representing the first plurality of image configurations of the first plurality of image frames I1 of the video V1. Similarly, multiple video nodes may be generated in the overlay system 202 to represent videos of one or more external systems (for example, the external system 702). Notably, based on the video action overlay node 706 being a generic node, the video node 708 may be a generic video node.

In some embodiments, the video node 708 may be the stateful node. Based on the video node 708 being the stateful node, upon unloading the video node 708, the first plurality of image configurations remain stored in the storage element in association with a node state of the video node 708. The node state of the video node 708 may be used to re-create/load (as described in conjunction with FIG. 6) the video node 708 based on a requirement thereof.

In some embodiments, the video node 708 may be the stateless node. Based on the video node 708 being the stateless node, upon unloading the video node 708, the video node 708 may cease to exist in the overlay system 202. That is to say that upon unloading the video node 708, the first plurality of image configurations and the first reference cease to exist in the overlay system 202.

Referring now to FIG. 7B, the processing circuitry (for example, the controller module 206, the transaction module 208, the stimuli management module 212, or the like) may be configured to receive a second stimulus (for example, the stimulus 230). The second stimulus may be indicative of a first video action to be executed based on the video V1 of the external system 702. The first video action may include a set of video operations (for example, video creation operations, video manipulation operations, video analysis operations, video deletion operations, rollback operations, or the like). Based on a context of the second stimulus, the processing circuitry (for example, the controller module 206, the transaction module 208, the stimuli management module 212, or the like) may be configured to identify the video node V1 in the executable graph-based model 100. Based on the identification of the video node V1, the processing circuitry (for example, the controller module 206, the transaction module 208, the stimuli management module 212, or the like) may be configured to determine whether the video node 708 is unloaded from the executable graph-based model 100. Based on a determination that the video node 708 is unloaded from the executable graph-based model 100, the processing circuitry (for example, the controller module 206, the transaction module 208, the memory management module 218, the storage management module 220, or the like) may be configured to load the video node 708 in the executable graph-based model 100 as described in conjunction with FIG. 6.

Subsequently, the processing circuitry (for example, the controller module 206, the transaction module 208, the stimuli management module 212, or the like) may be configured to identify at least a video action overlay node 710 from the plurality of video action overlay nodes of the executable graph-based model 100. The video action overlay node 710 may be the video creation overlay node, the video modification overlay node, the video deletion overlay node, the rollback overlay node, or a video analyzer overlay node. The processing circuitry (for example, the controller module 206, the transaction module 208, the stimuli management module 212, or the like) may identify the video action overlay node 710 based on a functionality thereof being in conformity with the first video action indicated by the second stimulus. That is to say that, the video action overlay node 710 may include processing logic that when executed may cause one or more video operations, of the set of video operations associated with the first video action, to be performed on a video represented by an associated video node. The video action overlay node 710 may include a second module reference of a video action module 712 of the plurality of video action modules of the external system 702 that may execute the one or more video operations on the video represented by the video node associated with the video action overlay node 710.

The processing circuitry (for example, the controller module 206, the transaction module 208, the stimuli management module 212, or the like) may be configured to associate the identified video action overlay node 710 with the video node 708. Based on the identification of the video node 708 and the association of the video action overlay node 710 with the video node 708, the processing circuitry (for example, the memory management module 218, the storage management module 220, or the like) may be configured to execute the first video action in response to the second stimulus. The first video action may be executed based on the video node 708 and at least the video action overlay node 710. The first video action may be executed further based on the video V1 and the video action module 712 of the external system 702.

For executing the first video action, the processing circuitry (for example, the controller module 206, the transaction module 208, the video node management module 216, or the like) may use the video action overlay node 710 to retrieve the first video reference of the video V1 from the video node 708. The processing logic of the video action overlay node 710 when executed by the processing circuitry (for example, the controller module 206, the transaction module 208, the video node management module 216, or the like) may retrieve the first video reference of the video V1 from the video node 708. Subsequently, the processing circuitry (for example, the controller module 206, the transaction module 208, the video node management module 216, or the like) may be configured to communicate (as shown by an arrow 714), using the video action overlay node 710 having the second module reference of the video action module 712, the first video reference of the video V1 to the video action module 712. In addition, the processing circuitry (for example, the controller module 206, the transaction module 208, the video node management module 216, or the like) may be configured to communicate (as shown by the arrow 714), using the second module reference of the video action module 712, one or more instructions to the video action module 712. Based on the one or more instructions and the first video reference, the video action module 712 may execute the set of video operations, associated with the first video action, on the video V1. The video operations may include video generation (for example, re-generation) operations, video modification operations, video deletion operations, video analysis operations, rollback operations, or a combination thereof.

Based on the execution of the set of video operations on the video V1, the video action module 712 may generate a video V2. Upon generation of the video V2, the video action module 712 may communicate (as shown by an arrow 716) a second plurality of image configurations of a second plurality of image frames of the video V2 to the video action overlay node 710. In addition, the video action module 712 may also communicate (as shown by the arrow 716) a second video reference of the video V2 to the video action overlay node 710.

The processing circuitry (for example, the controller module 206, the transaction module 208, the video node management module 216, or the like) may be configured to receive the second plurality of image configurations of the second plurality of image frames of the video V2 from the video action module 712. The processing circuitry (for example, the controller module 206, the transaction module 208, the video node management module 216, or the like) may use the video action overlay node 710 to receive the second plurality of image configurations of the video V2 from the video action module 712.

Subsequently, the processing circuitry (for example, the controller module 206, the transaction module 208, the video node management module 216, or the like) may be configured to generate (namely, instantiate or create) a video node 718 that represents the video V2. The video node 718 may be generated based on the second plurality image configurations of the second plurality of image frames received from the video action module 712. The video node 718 may also include the second video reference of the video V2. The processing circuitry (for example, the controller module 206, the transaction module 208, the video node management module 216, or the like) may use the video action overlay node 710 to generate the video node 718.

In some embodiments, based on the generation of the video node 718, the video nodes 708 and 718, and the video action overlay node 710 may be unloaded from the executable graph-based model 100. In some embodiments, the video nodes 708 and 718 and the video action overlay node 710 may not be unloaded or may be loaded again based on a requirement thereof for execution of one or more operations associated with the overlay system 202 or the external system 702.

In some embodiments, based on the second stimulus, the processing circuitry (for example, the controller module 206, the transaction module 208, the video node management module 216, or the like) may be further configured to associate an additional overlay node 720 with the video node 708. The overlay node 720 may be a standard operations overlay node or a video action overlay node. For the sake of brevity of the description, the overlay node 720 is assumed to be the standard operations overlay node.

In an instance, the video node 708 may have to be encrypted using an encryption technique. In such an instance, the overlay node 720 may be the standard operations overlay node (for example, an encryption overlay node). The overlay node 720 may include processing logic that when executed may encrypt the video node 708. Therefore, the first plurality of image configurations of the video V1 and the first video reference of the video V1 may also be encrypted. In such embodiments, the first video action may be performed further based on the overlay node 720 being the standard operations overlay node. For execution of the first video action, a decryption logic of the overlay node 720 may be used to decrypt the video node 708. Based on the decryption of the video node 708, the first plurality of image configurations of the video V1 and the first video reference of the video V1 may be also decrypted. Subsequently, the first video action may be executed as described above.

In some embodiments, the video node 708 may include an overlay manager 708a configured to manage association of the video node 708 with the video action overlay node 710 and the overlay node 720. The overlay manager 708a may have a description similar to the description of the overlay manager 504.

In some embodiments, the set of video operations associated with the first video action may be a set of video mutation operations. A video mutation operation may refer to a process of modifying one or more parameters of one or more image frames of a plurality of image frames of a video. Examples of parameters of an image frame may include, but are not limited to, resolution, aspect ratio, file format, bit depth, compression type, color mode, metadata (for example, exchangeable image file format data), sharpness, noise level, contrast, brightness, dynamic range, saturation, exposure, dimensions, dots per inch (DPI)/pixels per inch (PPI), cropping/framing, rotation/orientation, scaling/resizing, pixel intensity, histogram distribution, white balance, gamma correction, edge detection, blur level, gradient information, texture features, object count, segmentation data, face detection, saliency map, temporal correlation with other image frames of the plurality of image frames. Similarly, a video mutation operation of the first video action may include modification of one or more parameters of one or more image frames of the first plurality of image frames I1.

In some embodiments, when the set of video operations is assumed to be the set of video mutation operations, based on the execution of the first video action, the processing circuitry (for example, the controller module 206, the transaction module 208, the video node management module 216, or the like) may be configured to associate the first plurality of image configurations of the first plurality of image frames I1 of the video V1 with the video action overlay node 710. In such embodiments, the processing circuitry (for example, the controller module 206, the transaction module 208, the video node management module 216, the memory management module 218, the storage management module 220, or the like) may be configured to discard the video node 708. Such discarding of the video node 708 may cause deletion of the video node 708 from the executable graph-based model 100. The first plurality of image configurations may be stored in association with the video action overlay node 710. In an instance, the video action overlay node 710 may be the stateless node. In such an instance, the first plurality of image configurations may cease to exist in the overlay system 202 based on unloading of the video action overlay node 710. In another instance, the video action overlay node 710 may be the stateful node. In such an instance, the first plurality of image configurations may persist in the storage element based on unloading of the video action overlay node 710. Such persistence of the first plurality of image configurations may be in association with a node state of the video action overlay node 710.

In some embodiments, when a video trail of (i) a lifecycle of the video V1 or (ii) various operations performed on the video V1 may have to be maintained within the overlay system 202, the video node 708 may not be discarded. For the sake of ongoing description, it is assumed that the video node 708 may not be discarded.

The video trail of the video V1 may refer to a temporal record of various video nodes that may be generated directly or indirectly based on the video V1 or any other video associated with the video V1. Such a video trail may be stored in form a snapshot that may be an unmodifiable state of the video nodes associated with the video trail. Beneficially, this ensures that an initial state and various modifications made to the video V1 are available within the overlay system 202 at all times.

In some embodiments, when the set of video operations is assumed to be the set of video mutation operations, the video V2 may be a final output of the set of video mutation operations. Prior to the generation of the video V2, the video action module 712 may generate at least an intermediate video IV1 based on the execution of one or more video mutation operations of the set of video mutation operations. The intermediate video IV1 may be generated based on the execution of the one or more video mutation operations of the set of video mutation operations on the video V1. The intermediate video IV1 may be generated prior to the generation of the video V2. In such embodiments, the video V2 may be generated based on execution of remaining mutation operations, of the set of mutation operations, on the intermediate video IV1. In addition, prior to communication of the second plurality of image configurations of the video V2, the video action module 712 may communicate a third plurality of image configurations of a third plurality of image frames of the intermediate video IV1 to the video action overlay node 710. Therefore, the processing circuitry (for example, the controller module 206, the transaction module 208, the video node management module 216, or the like) may be configured to receive, using the video action overlay node 710, the third plurality of image configurations of the intermediate video IV1. In addition, the video action module 712 may also communicate a third video reference of the intermediate video IV1. Therefore, the processing circuitry (for example, the controller module 206, the transaction module 208, the video node management module 216, or the like) may be further configured to receive, using the video action overlay node 710, the third video reference of the intermediate video IV1.

In some embodiments, the third plurality of image configurations may be represented by the video action overlay node 710. In an instance, the video action overlay node 710 may be the stateless node. In such an instance, the third plurality of image configurations may cease to exist in the overlay system 202 based on unloading of the video action overlay node 710. In another instance, the video action overlay node 710 may be the stateful node. In such an instance, the third plurality of image configurations may persist in the storage element based on unloading of the video action overlay node 710. Such persistence of the third plurality of image configurations may be in association with the node state of the video action overlay node 710.

In some embodiments, the processing circuitry (for example, the controller module 206, the transaction module 208, the video node management module 216, or the like) may be configured to instantiate (namely, create and generate) an intermediate video node 722. The intermediate video node 722 may represent the third plurality of image configurations of the intermediate video IV1. The intermediate video node 722 may include the third image reference of the intermediate video IV1. The processing circuitry (for example, the controller module 206, the transaction module 208, the video node management module 216, or the like) may be further configured to correlate (as shown by an arrow 726) the video node 708 with the intermediate video node 722. Such correlation of the video node 708 and the intermediate video node 722 may be indicative of a relation therebetween. In other words, the correlation of the video node 708 with the intermediate video node 722 may be indicative of a transition of the video V1 to form the intermediate video IV1. Similarly, the processing circuitry (for example, the controller module 206, the transaction module 208, the video node management module 216, or the like) may be further configured to correlate (as shown by an arrow 728) the intermediate video node 722 with the video node 718. Such correlation of the intermediate video node 722 and the video node 718 may be indicative of a relation therebetween. In other words, the correlation of the intermediate video node 722 with the video node 718 may be indicative of a transition of the intermediate video IV1 to form the video V2.

In some embodiments, when the third plurality image configurations may be represented by the video action overlay node 710, the intermediate video node 722 may not be generated. In such embodiments, the processing circuitry (for example, the controller module 206, the transaction module 208, the video node management module 216, or the like) may be further configured to correlate (as shown by an arrow 730) the video node 708 with the video node 718. Such correlation of the video node 708 and the video node 718 may be indicative of a relation therebetween. In other words, the correlation of the video node 708 with the video node 718 may be indicative of a transition of the video V1 to form the video V2.

In some embodiments, the processing circuitry (for example, the controller module 206, the transaction module 208, the video node management module 216, or the like) may be further configured to generate a group node 732 based on the video nodes 708 and 718, and the intermediate video node 722. The group node 732 may include the video nodes 708 and 718, and the intermediate video node 722. The group node 732 may be generated to maintain the video trail of the video V1. The group node 732 may refer to a composite structure (for example, a sub-graph, a container, or the like) within the executable graph-based model 100 that may include a plurality of video nodes that may have a correlation therebetween.

In some embodiments, the processing circuitry (for example, the controller module 206, the transaction module 208, the video node management module 216, or the like) may be further configured to generate the video trail associated with the video V1 based on the group node 732. The video trail associated with the video V1 may include the video nodes 708 and 718, and the intermediate video node 722 in a time-synchronized order of generation thereof. In other embodiments, the video trail may be time-synchronized in accordance with any other constraint for example, time of modification, time of last use, or the like. Video trails for other videos being represented by other video nodes in the group node 732 may also be generated in a similar manner. In some embodiments, the video trail may be generated from a reference time instance. In such embodiments, the video trail may be generated in a forward time progression or a reverse time progression.

In some embodiments, the group node 732 may be a persistable node. Based on the group node 732 being the persistable node, the correlation among the video nodes 708 and 718, and the intermediate video node 722 may exist in the storage element of the overlay system 202. In other words, based on the group node 732 being the persistable node, the video trail of the video V1 may persist in the storage element of the overlay system 202 at all times.

In some embodiments, the group node 732 may be a non-persistable node. Based on the group node 732 being the non-persistable node, the correlation among the video nodes 708 and 718, and the intermediate video node 722 may cease to exist in the overlay system 202 after a threshold time-interval. In other words, based on the group node 732 being the non-persistable node, the video trail of the video V1 may cease to persist in the storage element of the overlay system 202 after an expiration of the threshold time-interval. The threshold time-interval may correspond to a time period for which the video trail associated with the video V1 may be required for one or more operations associated with the overlay system 202.

Referring to FIG. 7C, in some embodiments, the processing circuitry (for example, the controller module 206, the transaction module 208, the video node management module 216, or the like) may be further configured to associate the group node 732 with an overlay node 734. The overlay node 734 may be a standard operations overlay node or a video action overlay node. The first video action may be further executed based on the overlay node 734. In an instance, the overlay node 734 may be the standard operations overlay node such as an obfuscation overlay node. In such an instance, the overlay node 734 may obfuscate the first plurality of image configurations, the second plurality of image configurations, and the third plurality of image configurations included in the video nodes 708 and 718, and the intermediate video node 722, respectively, encompassed within the group node 732. In an instance, the overlay node 734 may be the video action overlay node such as a video blur overlay node. In such an instance, the overlay node 734 may communicate with a corresponding video action module (not shown) of the external system 702 and cause the corresponding video action module to blur the videos V1 and V2 and the intermediate video IV1 represented by the video nodes 708, 718, and 722, respectively, encompassed within the group node 732.

Referring back to FIG. 7B, in some embodiments, based on a context of the second stimulus, the processing circuitry (for example, the controller module 206, the transaction module 208, the stimuli management module 212, or the like) may be further configured to identify a video action overlay node 736 of the plurality of video action overlay nodes of the executable graph-based model 100. The video action overlay node 736 may be identified based on a functionality thereof being in conformity with the first video action. That is to say that, the video action overlay node 736 may include processing logic that when executed may execute one or more video operations of the set of video operations associated with the first video action.

The processing circuitry (for example, the controller module 206, the transaction module 208, the stimuli management module 212, or the like) may be further configured to determine whether the video action overlay node 736 is unloaded from the executable graph-based model 100. Based on the determination of the video action overlay node 736 being unloaded from the executable graph-based model 100, the processing circuitry (for example, the controller module 206, the transaction module 208, the stimuli management module 212, the memory management module 218, the storage management module 220, or the like) may be configured to load the video action overlay node 736 in the executable graph-based model 100 as described in conjunction with FIG. 6.

Subsequently, the processing circuitry (for example, the controller module 206, the transaction module 208, the video node management module 216, or the like) may associate the video action overlay node 736 with the video node 708. The video action overlay node 736 may include a third module reference of a video action module 738 of the external system 702. The video action module 738 may be configured to execute a video operation that may be different from the video operations performed by the video action module 712. The first video action may be executed further based on the video action overlay node 736 in a manner similar to the execution of the first video action based on the video action overlay node 710. Based on the execution of the first video action using the video action overlay node 736, the video action module 738 may generate a video V3 as an output of execution of a corresponding video operation on the video V1. The processing circuitry (for example, the controller module 206, the transaction module 208, the video node management module 216, or the like) may be further configured to receive, using the video action overlay node 736, a fourth plurality of image configurations of a fourth plurality of image frames of the video V3 from the video action module 738. The processing circuitry (for example, the controller module 206, the transaction module 208, the video node management module 216, or the like) may be further configured to receive, using the video action overlay node 736, a fourth video reference of the video V3. The processing circuitry (for example, the controller module 206, the transaction module 208, the video node management module 216, or the like) may be further configured to generate, using the video action overlay node 736, a video node 740 including the fourth plurality of image configurations of the fourth plurality of image frames and the fourth video reference of the video V3.

In some embodiments, based on the second stimulus, the processing circuitry (for example, the controller module 206, the transaction module 208, the video node management module 216, or the like) may be further configured to associate an additional overlay node 742 with the video action overlay node 710. The overlay node 742 may be a standard operations overlay node or a video action overlay node. For the sake of description, the overlay node 742 is assumed to be the video action overlay node. The overlay node 742 may be associated with the video action overlay node 710 in a manner similar to association of the video action overlay node 736 with the video node 708. The video action overlay node 742 may include a fourth module reference of a video action module 744 of the external system 702. The video action module 744 may be configured to execute a video operation that may be different from the video operations performed by the video action modules 712 and 738. The first video action may be executed further based on the video action overlay node 742 in a manner similar to the execution of the first video action based on the video action overlay node 710.

In some embodiments, the video action overlay node 710 may include an overlay manager 710a configured to manage the association of the video action overlay node 710 with the video action overlay node 742. The overlay manager 710a may have a description similar to the description of the overlay manager 504.

Based on the execution of the first video action using the video action overlay node 742, the video action module 744 may generate a video V4 based on execution of a corresponding video operation on the video V2. The processing circuitry (for example, the controller module 206, the transaction module 208, the video node management module 216, or the like) may be further configured to receive, using the video action overlay node 742, a fifth plurality of image configurations of a fifth plurality of image frames of the video V4 and a fifth video reference of the video V4, from the video action module 744. The processing circuitry (for example, the controller module 206, the transaction module 208, the video node management module 216, or the like) may be further configured to generate, using the video action overlay node 742 and/or the video action overlay node 710, a video node 746 including the fifth plurality of image configurations and the fifth video reference.

In some embodiments, the videos V3 and V4 may be associated with a common attribute (for example, time of generation, purpose of generation, owner, user, or the like). Therefore, the processing circuitry (for example, the controller module 206, the transaction module 208, the video node management module 216, or the like) may be further configured to correlate, using at least one of the video action overlay nodes 710, 736, or 742, the video nodes 740 and 746 representing the video V3 and V4, respectively. The processing circuitry (for example, the controller module 206, the transaction module 208, the video node management module 216, or the like) may be further configured to generate, using at least one of the video action overlay nodes 710, 736, or 742, a group node 748 including the video nodes 740 and 746.

Referring again to FIG. 7C, the processing circuitry (for example, the controller module 206, the transaction module 208, the video node management module 216, or the like) may be further configured to associate the group nodes 732 and 748. The association between the group nodes 732 and 748 may be based on the video V1 being an initial (namely, start, source) point for generation of each video node included in the group nodes 732 and 748. In other embodiments, such association between two or more group nodes may be based on other factors such as, date of generation, owner, purpose of generation, associations among video trails of one or more video nodes in the group nodes, or the like.

As shown, the group nodes 732 and 748 are associated based on the video node 718 being correlated with the video node 746 by way of a role source. In other words, the video node 718 may be a source node for the video node 746. The video node 718 is a source node to the video node 746 based on the video V2 being a source for the video V4. Notably, the video V2 is the source for the video V4 as the video V4 is generated based on the video V2.

The group nodes 732 and 748 are further associated by way of a contract overlay node 750 of the executable graph-based model 100. The group node 732 is associated with the contract overlay node 750 by way of the video node 708 being associated with the contract overlay node 750. The contract overlay node 750 may be further associated with the group node 748. The group node 748 may be associated with the contract overlay node 750 based on the video node 740 being associated with the contract overlay node 750. The contract overlay node 750 may be a standard operations overlay node and may be associated with a set of constraints that implement access control for accessing the video node 708 or the group node 732 by way of the video node 740. The access control associated with the video node 708 or the group node 732 may be a private access, a public access, or a protected access. The public access of a node (for example, the video node 708 and the group node 732) may correspond to the node being accessible from any other node in the executable graph-based model 100 without any restrictions. The private access of a node corresponds to the node being accessible only to itself or directly connected nodes within a restricted portion of the executable graph-based model 100. The protected access of a node corresponds to the node being accessible to its directly connected nodes and certain privileged nodes, such as those within a specific portion or hierarchy of the executable graph-based model 100.

It will be apparent to a person skilled in the art that an operation being executed by a node (for example, a video node, a video action overlay node, a standard operations overlay node, or the like) is actually executed by the processing circuitry using the node.

It should be appreciated that the references to ‘first video node,’ ‘second video node,’ and ‘intermediate video node’ or other similar terms in the claims are not intended to refer to specific nodes but are used for distinguishing elements. These nodes may correspond to any of the video nodes described in the specification, including, but not limited to, the video nodes 708 and 718, or any other applicable video node discussed herein.

It should be appreciated that the references to ‘first video,’ ‘second video,’ and ‘intermediate video’ or other similar terms in the claims are not intended to refer to specific videos but are used for distinguishing elements. These videos may correspond to any of the videos described in the specification, including, but not limited to, the videos V1 and V2, or any other applicable video discussed herein.

Although FIGS. 7A, 7B, and 7C depict the plurality of videos and the plurality of video action modules to be associated with a single external system, in practical implementations the plurality of videos and the plurality of video action modules may be of distinct external systems associated with the overlay system 202.

Having discussed the implementation of video nodes (for example, the video node 708) that may be generic video nodes and video action overlay nodes (for example, the video action overlay node 710) that may be a generic overlay node, the description now moves towards implementation of run-time video nodes and video action overlay nodes that may be run-time overlay nodes. Notably, various concepts and embodiments discussed in conjunction with the FIGS. 7A, 7B, and 7C for the implementation of the generic video node may also be applicable for implementation of the video nodes (for example, the run-time video node 426.

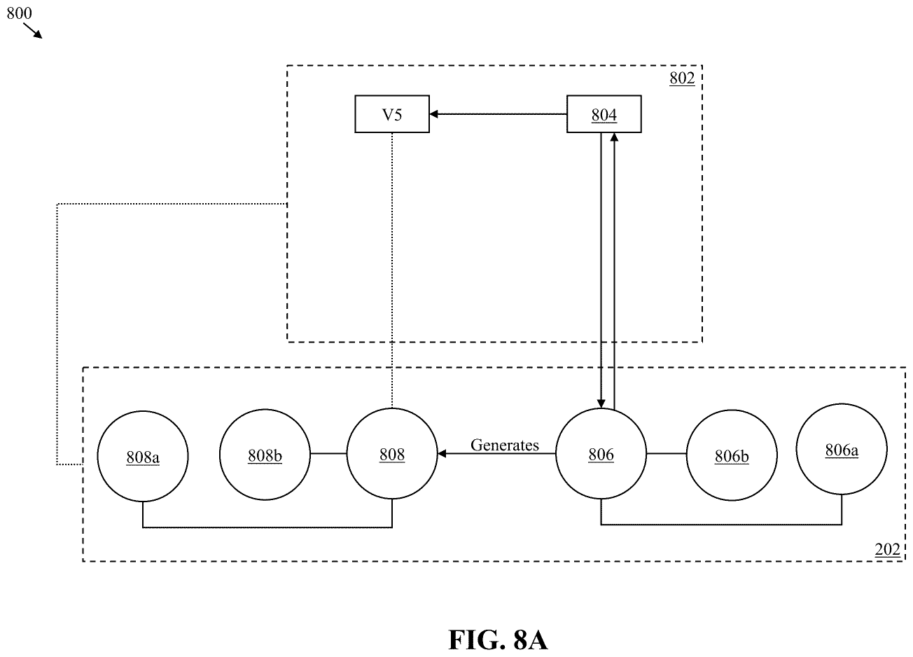

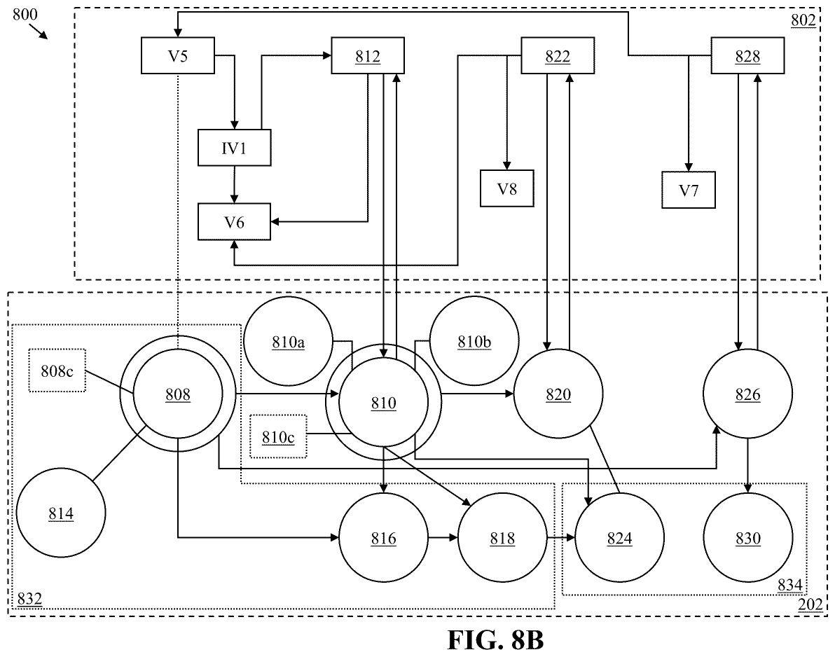

FIGS. 8A and 8B, collectively, illustrate a graph 800 that depicts an implementation of a plurality of run-time video nodes in the executable graph-based model 100, consistent with disclosed embodiments of the present disclosure. Referring to FIG. 8A, shown is an external system 802 associated with the overlay system 202. The external system 802 may include at least a video V5 and a plurality of video action modules including a video creation module 804. The overlay system 202 may include a plurality of run-time video action overlay nodes including a run-time video action overlay node 806. The run-time video action overlay node 806 being a run-time overlay node may include an overlay node template 806a and an overlay node instance 806b. The run-time video action overlay node 806 may include a fifth module reference of the video creation module 804. The processing circuitry (for example, the controller module 206, the transaction module 208, the stimuli management module 212, or the like) may receive a third stimulus indicative of a second video action. Based on the third stimulus, the processing circuitry (for example, the controller module 206, the transaction module 208, the video node management module 216, or the like) may be configured to use the run-time video action overlay node 806 to create a run-time video node 808 in a manner similar to the creation of the video node 708 using the video action overlay node 706. The run-time video node 808 being a run-time node may include a node template 808a and a node instance 808b. Notably, based on the run-time video action overlay node 806 being a run-time node, the run-time video node 808 may be a run-time video node.

Referring now to FIG. 8B, the external system 802 includes videos V5, V6, V7, and V8 that may have descriptions, features, functionalities, and embodiments similar to the videos V1, V2, V3, and V4 described in conjunction with FIGS. 7A-7C. The external system 702 is shown to further include an intermediate video IV2 that may have description, features, functionalities, and embodiments similar to the intermediate video IV1.

The overlay system 202 is further shown to include a run-time video action overlay node 810 that may be associated with the run-time video node 808 in a manner similar to the association of the video action overlay node 710 with the video node 708. The run-time video action overlay node 810 being a run-time overlay node may include an overlay node template 810a and an overlay node instance 810b. The run-time video node 808 may include an overlay manager 808c configured to manage association of the run-time video node 808 with the run-time video action overlay node 810. The overlay manager 808c may have a description similar to the description of the overlay manager 516. The run-time video action overlay node 810 may include a sixth module reference for a video action module 812 of the external system 802. The run-time video action overlay node 810 may have a description similar to the description of the video action overlay node 710 and the video action module 812 may have a description similar to the description of the video action module 712.

As shown, the run-time video node 808 is further shown to be associated with a run-time overlay node 814. The run-time overlay node 814 may have a description similar to the overlay node 720. Further, the run-time video node 808 may be correlated with a run-time intermediate video node 816 and a run-time video node 818. The run-time intermediate video node 816 may have a description similar to the intermediate video node 722. The run-time video node 818 may have a description similar to the video node 718.

The run-time video action overlay node 810 is further shown to be associated with a run-time overlay node 820. The run-time overlay node 820 may have a description similar to the description of the overlay node 742. For the sake of description of FIG. 8B, the run-time overlay node 820 is assumed to be a run-time video action overlay node. Hereinafter, the run-time overlay node 820 is referred to as the run-time video action overlay node 820. The run-time video action overlay node 820 may include a seventh module reference of a video action module 822 of the external system 802. The video action module 822 may have a description similar to the video action module 744. The processing circuitry (for example, the controller module 206, the transaction module, the video node management module 216, or the like) may be configured to use the run-time video action overlay node 820 to generate a run-time video node 824. The run-time video node 824 may have a description similar to the video node 746. In addition, based on the run-time video action overlay node 810 and the run-time video action overlay node 820 being associated with the run-time video node 808 in a cascading manner, a sequence of execution and an output approach of processing logic thereof may be defined by the overlay node template 810a of the run-time video action overlay node 810. In some embodiments, based on the sequence of execution defined by the overlay node template 810a, the processing logic of the run-time video action overlay node 820 may be executed prior to the execution of the processing logic of the run-time video action overlay node 810. In some embodiments, based on the sequence of execution defined by the overlay node template 810a, the processing logic of the run-time video action overlay node 810 may be executed prior to the execution of the processing logic of the run-time video action overlay node 820.

In some embodiments, the run-time video action overlay node 810 may include an overlay manager 810c configured to manage association of the run-time video action overlay node 810 with the run-time video action overlay node 820. The overlay manager 810c may have a description similar to the description of the overlay manager 516.

The run-time video node 808 is further shown to be associated with a run-time video action overlay node 826. The run-time video action overlay node 826 may have a description similar to the description of the video action overlay node 736. The run-time video action overlay node 826 may include an eighth module reference of a video action module 828 of the external system 802. The video action module 828 may have a description similar to the video action module 738. The processing circuitry (for example, the controller module 206, the transaction module, the video node management module 216, or the like) may be configured to use the run-time video action overlay node 826 to generate a run-time video node 830. The run-time video node 830 may have a description similar to the video node 740.

The graph 800 is further shown to include group nodes 832 and 834 having descriptions and functionalities similar to the group nodes 732 and 748, respectively. The group node 832 may include the run-time video nodes 808 and 818 and the run-time intermediate video node 816. The group node 834 may include the run-time video nodes 824 and 830. Additionally, the group nodes 832 and 834 may have associated overlay nodes (for example, generic operation overlay nodes and/or video action overlay nodes) as described for the group nodes 732 and 748, respectively, in conjunction with FIGS. 7A-7C. In addition, the group nodes 832 and 834 may be associated with each other as described for the group nodes 732 and 748, respectively, in conjunction with FIGS. 7A-7C. Also, the group nodes 832 and 834 may be run-time nodes and may include corresponding node templates and corresponding node instances.

It will be apparent to a person skilled in the art that based on the video nodes and the video action overlay nodes depicted in FIGS. 8A-8B being run-time nodes, each video node and video action overlay node may include a node template and a node instance.

For each component in the graph 800, various associations with other components mirrors that of a corresponding component in the graph 700, such that the relational structure of the graph 800 is isomorphic to that of the graph 700 with respect to connectivity among components.

Notably, FIGS. 8A-8B, collectively, are same as a collective representation of FIG. 7A-7C. In addition, nodes (video nodes and overlay nodes) depicted in FIGS. 8A and 8B are run-time nodes. Therefore, in addition to the above-mentioned description of FIG. 8, various concepts and embodiments associated with the implementation of the generic video nodes in the executable graph-based model 100 as discussed in conjunction with FIGS. 7A-7C may also be applicable to the implementation of the run-time video nodes in the executable graph-based model 100.

Additionally, loading of a run-time node (for example, a run-time video node, a run-video action overlay node, a run-time standard operations overlay node, or the like) is performed based on loading of its node template and node instance. Each of the node instance and the node template may be loaded as described in conjunction with FIG. 6.

Although FIGS. 8A-8B depict the plurality of videos and the plurality of video action modules to be associated with a single external system, in practical implementations the plurality of videos and the plurality of video action modules may be associated with distinct external systems associated with the overlay system 202.

Having discussed various concepts associated with the video nodes in the executable graph-based model 100, the description now moves towards exemplary implementations of the video nodes in the executable graph-based model 100 for performing various video operations for manipulation, modification, and analysis of videos represented by the video nodes.

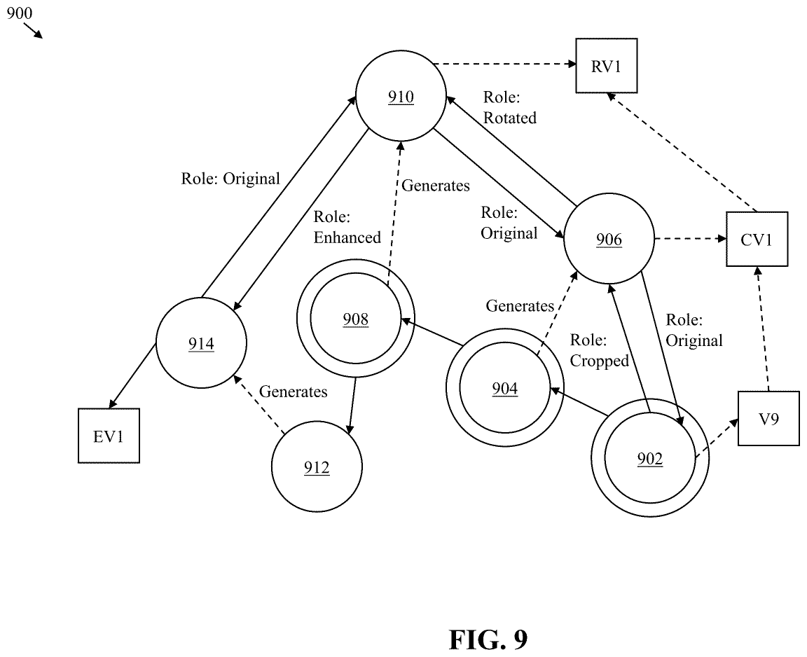

FIG. 9 illustrates a graph 900 that depicts an exemplary implementation of the executable graph-based model 100, consistent with disclosed embodiments of the present disclosure. Referring to FIG. 9, illustrated is the exemplary implementation of the video nodes for modification of videos of an external system (for example, the external systems 702 and 802). For the sake of description of FIG. 9, it is assumed that video nodes depicted in FIG. 9 are generic video nodes and video action overlay nodes depicted in FIG. 9 are generic overlay nodes. Notably, modification of a video may be performed based on modification of parameters associated with one or more image frames of a plurality of image frames of the video.

As shown, the executable graph based-model 100 may include a video node 902 representing a video V9 of an external system (for example, the external system 702). Therefore, the video node 902 may include a sixth video reference (for example, a pointer, a storage location, a URL, or the like) associated with the video V9. The processing circuitry (for example, the controller module 206, the transaction module 208, the stimuli management module 212, or the like) may receive a fourth stimulus (for example, the stimulus 230) indicative of a third video action to be executed on the video V9. Based on the third stimulus, the processing circuitry (for example, the controller module 206, the transaction module 208, the stimuli management module 212, or the like) may identify the video node 902 representing the video V9. Further, based on the video node 902, the processing circuitry (for example, the controller module 206, the transaction module 208, the stimuli management module 212, or the like) may determine a video cropping overlay node 904 from one or more video action overlay nodes associated with the video node 902. The video cropping overlay node 904 may be determined based on a functionality thereof being able to execute a first video operation of the third video action indicated by the third stimulus. The first video operation may correspond to a video cropping operation.

The video cropping overlay node 904 may include a ninth module reference of a crop video action module (not shown) of the external system. The processing circuitry (for example, the controller module 206, the transaction module 208, the video node management module 216, the overlay management module 236, or the like) may use video cropping overlay node 904 to communicate the sixth video reference associated with the video V9 to the crop video action module. Subsequently, the crop video action module may execute the video cropping operation on the video V9. Based on the video cropping operation executed on the video V9, a cropped video CV1 may be generated in the external system. The processing circuitry (for example, the controller module 206, the transaction module 208, the video node management module 216, the overlay management module 236, or the like) may use the video cropping overlay node 904 to receive a sixth plurality of image configurations of a sixth plurality of image frames of the cropped video CV1 from the crop video action module. The cropped video CV1 may not be a final output of the third video action being executed on the video V9. Hence, the cropped video CV1 may be a first intermediate video. The processing circuitry (for example, the controller module 206, the transaction module 208, the video node management module 216, or the like) may use the video cropping overlay node 904 to produce (namely, generate, create, instantiate) an intermediate video node 906. The intermediate video node 906 may include a seventh video reference of the cropped video CV1. Subsequently, the processing circuitry (for example, the controller module 206, the transaction module 208, the video node management module 216, or the like) may use the video cropping overlay node 904 to correlate the video node 902 and the intermediate video node 906 such that the video node 902 may be associated with a role ‘Original’ and the intermediate video node 906 may be associated with a role ‘Cropped’.

Subsequently, based on the video cropping overlay node 904, the processing circuitry (for example, the controller module 206, the transaction module 208, the stimuli management module 212, or the like) may determine a video rotation overlay node 908 from one or more video action overlay nodes associated with the video cropping overlay node 904. The video rotation overlay node 908 may be determined based on a functionality thereof being able to execute a second video operation of the third video action indicated by the third stimulus. The second video operation may correspond to a video rotation operation of the first intermediate video e.g., the cropped video CV1, generated based on the first video operation.

The video rotation overlay node 908 may include a tenth module reference of a rotate video action module (not shown) of the external system. The processing circuitry (for example, the controller module 206, the transaction module 208, the video node management module 216, the overlay management module 236, or the like) may use the video rotation overlay node 908 to communicate the seventh video reference associated with the cropped video CV1 to the rotate video action module. Subsequently, the rotate video action module may execute the video rotation operation on the cropped video CV1. Based on the video rotation operation executed on the cropped video CV1, a rotated video RV1 may be generated in the external system.

The processing circuitry (for example, the controller module 206, the transaction module 208, the video node management module 216, the overlay management module 236, or the like) may use the video rotation overlay node 908 to receive a seventh plurality of image configurations of a seventh plurality of image frames of the rotated video RV1 from the rotate video action module. The rotated video RV1 may not be the final output of the third video action being executed on the video V9. Hence, the rotated video RV1 may be a second intermediate video. The processing circuitry (for example, the controller module 206, the transaction module 208, the video node management module 216, or the like) may use the video rotation overlay node 908 to produce (namely, generate, create, instantiate) an intermediate video node 910. The intermediate video node 910 may include an eighth video reference associated with the rotated video RV1. Subsequently, the processing circuitry (for example, the controller module 206, the transaction module 208, the video node management module 216, or the like) may use the video rotation overlay node 908 to correlate the intermediate video node 906 and the intermediate video node 910 such that the intermediate video node 906 may be associated with a role ‘Original’ and the intermediate video node 910 may be associated with a role ‘Rotated’.

Subsequently, based on the video rotation overlay node 908, the processing circuitry (for example, the controller module 206, the transaction module 208, the stimuli management module 212, or the like) may determine a video enhancement overlay node 912 from one or more video action overlay nodes associated with the video rotation overlay node 908. The video enhancement overlay node 912 may be determined based on a functionality thereof being able to execute a third video operation of the third video action indicated by the third stimulus. The third video operation may correspond to a video enhancement operation of the second intermediate video, e.g., the rotated video RV1, generated based on the second video operation.

The video enhancement overlay node 912 may include an eleventh module reference of a video enhancement overlay node (not shown) of the external system. The processing circuitry (for example, the controller module 206, the transaction module 208, the video node management module 216, the overlay management module 236, or the like) may use the video enhancement overlay node 912 to communicate the eighth video reference associated with the rotated video RV1 to the video enhancement action module. Subsequently, the video enhancement action module may execute the video enhancement operation on the rotated video RV1. Based on the video enhancement operation executed on the rotated video RV1, an enhanced video EV1 may be generated in the external system.

The processing circuitry (for example, the controller module 206, the transaction module 208, the video node management module 216, the overlay management module 236, or the like) may use video enhancement overlay node 912 to receive an eighth plurality of image configurations of an eighth plurality of image frames of the enhanced video EV1 from the video enhancement action module. The enhanced video EV1 may be the final output of the third video action being executed on the video V9. The processing circuitry (for example, the controller module 206, the transaction module 208, the video node management module 216, or the like) may use the video enhancement overlay node 912 to produce (namely, generate, create, instantiate) an enhanced video node 914. Subsequently, the processing circuitry (for example, the controller module 206, the transaction module 208, the video node management module 216, or the like) may use the video enhancement overlay node 912 to correlate the intermediate video node 910 and the enhanced video node 914 such that the intermediate video node 910 may be associated with a role ‘Original’ and the enhanced video node 914 may be associated with a role ‘Enhanced’. The first, second, and third video operations may constitute the third video action. Completion of the first, second, and third video operations may mark a completion of the third video action indicated by the third stimulus.

Notably, the video cropping operation, the video rotation operation, and the video enhancement operation are executed by the crop video action module, the rotate video action module, and the enhance video action module, respectively of the external system. Each of the crop video action module, the rotate video action module, and the enhance video action module may execute corresponding operations (for example, the video cropping operation, the video rotation operation, and the video enhancement operation) based on a processor (for example, CPU, GPU, or the like) associated with the external system.

The videos V9, CV1, RV1, EV1, or any other videos associated with the external system may be stored in a storage (for example, main memory, file system, or the like) in form of a video or a file. A video may be stored in various forms including Raw Video Formats (e.g., Uncompressed RGB, YUV, Bayer RAW), Compressed Video Formats (Lossless: HuffYUV, FFV1, Lagarith; Lossy: Advanced Video Coding (AVC/H.264), High Efficiency Video Coding (HEVC/H.265), VP9, AOMedia Video 1 (AV1)), Encapsulated Video Formats (Containers) (e.g., MPEG-4 Part 14 (MP4), Matroska (MKV), Audio Video Interleave (AVI), QuickTime Movie (MOV), Web Media File (WebM), Flash Video (FLV)), Specialized and Professional Formats (e.g., Apple ProRes, Avid Digital Nonlinear Extensible High Definition (DNxHD), Digital Nonlinear Extensible High Resolution (DNxHR), Material Exchange Format (MXF), Moving Picture Experts Group Transport Stream (MPEG-TS)), VR and 360-Degree Video Formats (e.g., Equirectangular Projection, Cube Map), Cloud/Streaming-Oriented Formats (e.g., HTTP Live Streaming (HLS), Dynamic Adaptive Streaming over HTTP (DASH), Microsoft Smooth Streaming (MSS)), or any other format of video representation.

Notably, the third video action performed on the video V9 may be performed dynamically based on one or more inputs received via the API facilitated by the processing circuitry (for example, the interface module 204, or the like). In other words, a sequence of execution of the first, second, and third video operations may not be predefined and may be dynamically selected by way of the API. In addition, generation of various intermediate videos and corresponding video nodes may not be predefined and hence may be dynamic and based on one or more user inputs received via the API.

Having discussed the exemplary implementation of the executable graph-based model 100 with video nodes that may be generic video nodes, the description now moves towards another exemplary implementation of the executable graph-based model 100 with video nodes that may be run-time video nodes.

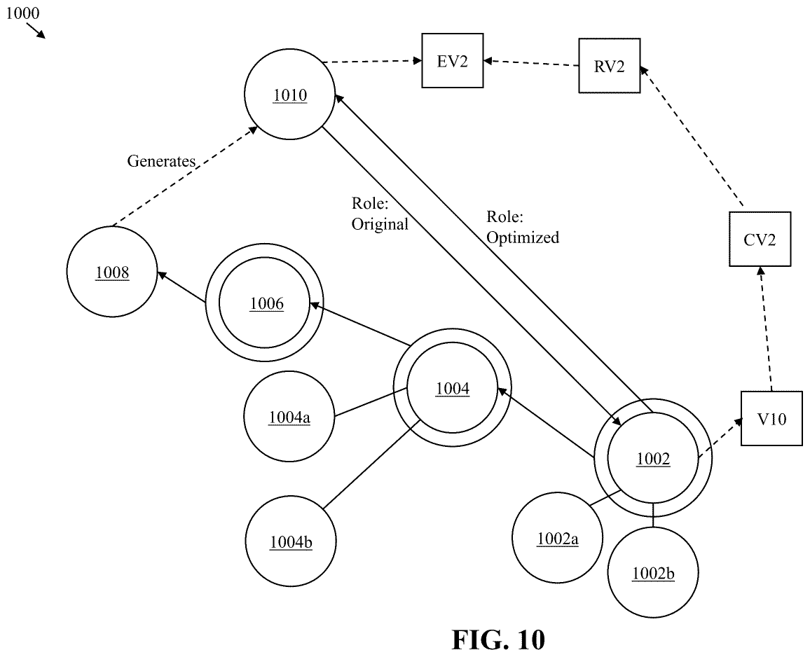

FIG. 10 illustrates a graph 1000 that depicts another exemplary implementation of the executable graph-based model 100, consistent with disclosed embodiments of the present disclosure. Referring to FIG. 10, illustrated is the exemplary implementation of the video nodes for modification of videos of an external system (for example, the external systems 702 and 802). For the sake of description of FIG. 10, it is assumed that video nodes depicted in FIG. 10 are run-time video nodes and video action overlay nodes depicted in FIG. 10 are run-time overlay nodes. Therefore, each video node and video action overlay node depicted in FIG. 10 may include a node template and a node instance. For example, a run-time video node 1002 depicted in FIG. 10 may include a node template 1002a and a node instance 1002b. Similarly, each of the other run-time video nodes depicted in FIG. 10 may include a corresponding node template and a corresponding node instance. Moreover, a run-time video action overlay node 1004 may include an overlay node template 1004a and an overlay node instance 1004b. Similarly, each of the other run-time video action overlay nodes depicted in FIG. 10 may also include corresponding overlay node templates and corresponding overlay node instances.

The run-time video node 1002 may represent a video V10 of an external system (for example, the external system 802). Therefore, the run-time video node 1002 may include a ninth video reference (for example, a pointer, a storage location, a URL, or the like) associated with the video V10. The processing circuitry (for example, the controller module 206, the transaction module 208, the stimuli management module 212, or the like) may receive a fourth stimulus (for example, the stimulus 230) indicative of a fourth video action to be executed on the video V10. Based on the fourth stimulus, the stimuli management module 212, or the like) may identify the run-time video node 1002 representing the video V10. Further, based on the run-time video node 1002, the processing circuitry (for example, the controller module 206, the transaction module 208, the stimuli management module 212, or the like) may determine a run-time video action overlay node 1004 from one or more run-time video action overlay nodes associated with the run-time video node 1002. The run-time video action overlay node 1004 may be determined based on a functionality thereof being able to execute a fourth video operation of the fourth video action indicated by the fourth stimulus. The fourth video operation may correspond to a video cropping operation and the functionality of the run-time video action overlay node 1004 may be processing logic that when executed causes a cropping operation of a video represented by an associated video node.

Based on the identification of the run-time video node 1002 and the determination of the run-time video action overlay node 1004, the processing circuitry (for example, the memory management module 218, the storage management module 220, or the like) may be configured to determine whether the run-time video node 1002 and the run-time video action overlay node 1004 is unloaded from the executable graph-based model 100. Based on the determination that the run-time video node 1002 and the run-time video action overlay node 1004 are unloaded from the executable graph-based model 100, the processing circuitry (for example, the memory management module 218, the storage management module 220, or the like) may load the run-time video node 1002 and the run-time video action overlay node 1004 as described in conjunction with FIG. 6. The run-time video node 1002 may be loaded based on loading of the node template 1002a and the node instance 1002b. Similarly, the run-time video action overlay node 1004 may be loaded based on loading of the overlay node template 1004a and the overlay node instance 1004b.

As shown, the run-time video action overlay node 1004 may be further associated with run-time video action overlay nodes 1006 and 1008 in a cascading manner. In other words, the run-time video action overlay node 1006 may be directly associated with the run-time video action overlay node 1004 and the run-time video action overlay node 1008 may be associated with the run-time video action overlay node 1004 via the run-time video action overlay node 1006. In such a scenario, based on the run-time video action overlay nodes 1004, 1006, and 1008 being run-time nodes, the overlay node template 1004a of the run-time video action overlay node 1004 may define an operation sequence and an output strategy associated with an execution of processing logic of the run-time video action overlay nodes 1004, 1006 and 1008. In other words, the overlay node template 1004a may define various parameters, constraints, or the like associated with the execution of the processing logic of the run-time video action overlay nodes 1004, 1006, and 1008. In addition, the overlay node template 1004a may define various parameters, constraints, formats, storage locations, or the like associated with output that may be generated based on the execution of the processing logic of the run-time video action overlay nodes 1004, 1006, and 1008.

The run-time video action overlay node 1004 may include a twelfth module reference of a crop video action module (not shown) of the external system. The processing circuitry (for example, the controller module 206, the transaction module 208, the video node management module 216, the overlay management module 236, or the like) may use run-time video action overlay node 1004 to communicate the ninth video reference associated with the video V10 to the crop video action module. Subsequently, the crop video action module may execute the video cropping operation on the video V10. Based on the video cropping operation executed on the video V10, a cropped video CV2 may be generated in the external system. The processing circuitry (for example, the controller module 206, the transaction module 208, the video node management module 216, the overlay management module 236, or the like) may use the run-time video action overlay node 1004 to receive a ninth plurality of image configurations of a ninth plurality of image frames and a tenth video reference, of the cropped image CV2 from the crop video action module. The cropped image CV2 may not be a final output of the fourth video action being executed on the video V10. Hence, the cropped image CV2 may be a third intermediate video. In addition, the node template 1004a of the run-time video action overlay node 1004 may define the output strategy in accordance with which only final output of the fourth video action may be represented in the executable graph-based model 100. Therefore, the cropped video CV2 is not represented by way of a video node in the executable graph-based model 100.

Subsequently, based on the run-time video action overlay node 1004, the processing circuitry (for example, the controller module 206, the transaction module 208, the stimuli management module 212, or the like) may determine the run-time video action overlay node 1006 from one or more run-time video action overlay nodes associated with the run-time video action overlay node 1004. The run-time video action overlay node 1006 may be determined based on a functionality thereof being able to execute a fifth video operation of the fourth video action indicated by the fourth stimulus. The fifth video operation may correspond to a video rotation operation of the third intermediate video e.g., the cropped video CV2, generated based on the fourth video operation.

The run-time video action overlay node 1006 may include a thirteenth module reference of a rotate video action module (not shown) of the external system. The processing circuitry (for example, the controller module 206, the transaction module 208, the video node management module 216, the overlay management module 236, or the like) may use the run-time video action overlay node 1004 to provide the tenth video reference of the cropped video CV2 to the run-time video action overlay node 1006. The processing circuitry (for example, the controller module 206, the transaction module 208, the video node management module 216, the overlay management module 236, or the like) may use the run-time video action overlay node 1006 to communicate the tenth video reference associated with the cropped video CV2 to the rotate video action module. Subsequently, the rotate video action module may execute the video rotation operation on the cropped video CV2. Based on the video rotation operation executed on the cropped video CV2, a rotated video RV2 may be generated in the external system.

The processing circuitry (for example, the controller module 206, the transaction module 208, the video node management module 216, the overlay management module 236, or the like) may use the run-time video action overlay node 1006 to receive a tenth plurality of image configurations of a tenth plurality of image frames and an eleventh video reference, of the rotated video RV2 from the rotate video action module. The rotated image RV2 may not be the final output of the fourth video action being executed on the video V10. Hence, the rotated image RV2 may be a fourth intermediate video. Hence, based on the output strategy defined by the node template 1004a, the rotated video RV2 may not be represented in the executable graph-based model 100.

Subsequently, based on the run-time video action overlay nodes 1004 and 1006, the processing circuitry (for example, the controller module 206, the transaction module 208, the stimuli management module 212, or the like) may determine the run-time video action overlay node 1008 from one or more run-time video action overlay nodes associated with the run-time video action overlay nodes 1004 and 1006. The run-time video action overlay node 1008 may be determined based on a functionality thereof being able to execute a sixth video operation of the fourth video action indicated by the fourth stimulus. The sixth video operation may correspond to a video enhancement operation of the fourth intermediate video i.e., the rotated video RV2, generated based on the fifth video operation.

The run-time video action overlay node 1008 may include a fourteenth module reference of an enhance video action module (not shown) of the external system. The processing circuitry (for example, the controller module 206, the transaction module 208, the video node management module 216, the overlay management module 236, or the like) may use the run-time video action overlay node 1006 to provide the eleventh video reference of the rotated video RV2 to the run-time video action overlay node 1008. Further, the processing circuitry (for example, the controller module 206, the transaction module 208, the video node management module 216, the overlay management module 236, or the like) may use the run-time video action overlay node 1008 to communicate the eleventh video reference associated with the rotated image RV2 to the video enhancement action module. Subsequently, the video enhancement action module may execute the video enhancement operation on the rotated video RV2. Based on the video enhancement operation executed on the rotated video RV2, an enhanced video EV2 may be generated in the external system.

The processing circuitry (for example, the controller module 206, the transaction module 208, the video node management module 216, the overlay management module 236, or the like) may use run-time video action overlay node 1008 to receive an eleventh plurality of image configurations of an eleventh plurality of image frames and a twelfth video reference of the enhanced video EV2 from the video enhancement action module. The enhanced video EV2 may be the final output of the fourth video action being executed on the video V10. Therefore, based on the output strategy defined by the node template 1004a, the enhanced video EV2 may be represented in the executable graph-based model 100.

The processing circuitry (for example, the controller module 206, the transaction module 208, the video node management module 216, or the like) may use the run-time video action overlay node 1008 to produce (namely, generate, create, instantiate) a run-time optimized video node 1010. Subsequently, the processing circuitry (for example, the controller module 206, the transaction module 208, the video node management module 216, or the like) may use the run-time video action overlay node 1008 to correlate the run-time optimized video node 1010 and the run-time video node 1002 such that the run-time optimized video node 1010 may be associated with a role ‘Optimized’ and the run-time video node 1002 may be associated with a role ‘Original’. The run-time optimized video node 1010 may represent the enhanced video EV2 that may be a cropped, rotated, and enhanced version of the video V10, and may be the final output of the fourth video action. The fourth, fifth, and sixth video operations may constitute the fourth video action. Completion of the fourth, fifth, and sixth video operations may mark completion of the fourth video action indicated by the fourth stimulus.

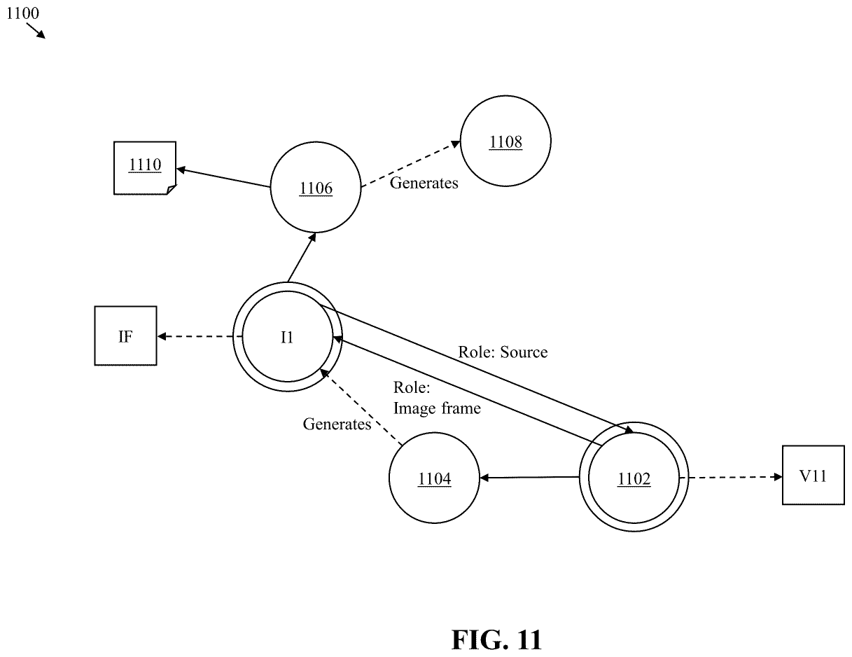

FIG. 11 is a graph 1100 that illustrates another exemplary implementation of the executable graph-based model 100, consistent with disclosed embodiments of the present disclosure. Referring to FIG. 11, shown is a video V11 of an external system associated with the overlay system 202. The video V11 may be represented by a video node 1102 in the executable graph-based model 100. That is to say that, a twelfth plurality of image configurations of a twelfth plurality of image frames of the video V11 may be included within the video node 1102. In addition, the video node V11 may have a thirteenth video reference of the video V11.

Based on a requirement of analysis of one or more frames of the twelfth plurality image frames of the video V11, the processing circuitry (for example, the controller module 206, the transaction module 208, the video node management module 216, the overlay management module 236, or the like) may be configured to associate a feature extractor overlay node 1104 associated with the video node 1102. The feature extractor overlay node 1104 may include processing logic that when executed may cause extraction of one or more image frames of a plurality of image frames of a video being represented by an associated video node. Subsequently, the processing circuitry (for example, the controller module 206, the transaction module 208, the video node management module 216, the overlay management module 236, or the like) may use the feature extractor overlay node 1104 associated with the video node 1102 to cause extraction of an image frame IF by way of a video action module of the external system as described throughout the description. Notably, extraction of other image frames of the twelfth plurality of image frames may be performed in a similar manner.

The processing circuitry (for example, the controller module 206, the transaction module 208, the video node management module 216, the overlay management module 236, or the like) may be further configured to, use the feature extractor overlay node 1104, to generate an image frame node I1 representing the image frame IF. The image frame node I1 may be correlated with the video node 1102 such that the video node 1102 may have a role ‘Source’ and the image frame node I1 may have a role ‘Image frame’. Further, to analyze the image frame IF, the processing circuitry (for example, the controller module 206, the transaction module 208, the video node management module 216, the overlay management module 236, or the like) may be further configured to associate an analyzer overlay node 1106 with the image frame node I1. Similarly, the analyzer overlay node 1106 may be associated with other image frame nodes representing the other extracted image frames of the twelfth plurality of image frames.

The processing circuitry (for example, the controller module 206, the transaction module 208, the video node management module 216, the overlay management module 236, or the like) may use the analyzer overlay node 1106 to cause analysis of the extracted image frames including the image frame IF as described throughout the description. Notably, the analysis of each extracted image frame may be performed based on a corresponding image configuration. It will be apparent to a person skilled in the art that the twelfth plurality of image frames of the video V11 may be analyzed based on analysis of the twelfth plurality of image configurations.

Based on the analysis of the extracted image frames, a set of analyzed image frames and optionally an analysis report may be generated as output of the analysis. The analysis report and/or image configurations of each image frame of the set of analyzed image frames may be received by the processing circuitry (for example, the controller module 206, the transaction module 208, the video node management module 216, the overlay management module 236, or the like) using the analyzer overlay node 1106. The analyzer overlay node 1106 may represent the image configuration of each analyzed image frame. Alternatively, each image frame of the set of analyzed image frames may be represented in the executable graph-based model 100 by way of an analyzed image frame node including an analyzed image frame node 1108. The analyzed image frame node 1108 may be generated based on an analysis of the image frame IF. Hence, the analyzed image frame node 1108 may be associated with image frame node I1. The analysis report may be stored in the storage element in form of a file 1110. Alternatively, the analysis report may be represented in the executable graph-based model 100 by way of a node (not shown). The node may be associated with the video node 1102 or the image frame nodes (for example, the image frame node I1) representing the extracted image frames.

Having discussed various exemplary implementations of the executable graph-based model 100 with the video nodes, the description now moves towards a computing system that facilitates such implementation of the executable graph-based model 100.

FIG. 12 shows an example computing system 1200 for carrying out the methods of the present disclosure, consistent with disclosed embodiments of the present disclosure. Specifically, FIG. 12 shows a block diagram of an embodiment of the computing system 1200 according to example embodiments of the present disclosure.

The computing system 1200 may be configured to perform any of the operations disclosed herein, such as for example, any of the operations discussed with reference to the functional modules described in relation to FIG. 2. The computing system 1200 can be implemented as a conventional computer system, an embedded controller, a laptop, a server, a mobile device, a smartphone, a set-top box, a kiosk, a vehicular information system, one or more processors associated with a television, a customized machine, any other hardware platform, or any combination or multiplicity thereof. In one embodiment, the computing system 1200 is a distributed system configured to function using multiple computing machines interconnected via a data network or bus system.

The computing system 1200 includes computing devices (such as a computing device 1202). The computing device 1202 includes one or more processors (such as a processor 1204) and a memory 1206. The processor 1204 may be any general-purpose processor(s) configured to execute a set of instructions. For example, the processor 1204 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 1204 may be multiple processing units, a single processing core, multiple processing cores, special purpose processing cores, co-processors, or any combination thereof. The processor 1204 may be communicatively coupled to the memory 1206 via an address bus 1208, a control bus 1210, a data bus 1212, and a messaging bus 1214.

The memory 1206 may include non-volatile memories such as a read-only memory (ROM), a programable read-only memory (PROM), an erasable programmable read-only memory (EPROM), a flash memory, or any other device capable of storing program instructions or data with or without applied power. The memory 1206 may also include volatile memories, such as a random-access memory (RAM), a static random-access memory (SRAM), a dynamic random-access memory (DRAM), and a synchronous dynamic random-access memory (SDRAM). The memory 1206 may include single or multiple memory modules. While the memory 1206 is depicted as part of the computing device 1202, a person skilled in the art will recognize that the memory 1206 can be separate from the computing device 1202.

The memory 1206 may store information that can be accessed by the processor 1204. For instance, the memory 1206 (e.g., one or more non-transitory computer-readable storage mediums, memory devices) may include computer-readable instructions (not shown) that can be executed by the processor 1204. The computer-readable instructions may be software written in any suitable programming language or may be implemented in hardware. Additionally, or alternatively, the computer-readable instructions may be executed in logically and/or virtually separate threads on the processor 1204. For example, the memory 1206 may store instructions (not shown) that when executed by the processor 1204 cause the processor 1204 to perform operations such as any of the operations and functions for which the computing system 1200 is configured, as described herein. Additionally, or alternatively, the memory 1206 may store data (not shown) that can be obtained, received, accessed, written, manipulated, created, and/or stored. The data can include, for instance, the data and/or information described herein in relation to FIGS. 1-11. In some implementations, the computing device 1202 may obtain from and/or store data in one or more memory device(s) that are remote from the computing system 1200.

The computing device 1202 may further include an input/output (I/O) interface 1216 communicatively coupled to the address bus 1208, the control bus 1210, and the data bus 1212. The data bus 1212 and messaging bus 1214 may include a plurality of tunnels that may support parallel execution of messages by the overlay system 202. The I/O interface 1216 is configured to couple to one or more external devices (e.g., to receive and send data from/to one or more external devices). Such external devices, along with the various internal devices, may also be known as peripheral devices. The I/O interface 1216 may include both electrical and physical connections for operably coupling the various peripheral devices to the computing device 1202. The I/O interface 1216 may be configured to communicate data, addresses, and control signals between the peripheral devices and the computing device 1202. The I/O interface 1216 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, or the like. The I/O interface 1216 is configured to implement only one interface or bus technology. Alternatively, the I/O interface 1216 is configured to implement multiple interfaces or bus technologies. The I/O interface 1216 may include one or more buffers for buffering transmissions between one or more external devices, internal devices, the computing device 1202, or the processor 1204. The I/O interface 1216 may couple the computing device 1202 to various input devices, including mice, touch screens, scanners, biometric readers, electronic digitizers, sensors, receivers, touchpads, trackballs, cameras, microphones, keyboards, any other pointing devices, or any combinations thereof. The I/O interface 1216 may couple the computing device 1202 to various output devices, including video displays, speakers, printers, projectors, tactile feedback devices, automation control, robotic components, actuators, motors, fans, solenoids, valves, pumps, transmitters, signal emitters, lights, and so forth.

The computing system 1200 may further include a storage unit 1218, a network interface 1220, an input controller 1222, and an output controller 1224. The storage unit 1218, the network interface 1220, the input controller 1222, and the output controller 1224 are communicatively coupled to the central control unit (e.g., the memory 1206, the address bus 1208, the control bus 1210, and the data bus 1212) via the I/O interface 1216. The network interface 1220 communicatively couples the computing system 1200 to one or more networks such as wide area networks (WAN), local area networks (LAN), intranets, the Internet, wireless access networks, wired networks, mobile networks, telephone networks, optical networks, or combinations thereof. The network interface 1220 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 1218 is a computer-readable medium, preferably a non-transitory computer-readable medium, comprising one or more programs, the one or more programs comprising instructions which when executed by the processor 1204 cause the computing system 1200 to perform the method steps of the present disclosure. Alternatively, the storage unit 1218 is a transitory computer-readable medium. The storage unit 1218 can include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 1218 stores one or more operating systems, application programs, program modules, data, or any other information. The storage unit 1218 is part of the computing device 1202. Alternatively, the storage unit 1218 is part of one or more other computing machines that are in communication with the computing device 1202, such as servers, database servers, cloud storage, network attached storage, and so forth.

The input controller 1222 may include suitable logic, circuitry, interfaces, and/or code, executable by the circuitry, that may be configured to control one or more input devices that may be configured to receive an input (the stimulus 230) for the overlay system 202. The output controller 1224 may include suitable logic, circuitry, interfaces, and/or code, executable by the circuitry, that may be configured to control one or more output devices that may be configured to render/output the outcome of the operation executed to process the received input (the stimulus 230).

Having discussed the computing system 1200 that implements the video nodes in the overlay system 202 disclosed herein, the description now moves towards methods that are executed to facilitate such an implementation of the video nodes in the overlay system 202.

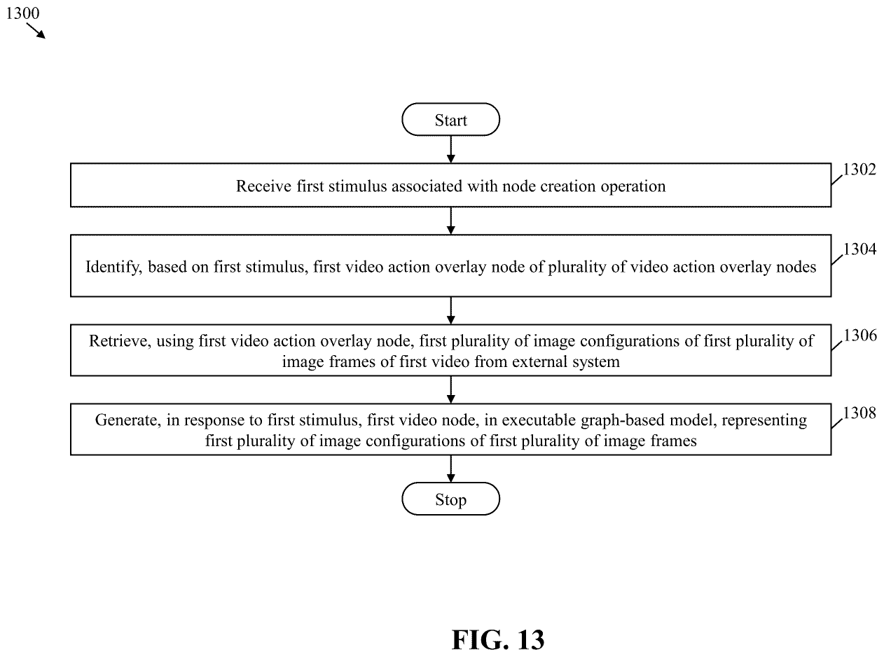

FIG. 13 illustrates a flowchart 1300 of a method for creation of a video node in the executable graph-based model 100, consistent with disclosed embodiments of the present disclosure. Referring to FIG. 13, at 1302, a first stimulus associated with a node creation operation may be received. The node creation operation may correspond to a first video action. The processing circuitry (such as the controller module 206, the transaction module 208, the stimuli management module 212, or the like) may receive the first stimulus associated with the node creation operation.

At 1304, a first video action overlay node of the plurality of video action overlay nodes may be identified based on the first stimulus. The processing circuitry (such as the controller module 206, the stimuli management module 212, or the like) may identify the first video action overlay node from the plurality of video action overlay nodes based on a context of the first stimulus.

At 1306, a first plurality of image configurations of a first plurality of image frames of the first video (for example, videos V1, V5, V8, V9, or the like) may be retrieved, using the first video action overlay node, from the external system. The processing circuitry (for example, the controller module 206, the transaction module 208, or the like) may be configured to retrieve, using the first video action overlay node, the first plurality of image configurations of the first plurality of image frames of the first video from the external system.

At 1308, a first video node may be generated, in the executable graph-based model 100, in response to the first stimulus. The first video node may represent the first plurality of image configurations of the first plurality of image frames of the first video. The processing circuitry (for example, the controller module 206, the transaction module 208, or the like) may be configured to generate the first video node in response to the first stimulus.

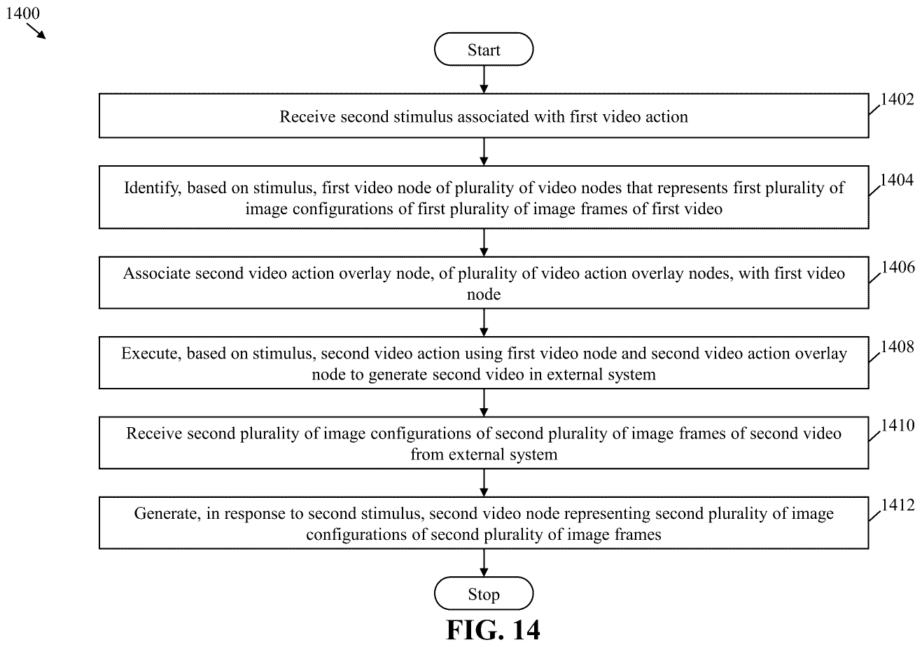

FIG. 14 illustrates a flowchart 1400 of a method for execution of a video action, consistent with disclosed embodiments of the present disclosure. Referring to FIG. 14, at 1402, a second stimulus associated with a first video action may be received. The first video action may be executed based on the first video. The processing circuitry (for example, the controller module 206, the transaction module 208, the stimuli management module 212, or the like) may be configured to receive the second stimulus.

At 1404, based on the second stimulus, the first video node may be identified in the executable graph-based model 100. The processing circuitry (for example, the controller module 206, the transaction module 208, the stimuli management module 212, or the like) may be configured to identify the first video node.

At 1406, a second video action overlay node, of the plurality of video action overlay nodes, may be associated with the first video node. The second video action overlay node has a functionality that conforms with the second video action. The processing circuitry (for example, the controller module 206, the transaction module 208, the stimuli management module 212, the video node management module 216, or the like) may be configured to identify the second video action overlay node from the plurality of video action overlay nodes. The processing circuitry (for example, the controller module 206, the transaction module 208, the stimuli management module 212, the video node management module 216, or the like) may be further configured to associate the second video action overlay node with the first video node.

At 1408, the second video action may be executed using the first video node and the second video action overlay node to generate a second video in the external system. The processing circuitry (for example, the controller module 206, the transaction module 208, the video node management module 216, the overlay management module 236, or the like) may be configured to execute the second video action.

At 1410, a second plurality of image configurations of a second plurality of image frames of the second video may be received. The processing circuitry (for example, the controller module 206, the transaction module 208, the video node management module 216, the overlay management module 236, or the like) may be configured to receive, using the second video action overlay node, the second plurality of image configurations of the second plurality of image frames.

At 1412, a second video node may be generated in the executable graph-based model 100 in response to the second stimulus. The second video node may represent the second plurality of image configurations of the second plurality of image frames of the second video, in the executable graph-based model 100. The processing circuitry (for example, the controller module 206, the transaction module 208, the video node management module 216, the overlay management module 236, or the like) may be configured to generate, using the second video action overlay node, the second video node.

The disclosed embodiments encompass numerous advantages including a simple and user-friendly implementation of the executable graph-based model 100 that may be in turn used to implement various complex and advanced applications. The disclosed systems and methods allow for facilitation and implementation of video nodes in the executable graph-based model 100. The overlay system 202 disclosed herein introduces domain-specific optimizations pertaining to the domain of video processing. Such optimization of the executable graph-based model 100 can significantly enhance the performance, scalability, and precision of the overlay system 202. By incorporating specialized video node structures and tailored processing logic by way of video action overlay nodes, the overlay system 202 may streamline data representation, ensuring that each video node is optimized for its intended application. This specialization enables more efficient traversal, retrieval, and computation, reducing redundant processing and improving overall system responsiveness.

Beyond performance improvements, the disclosed overlay system 202 fosters greater interpretability and decision-making capabilities by embedding domain-aware intelligence into the executable graph-based model 100 by way of video nodes and video action overlay nodes. Unlike generic implementations, which require extensive customization for domain-specific insights, a structured and optimized approach facilitates seamless integration of industry-specific heuristics, machine learning models, and automated rule-based processing. As a result, users benefit from more accurate execution of operations associated with the video nodes. Furthermore, the ability of the overlay system 202 to incorporate real-time adjustments based on evolving technological trends ensures sustained adaptability, making it a powerful tool for industries requiring high precision and efficiency in data-driven decision-making.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods for the implementation of a plurality of video nodes in conjunction with a plurality of video action overlay nodes in executable graph-based models. While various embodiments of the disclosed systems and methods have been described above, it should be understood that they have been presented for purposes of example only, and not limitations. It is not exhaustive and does not limit the present disclosure to the precise form disclosed. Modifications and variations are possible in light of the above teachings or may be acquired from practicing the present disclosure, without departing from the breadth or scope.

Moreover, for example, the present technology/system may achieve the following configurations:
1. An overlay system, comprising:
   a storage element configured to store an executable graph-based model that includes a plurality of video action overlay nodes; and
   processing circuitry that is coupled to the storage element, and configured to:
      receive a first stimulus associated with a node creation operation in the executable graph-based model to represent a first video of an external system;
      identify, based on the first stimulus, a first video action overlay node of the plurality of video action overlay nodes;
      retrieve, using the first video action overlay node, a first plurality of image configurations of a first plurality of image frames of the first video from the external system; and
      generate, in response to the first stimulus, a first video node, in the executable graph-based model, representing the first video based on the first plurality of image configurations of the first plurality of image frames.
2. The overlay system of 1, wherein the first video action overlay node is a video creation overlay node.
3. The overlay system of 1, wherein the first video node includes a first video reference of the first video.
4. The overlay system of 1, wherein the first video action overlay node includes a first module reference of a video creation module of the external system.
5. The overlay system of 1, wherein the processing circuitry identifies the first video action overlay node based on a functionality of thereof being in conformity with the node creation operation.
6. The overlay system of 1, wherein the first video node is one of a group consisting of a stateful node or a stateless node.
7. The overlay system of 6, wherein based on the first video node being the stateful node, the first plurality of image configurations remain stored with the storage element upon unloading of the first video node.
8. The overlay system of 6, wherein based on the first video node being the stateless node, the first plurality of image configurations cease to exist in the storage element upon unloading of the first video node.
9. The overlay system of 1, wherein the processing circuitry is further configured to:
   receive a second stimulus associated with a first video action to be executed based on the first video;
   identify, based on the second stimulus, the first video node in the executable graph-based model;
   associate a second video action overlay node, of the plurality of video action overlay nodes, with the first video node, wherein the second video action overlay node has a functionality that conforms with the first video action;
   execute the first video action using the first video node and the second video action overlay node to generate a second video in the external system; and
   generate, in response to the second stimulus, a second video node, representing the second video based on a second plurality of image configurations of a second plurality of image frames of the second video, in the executable graph-based model.
10. The overlay system of 9,
   wherein the second video action overlay node includes a second module reference of a first video action module associated with the external system, and
   wherein the first video action is executed further based on the first video action module.
11. The overlay system of 9, wherein the second video action overlay node is at least one of a group consisting of: a video creation overlay node, a video modification overlay node, or a video analyzer overlay node.
12. The overlay system of 9,
   wherein the executable graph-based model further includes a plurality of standard operations overlay nodes,
   wherein the processing circuitry is further configured to associate a first standard operations overlay node, of the plurality of standard operations overlay nodes, with the first video node,
   wherein a functionality of the first standard operations overlay node conforms with the first video action, and
   wherein the first video action is executed further based on the first standard operations overlay node.
13. The overlay system of 9,
   wherein the first video node includes a first video reference of the first video,
   wherein the second video action overlay node includes a second module reference of a first video action module associated with the external system, and
   wherein for the execution of the first video action, the processing circuitry is further configured to:
      retrieve, using the second video action overlay node, the first video reference from the first video node;
      communicate, using the second module reference, the first video reference to the first video action module, wherein the first video reference is utilized by the first video action module to execute a video operation of the first video action on at least one of the first plurality of image frames of the first video to generate the second plurality of image frames of the second video; and
      receive, using the second video action overlay node, the second plurality of image configurations of the second plurality of image frames, from the first video action module.
14. The overlay system of 13,
   wherein the first video action corresponds to a set of video mutation operations,
   wherein the execution of the first video action generates at least one intermediate video associated with the first video, and
   wherein prior to the reception of the second plurality of image configurations, the processing circuitry is further configured to receive, from the first video action module, using the second video action overlay node, a third plurality of image configurations of a third plurality of image frames of the at least one intermediate video.
15. The overlay system of 9,
   wherein the processing circuitry is further configured to associate a third video action overlay node, of the plurality of video action overlay nodes, with the first video node,
   wherein the third video action overlay node includes a third module reference of a second video action module associated with the external system, and
   wherein the first video action is executed further based on the third video action overlay node.
16. The overlay system of 9, wherein the first video node further includes a first overlay manager configured to manage the association of the first video node with the second video action overlay node.
17. The overlay system of 9,
   wherein the processing circuitry is further configured to associate a fourth video action overlay node, of the plurality of video action overlay nodes, with the second video action overlay node,
   wherein a functionality of the fourth video action overlay node conforms with the first video action, and
   wherein the first video action is executed further based on the fourth video action overlay node.
18. The overlay system of 9, wherein based on the execution of the first video action, the processing circuitry is further configured to store the first plurality of image configurations in association with the second video action overlay node.
19. The overlay system of 9,
   wherein the first video action is a set of video mutation operations, and
   wherein upon the execution of the first video action, the processing circuitry is further configured to:
      associate the first plurality of image configurations with the second video action overlay node, and
      discard the first video node from the overlay system.
20. The overlay system of 9,
   wherein the first video action is a set of video mutation operations,
   wherein the execution of the first video action generates at least one intermediate video associated with the first video,
   wherein the at least one intermediate video is generated prior to the generation of the second video, and
   wherein the processing circuitry is further configured to receive, using the second video action overlay node, a third plurality of image configurations of a third plurality of image frames of the at least one intermediate video, from the external system.
21. The overlay system of 20, wherein the second video action overlay node represents the third plurality of image configurations of the third plurality of image frames of the at least one intermediate video.
22. The overlay system of 20, wherein the processing circuitry is further configured to generate, using the second video action overlay node, at least one intermediate video node representing the at least one intermediate video based on the third plurality of image configurations of the third plurality of image frames.
23. The overlay system of 22, wherein the processing circuitry is further configured to correlate, using the second video action overlay node, the first video node with at least one of a group consisting of the at least one intermediate video node or the second video node.
24. The overlay system of 22, wherein the processing circuitry is further configured to generate a first group node including at least one of a group consisting of: the first video node, the at least one intermediate video node, or the second video node.
25. The overlay system of 24,
   wherein the processing circuitry is further configured to generate, based on the first group node, a video trail associated with the first video, and
   wherein the video trail includes a time-synchronized order of video mutations of the first video.
26. The overlay system of 24, wherein the processing circuitry is further configured to associate the first group node with a second group node having at least a third video node correlated with at least one of the group consisting of: the first video node, the at least one intermediate video node, or the second video node.
27. The overlay system of 24,
   wherein the processing circuitry is further configured to associate the first group node with a fifth video action overlay node, of the plurality of video action overlay nodes, and
   wherein the first video action is executed further based on the fifth video action overlay node.
28. The overlay system of 24,
   wherein the executable graph-based model further includes a plurality of standard operations overlay nodes,
   wherein the processing circuitry is further configured to associate the first group node with a second standard operations overlay node of the plurality of standard operations overlay nodes, and
   wherein the first video action is executed further based on the second standard operations overlay node.
29. The overlay system of 24, wherein the first group node is one of a group consisting of a persistable node or a non-persistable node.
30. The overlay system of 29,
   wherein based on the first group node being the persistable node, a video trail of the first video node is stored in the storage element, and
   wherein the video trail of the first video node includes a time-synchronized order of at least one of the group consisting of: the first video node, the at least one intermediate video node, or the second video node.
31. The overlay system of 29,
   wherein based on the first group node being the non-persistable node, a video trail of the first video node ceases to exist from the storage element upon expiration of a threshold time-interval, and
   wherein the video trail of the first video node includes a time-synchronized order of at least one of the group consisting of: the first video node, the at least one intermediate video node, or the second video node.
32. The overlay system of 24,
   wherein the processing circuitry is further configured to associate the first group node with a contract overlay node of the executable graph-based model, and
   wherein the processing circuitry is further configured to execute, using the contract overlay node, a set of constraints that implements access control associated with the first group node.
33. The overlay system of 32, wherein the access control associated with the first group node includes one of a group consisting of: a private access, a public access, or a protected access.
34. The overlay system of 9,
   wherein the first video node is a run-time node that includes (i) a node template that defines a node structure and (ii) a node instance that is an implementation of the node template, and
   wherein based on the first video node being the run-time node, the second video action overlay node is a run-time overlay node that includes (i) an overlay node template that defines an overlay node structure and (ii) an overlay node instance that is an implementation of the overlay node template.
35. The overlay system of 34,
   wherein each video action overlay node of the plurality of video action overlay nodes is the run-time overlay node,
   wherein the processing circuitry is further configured to associate one or more video action overlay nodes, of the plurality of video action overlay nodes, with the second video action overlay node,
   wherein the first video action is executed further based on the one or more video action overlay nodes, and
   wherein an overlay node template of the second video action overlay node defines a sequence of operations associated with the one or more video action overlay nodes.
36. The overlay system of 1, wherein the processing circuitry is further configured to:
   associate a sixth video action overlay node with the first video node;
   analyze, using the sixth video action overlay node, the first plurality of image frames; and
   generate, based on the analysis of the first plurality of image frames, a set of analyzed image frames.
37. The overlay system of 36, wherein the analysis of the first plurality of image frames is performed based on the first plurality of image configurations.
38. The overlay system of 36, wherein the processing circuitry is further configured to receive, using the sixth video action overlay node, a fourth set of image configurations, associated with the set of analyzed image frames.
39. The overlay system of 38, wherein the sixth video action overlay node represents the fourth set of image configurations associated with the set of analyzed image frames.
40. The overlay system of 1, wherein the first video node is an edge node.
41. A method, comprising:
   receiving, by processing circuitry of an overlay system, a stimulus associated with a node creation operation in an executable graph-based model to represent a first video of an external system,
      wherein the executable graph-based model is stored in a storage element of the overlay system and includes a plurality of video action overlay nodes;
   identifying, by the processing circuitry, based on the stimulus, a first video action overlay node of the plurality of video action overlay nodes;
   retrieving, by the processing circuitry, using the first video action overlay node, a first plurality of image configurations of a first plurality of image frames of the first video from the external system; and
   generating, by the processing circuitry, in response to the stimulus, a first video node, in the executable graph-based model, representing the first video based on the first plurality of image configurations of the first plurality of image frames.

What is claimed is:

1. An overlay system, comprising:
a storage element configured to store an executable graph-based model that includes a plurality of video action overlay nodes; and
processing circuitry that is coupled to the storage element, and configured to:
receive a first stimulus associated with a node creation operation in the executable graph-based model to represent a first video of an external system;
identify, based on the first stimulus, a first video action overlay node of the plurality of video action overlay nodes;
retrieve, using the first video action overlay node, a first plurality of image configurations of a first plurality of image frames of the first video from the external system; and
generate, in response to the first stimulus, a first video node, in the executable graph-based model, representing the first video based on the first plurality of image configurations of the first plurality of image frames.

2. The overlay system of claim 1, wherein the first video node includes a first video reference of the first video.

3. The overlay system of claim 1, wherein the first video action overlay node includes a first module reference of a video creation module of the external system.

4. The overlay system of claim 1,
wherein the first video node is one of a group consisting of a stateful node or a stateless node,
wherein based on the first video node being the stateful node, the first plurality of image configurations remain stored with the storage element upon unloading of the first video node, and
wherein based on the first video node being the stateless node, the first plurality of image configurations cease to exist in the storage element upon unloading of the first video node.

5. The overlay system of claim 1, wherein the processing circuitry is further configured to:
receive a second stimulus associated with a first video action to be executed based on the first video;
identify, based on the second stimulus, the first video node in the executable graph-based model;
associate a second video action overlay node, of the plurality of video action overlay nodes, with the first video node, wherein the second video action overlay node has a functionality that conforms with the first video action;
execute the first video action using the first video node and the second video action overlay node to generate a second video in the external system; and
generate, in response to the second stimulus, a second video node, representing the second video based on a second plurality of image configurations of a second plurality of image frames of the second video, in the executable graph-based model.

6. The overlay system of claim 5, wherein the second video action overlay node is at least one of a group consisting of: a video creation overlay node, a video modification overlay node, or a video analyzer overlay node.

7. The overlay system of claim 5,
wherein the first video node includes a first video reference of the first video,
wherein the second video action overlay node includes a second module reference of a first video action module associated with the external system, and
wherein for the execution of the first video action, the processing circuitry is further configured to:
retrieve, using the second video action overlay node, the first video reference from the first video node;
communicate, using the second module reference, the first video reference to the first video action module, wherein the first video reference is utilized by the first video action module to execute a video operation of the first video action on at least one of the first plurality of image frames of the first video to generate the second plurality of image frames of the second video; and
receive, using the second video action overlay node, the second plurality of image configurations of the second plurality of image frames, from the first video action module.

8. The overlay system of claim 5,
wherein the execution of the first video action generates at least one intermediate video associated with the first video, and
wherein prior to the reception of the second plurality of image configurations, the processing circuitry is further configured to receive, from the first video action module, using the second video action overlay node, a third plurality of image configurations of a third plurality of image frames of the at least one intermediate video.

9. The overlay system of claim 5,
wherein the processing circuitry is further configured to associate a third video action overlay node, of the plurality of video action overlay nodes, with the first video node,
wherein the third video action overlay node includes a third module reference of a second video action module associated with the external system, and
wherein the first video action is executed further based on the third video action overlay node.

10. The overlay system of claim 5, wherein upon the execution of the first video action, the processing circuitry is further configured to:
associate the first plurality of image configurations with the second video action overlay node; and
discard the first video node from the overlay system.

11. The overlay system of claim 5,
wherein the execution of the first video action generates at least one intermediate video associated with the first video,
wherein the at least one intermediate video is generated prior to the generation of the second video, and
wherein the processing circuitry is further configured to receive, using the second video action overlay node, a third plurality of image configurations of a third plurality of image frames of the at least one intermediate video, from the external system.

12. The overlay system of claim 11, wherein the second video action overlay node represents the third plurality of image configurations of the third plurality of image frames of the at least one intermediate video.

13. The overlay system of claim 11, wherein the processing circuitry is further configured to generate, using the second video action overlay node, at least one intermediate video node representing the at least one intermediate video based on the third plurality of image configurations of the third plurality of image frames.

14. The overlay system of claim 13, wherein the processing circuitry is further configured to generate a first group node including at least one of a group consisting of: the first video node, the at least one intermediate video node, or the second video node.

15. The overlay system of claim 14,
wherein the processing circuitry is further configured to generate, based on the first group node, a video trail associated with the first video, and
wherein the video trail includes a time-synchronized order of video mutations of the first video.

16. The overlay system of claim 14,
wherein the processing circuitry is further configured to associate the first group node with a fourth video action overlay node, of the plurality of video action overlay nodes, and
wherein the first video action is executed further based on the fourth video action overlay node.

17. The overlay system of claim 5,
wherein the first video node is a run-time node that includes (i) a node template that defines a node structure and (ii) a node instance that is an implementation of the node template, and
wherein based on the first video node being the run-time node, the second video action overlay node is a run-time overlay node that includes (i) an overlay node template that defines an overlay node structure and (ii) an overlay node instance that is an implementation of the overlay node template.

18. The overlay system of claim 17,
wherein each video action overlay node of the plurality of video action overlay nodes is the run-time overlay node,
wherein the processing circuitry is further configured to associate one or more video action overlay nodes, of the plurality of video action overlay nodes, with the second video action overlay node,
wherein the first video action is executed further based on the one or more video action overlay nodes, and
wherein an overlay node template of the second video action overlay node defines a sequence of operations associated with the one or more video action overlay nodes.

19. The overlay system of claim 1, wherein the processing circuitry is further configured to:
associate a fifth video action overlay node with the first video node;
analyze, using the fifth video action overlay node, the first plurality of image frames, wherein the analysis of the first plurality of image frames is performed based on the first plurality of image configurations; and
generate, based on the analysis of the first plurality of image frames, a set of analyzed image frames.

20. A method, comprising:
receiving, by processing circuitry of an overlay system, a stimulus associated with a node creation operation in an executable graph-based model to represent a first video of an external system,
wherein the executable graph-based model is stored in a storage element of the overlay system and includes a plurality of video action overlay nodes;
identifying, by the processing circuitry, based on the stimulus, a first video action overlay node of the plurality of video action overlay nodes;
retrieving, by the processing circuitry, using the first video action overlay node, a first plurality of image configurations of a first plurality of image frames of the first video from the external system; and
generating, by the processing circuitry, in response to the stimulus, a first video node, in the executable graph-based model, representing the first video based on the first plurality of image configurations of the first plurality of image frames.
